(19) United States
(12) Patent Application Publication
(10) Pub. No.: US 2026/0333051 A1
(43) Pub. Date: Oct. 22, 2026

(54) CIPHERING AND INTEGRITY PROTECTION ACTIVATION

(71) Applicant: Lenovo (United States) Inc., Morrisville, NC (US)

(72) Inventors: Sheeba Backia Mary Baskaran, Friedrichsdorf (DE); Andreas Kunz, Ladenburg (DE)

(73) Assignee: Lenovo (United States) Inc., Morrisville, NC (US)

(21) Appl. No.: 19/637,938

(22) Filed: Apr. 2, 2026

(51) Int. Cl. H04W 12/106; H04L 9/32; H04W 12/037

(52) U.S. Cl. CPC H04W 12/106; H04L 9/321; H04W 12/037

(57) ABSTRACT

Various aspects of the present disclosure relate to ciphering and integrity protection activation. A user equipment (UE) may receive a first message from a network entity (NE) including data that indicates an authenticated encryption algorithm and an authenticated encryption mode associated with at least one of integrity protection or ciphering. The UE verifies an integrity of the first message using the authenticated encryption algorithm and based on the data. The UE transmits a second message to the NE based on the integrity of the first message being verified. The second message is associated with activation of at least one of the integrity protection or the ciphering for transmission and/or reception based on the authenticated encryption mode.

### TECHNICAL FIELD

The present disclosure relates to wireless communications, and more specifically to security for the wireless communications.

### BACKGROUND

A wireless communications system may include one or multiple network communication devices, which may be otherwise known as network entities (NEs), supporting wireless communications for one or multiple user communication devices, which may be otherwise known as user equipment (UE), or other suitable terminology. The wireless communications system may support wireless communications with one or multiple user communication devices by utilizing resources of the wireless communication system (e.g., time resources (e.g., symbols, slots, subframes, frames, or the like) or frequency resources (e.g., subcarriers, carriers, or the like)). Additionally, the wireless communications system may support wireless communications across various radio access technologies, including third generation (3G) radio access technology, fourth generation (4G) radio access technology, fifth generation (5G) radio access technology, among other suitable radio access technologies beyond 5G (e.g., sixth generation (6G)).

### SUMMARY

As used herein, including in the claims, an article “a” before an element is unrestricted and understood to refer to “at least one” of those elements or “one or more” of those elements. The terms “a,” “at least one,” “one or more,” and “at least one of one or more” may be interchangeable. As used herein, including in the claims, “or” as used in a list of items (e.g., a list of items prefaced by a phrase such as “at least one of” or “one or more of” or “one or both of”) indicates an inclusive list such that, for example, a list of at least one of A, B, or C means A or B or C or AB or AC or BC or ABC (i.e., A and B and C). Also, as used herein, the phrase “based on” shall not be construed as a reference to a closed set of conditions. For example, an example step that is described as “based on condition A” may be based on both a condition A and a condition B without departing from the scope of the present disclosure. In other words, as used herein, the phrase “based on” shall be construed in the same manner as the phrase “based at least in part on.” Further, as used herein, including in the claims, a “set” may include one or more elements.

The devices (e.g., NE, UE), processors, and methods of the present disclosure each have several innovative aspects, no single one of which is solely responsible for the desirable features disclosed herein.

A user equipment (UE) for wireless communication is described. The UE may be configured to, capable of, or operable to perform one or more operations as described herein. For example, the UE may be configured to, capable of, or operable to receive a first message including data that indicates an authenticated encryption algorithm and an authenticated encryption mode associated with at least one of integrity protection or ciphering, verify, based on the data, an integrity of the first message using the authenticated encryption algorithm, and transmit, based on the integrity of the first message being verified, a second message, where the second message is associated with activation of at least one of the integrity protection or the ciphering based on the authenticated encryption mode.

A processor (e.g., a standalone processor chipset, or a component of a UE) for wireless communication is described. The processor may be configured to, capable of, or operable to perform one or more operations as described herein. For example, the processor may be configured to, capable of, or operable to receive a first message including data that indicates an authenticated encryption algorithm and an authenticated encryption mode associated with at least one of integrity protection or ciphering, verify, based on the data, an integrity of the first message using the authenticated encryption algorithm, and transmit, based on the integrity of the first message being verified, a second message, where the second message is associated with activation of at least one of the integrity protection or the ciphering based on the authenticated encryption mode.

A method performed or performable by a UE for wireless communication is described. The method may include receiving a first message including data that indicates an authenticated encryption algorithm and an authenticated encryption mode associated with at least one of integrity protection or ciphering, verifying, based on the data, an integrity of the first message using the authenticated encryption algorithm, and transmitting, based on the integrity of the first message being verified, a second message, where the second message is associated with activation of at least one of the integrity protection or the ciphering based on the authenticated encryption mode.

In some implementations of the UE, the processor, and the method described herein, the UE, the processor, and the method may further be configured to, capable of, or operable to determine a security key (e.g., cryptographic value, security parameter) based on one or more of an anchor key, an algorithm identifier associated with the authenticated encryption algorithm, the authenticated encryption mode, or a nonce value, where at least one of the integrity protection or the ciphering is based on the security key, and where the anchor key includes one of an access and mobility management function (AMF) key, a radio anchor key, or a network key. In some implementations, the UE, the processor, and the method may further be configured to, capable of, or operable to determine the nonce value based on at least one of a count value, a direction bit, a bearer identifier, or the algorithm identifier. In some implementations, the data includes the nonce value, and the nonce value is based on at least one of a counter, a sequence number, a random value, time information, or the authenticated encryption mode. In some implementations, the UE, the processor, and the method may further be configured to, capable of, or operable to determine the nonce value based on at least one of a counter, a sequence number, a random value, time information, or the authenticated encryption mode, where the second message indicates the nonce value.

In some implementations, the first message includes a first authentication tag, and to verify the integrity of the first message, the UE, the processor, and the method may further be configured to, capable of, or operable to generate, using the authenticated encryption algorithm, a second authentication tag based on the security key, the nonce value, and the data, where the integrity of the first message is verified based on the second authentication tag matching the first authentication tag. In some implementations, the UE, the processor, and the method may further be configured to, capable of, or operable to transmit, prior to receiving the first message, a third message that indicates UE security capabilities, including support for the authenticated encryption algorithm and one or more supported authenticated encryption modes, where the data is based on the UE security capabilities. In some implementations, the authenticated encryption mode is associated with the integrity protection and the ciphering, and the UE, the processor, and the method may further be configured to, capable of, or operable to obtain, after the activation of the integrity protection and the ciphering, a first portion associated with a third message and a second portion associated with the third message, where the first portion includes sensitive information elements and the second portion includes non-sensitive information elements, generate, using the authenticated encryption algorithm, ciphertext based on a security key, a nonce value, the second portion as additional data for the integrity protection, the authenticated encryption mode, and the first portion as plaintext, generate, using the authenticated encryption algorithm, an authentication tag based on the security key, the nonce value, the additional data, the authenticated encryption mode, and the ciphertext, and transmit the third message including at least the ciphertext, the second portion, and the authentication tag.

In some implementations, the authenticated encryption mode is associated with the integrity protection and the ciphering, and the UE, the processor, and the method may further be configured to, capable of, or operable to receive, after transmitting the second message, a third message including at least a ciphertext, a second portion of the third message, and a first authentication tag, where the third message is associated with a first portion including sensitive information elements, and where the second portion includes non-sensitive information elements, generate, using the authenticated encryption algorithm, a second authentication tag based on a security key, a nonce value, the second portion as additional data, the authenticated encryption mode, and the ciphertext, verify an integrity of the third message based on the first authentication tag matching the second authentication tag, and obtain, using the authenticated encryption algorithm, plaintext associated with the ciphertext based on the security key, the nonce value, the additional data, the authenticated encryption mode, and the ciphertext. In some implementations, the authenticated encryption mode is associated with the integrity protection, and the UE, the processor, and the method may further be configured to, capable of, or operable to obtain, after the activation of the integrity protection, additional data associated with a third message, generate, using the authenticated encryption algorithm, an authentication tag based on a security key, a nonce value, and the additional data, where a ciphertext associated with the authenticated encryption algorithm includes a null value based on the authenticated encryption mode, and transmit the third message including at least the additional data and the authentication tag.

In some implementations, the authenticated encryption mode is associated with the integrity protection, and the UE, the processor, and the method may further be configured to, capable of, or operable to receive, after transmitting the second message, a third message including at least additional data, a ciphertext including a null value, and a first authentication tag, generate, using the authenticated encryption algorithm, a second authentication tag based on a security key, a nonce value, the additional data, and the null value, verify an integrity of the third message based on the first authentication tag matching the second authentication tag, and refrain from obtaining plaintext associated with the ciphertext based on the authenticated encryption mode. In some implementations, the authenticated encryption mode is associated with the ciphering, and the UE, the processor, and the method may further be configured to, capable of, or operable to obtain, after the activation of the ciphering, plaintext associated with a third message, where the third message includes a null value corresponding to additional data, generate, using the authenticated encryption algorithm, a ciphertext associated with the plaintext based on a security key, the null value, a nonce value, and the authenticated encryption mode, and transmit the third message including at least the ciphertext, where an authentication tag associated with the authenticated encryption algorithm includes the null value based on the authenticated encryption mode. In some implementations, the authenticated encryption mode is associated with the ciphering, and the UE, the processor, and the method may further be configured to, capable of, or operable to receive, after transmitting the second message, a third message including at least a ciphertext and a null value corresponding to additional data, refrain from verifying an integrity of the third message based on the authenticated encryption mode, and obtain, using the authenticated encryption algorithm, plaintext associated with the ciphertext based on a security key, a nonce value, the authenticated encryption mode, the null value as the additional data, and the ciphertext.

In some implementations, the authenticated encryption mode is associated with the integrity protection and the ciphering, and the UE, the processor, and the method may further be configured to, capable of, or operable to obtain, after the activation of the integrity protection and the ciphering, plaintext associated with a third message, where the third message includes a null value corresponding to additional data, generate, using the authenticated encryption algorithm, a ciphertext associated with the plaintext based on the plaintext, a security key, a nonce value, the authenticated encryption mode, and the null value, generate, using the authenticated encryption algorithm, an authentication tag based on the security key, the nonce value, the null value, the authenticated encryption mode, and the ciphertext, and transmit the third message including at least the ciphertext and the authentication tag. In some implementations, the authenticated encryption mode is associated with the integrity protection and the ciphering, and the UE, the processor, and the method may further be configured to, capable of, or operable to receive, after transmitting the second message, a third message including ciphertext and a first authentication tag, where the third message includes a null value corresponding to additional data, generate, using the authenticated encryption algorithm, a second authentication tag based on a security key, a nonce value, the null value, the authenticated encryption mode, and the ciphertext, verify an integrity of the third message based on the first authentication tag matching the second authentication tag, and obtain, using the authenticated encryption algorithm, plaintext associated with the ciphertext based on the security key, the nonce value, the authenticated encryption mode, the null value, and the ciphertext. In some implementations, the first message includes at least one of an access stratum (AS) security mode command, a non-AS (NAS) security mode command, or a radio resource control (RRC) connection reconfiguration message, and the second message includes at least one of an AS security mode complete message, a NAS security mode complete message, or an RRC connection reconfiguration complete message. In some implementations, the data includes one or more of a count value, a bearer identifier, a direction bit, a nonce value, or security context information.

A network entity (NE) for wireless communication is described. The NE may be configured to, capable of, or operable to perform one or more operations as described herein. For example, the NE may be configured to, capable of, or operable to transmit a first message including data that indicates an authenticated encryption algorithm and an authenticated encryption mode associated with at least one of integrity protection or ciphering, and receive a second message based on the authenticated encryption mode and an integrity of the first message, where the second message is associated with activation of at least one of the integrity protection or the ciphering.

A processor (e.g., a standalone processor chipset, or a component of an NE) for wireless communication is described. The processor may be configured to, capable of, or operable to perform one or more operations as described herein. For example, the processor may be configured to, capable of, or operable to transmit a first message including data that indicates an authenticated encryption algorithm and an authenticated encryption mode associated with at least one of integrity protection or ciphering, and receive a second message based on the authenticated encryption mode and an integrity of the first message, where the second message is associated with activation of at least one of the integrity protection or the ciphering.

A method performed or performable by an NE (e.g., a base station) for wireless communication is described. The method may include transmitting a first message including data that indicates an authenticated encryption algorithm and an authenticated encryption mode associated with at least one of integrity protection or ciphering, and receiving a second message based on the authenticated encryption mode and an integrity of the first message, where the second message is associated with activation of at least one of the integrity protection or the ciphering.

In some implementations of the NE, the processor, and the method described herein, the NE, the processor, and the method may further be configured to, capable of, or operable to determine a security key based on one or more of an anchor key, an algorithm identifier associated with the authenticated encryption algorithm, the authenticated encryption mode, or a nonce value, where at least one of the integrity protection or the ciphering is based on the security key, and where the anchor key includes one of an AMF key, a radio anchor key, or a network key. In some implementations, the NE, the processor, and the method may further be configured to, capable of, or operable to determine the nonce value based on at least one of a count value, a direction bit, a bearer identifier, or the algorithm identifier. In some implementations, the second message includes the nonce value, and the nonce value is based on at least one of a counter, a sequence number, a random value, time information, or the authenticated encryption mode. In some implementations, the NE, the processor, and the method may further be configured to, capable of, or operable to determine the nonce value based on at least one of a counter, a sequence number, a random value, time information, or the authenticated encryption mode, where the data indicates the nonce value.

In some implementations, the NE, the processor, and the method may further be configured to, capable of, or operable to receive, prior to transmitting the first message, a third message that indicates UE security capabilities, including support for the authenticated encryption algorithm and one or more supported authenticated encryption modes, where the data is based on the UE security capabilities. In some implementations, the authenticated encryption mode is associated with the integrity protection and the ciphering, and the NE, the processor, and the method may further be configured to, capable of, or operable to obtain, after the activation of the integrity protection and the ciphering, a first portion associated with a third message and a second portion associated with the third message, where the first portion includes sensitive information elements and the second portion includes non-sensitive information elements, generate, using the authenticated encryption algorithm, ciphertext based on a security key, a nonce value, the second portion as additional data for the integrity protection, the authenticated encryption mode, and the first portion as plaintext, generate, using the authenticated encryption algorithm, an authentication tag based on the security key, the nonce value, the additional data, the authenticated encryption mode, and the ciphertext, and transmit the third message including at least the ciphertext, the second portion, and the authentication tag.

In some implementations, the authenticated encryption mode is associated with the integrity protection and the ciphering, and the NE, the processor, and the method may further be configured to, capable of, or operable to receive, after receiving the second message, a third message including at least a ciphertext, a second portion of the third message, and a first authentication tag, where the third message is associated with a first portion including sensitive information elements, and where the second portion includes non-sensitive information elements, generate, using the authenticated encryption algorithm, a second authentication tag based on a security key, a nonce value, the second portion as additional data, the authenticated encryption mode, and the ciphertext, verify an integrity of the third message based on the first authentication tag matching the second authentication tag, and obtain, using the authenticated encryption algorithm, plaintext associated with the ciphertext based on the security key, the nonce value, the additional data, the authenticated encryption mode, and the ciphertext. In some implementations, the authenticated encryption mode is associated with the integrity protection, and the NE, the processor, and the method may further be configured to, capable of, or operable to obtain, after the activation of the integrity protection, additional data associated with a third message, generate, using the authenticated encryption algorithm, an authentication tag based on a security key, a nonce value, and the additional data, where a ciphertext associated with the authenticated encryption algorithm includes a null value based on the authenticated encryption mode, and transmit the third message including at least the additional data and the authentication tag.

In some implementations, the authenticated encryption mode is associated with the integrity protection, and the NE, the processor, and the method may further be configured to, capable of, or operable to receive, after receiving the second message, a third message including at least additional data, a ciphertext including a null value, and a first authentication tag, generate, using the authenticated encryption algorithm, a second authentication tag based on a security key, a nonce value, the additional data, and the null value, verify an integrity of the third message based on the first authentication tag matching the second authentication tag, and refrain from obtaining plaintext associated with the ciphertext based on the authenticated encryption mode. In some implementations, the authenticated encryption mode is associated with the ciphering, and the NE, the processor, and the method may further be configured to, capable of, or operable to obtain, after the activation of the ciphering, plaintext associated with a third message, where the third message includes a null value corresponding to additional data, generate, using the authenticated encryption algorithm, a ciphertext associated with the plaintext based on a security key, the null value, a nonce value, and the authenticated encryption mode, and transmit the third message including at least the ciphertext, where an authentication tag associated with the authenticated encryption algorithm includes the null value based on the authenticated encryption mode. In some implementations, the authenticated encryption mode is associated with the ciphering, and the NE, the processor, and the method may further be configured to, capable of, or operable to receive, after receiving the second message, a third message including at least a ciphertext and a null value corresponding to additional data, refrain from verifying an integrity of the third message based on the authenticated encryption mode, and obtain, using the authenticated encryption algorithm, plaintext associated with the ciphertext based on a security key, a nonce value, the authenticated encryption mode, the null value as the additional data, and the ciphertext.

In some implementations, the authenticated encryption mode is associated with the integrity protection and the ciphering, and the NE, the processor, and the method may further be configured to, capable of, or operable to obtain, after the activation of the integrity protection and the ciphering, plaintext associated with a third message, where the third message includes a null value corresponding to additional data, generate, using the authenticated encryption algorithm, a ciphertext associated with the plaintext based on the plaintext, a security key, a nonce value, the authenticated encryption mode, and the null value, generate, using the authenticated encryption algorithm, an authentication tag based on the security key, the nonce value, the null value, the authenticated encryption mode, and the ciphertext, and transmit the third message including at least the ciphertext and the authentication tag. In some implementations, the authenticated encryption mode is associated with the integrity protection and the ciphering, and the NE, the processor, and the method may further be configured to, capable of, or operable to receive, after receiving the second message, a third message including ciphertext and a first authentication tag, where the third message includes a null value corresponding to additional data, generate, using the authenticated encryption algorithm, a second authentication tag based on a security key, a nonce value, the null value, the authenticated encryption mode, and the ciphertext, verify an integrity of the third message based on the first authentication tag matching the second authentication tag, and obtain, using the authenticated encryption algorithm, plaintext associated with the ciphertext based on the security key, the nonce value, the authenticated encryption mode, the null value, and the ciphertext. In some implementations, the first message includes at least one of an AS security mode command, a NAS security mode command, or an RRC connection reconfiguration message, and the second message includes at least one of an AS security mode complete message, a NAS security mode complete message, or an RRC connection reconfiguration complete message. In some implementations, the data includes one or more of a count value, a bearer identifier, a direction bit, a nonce value, or security context information.

### BRIEF DESCRIPTION OF THE DRAWINGS

FIG. 1 illustrates an example of a wireless communications system in accordance with aspects of the present disclosure.

FIG. 2 illustrates an example of a ciphering architecture diagram, in accordance with aspects of the present disclosure.

FIGS. 3 and 4 illustrate examples of integrity protection diagrams, in accordance with aspects of the present disclosure.

FIGS. 5 through 7 illustrate examples of authenticated encryption algorithm diagrams, in accordance with aspects of the present disclosure.

FIGS. 8 through 10 illustrate examples of signaling diagrams, in accordance with aspects of the present disclosure.

FIG. 11 illustrates an example of a UE in accordance with aspects of the present disclosure.

FIG. 12 illustrates an example of a processor in accordance with aspects of the present disclosure.

FIG. 13 illustrates an example of an NE in accordance with aspects of the present disclosure.

FIG. 14 illustrates a flowchart of a method performed by a UE in accordance with aspects of the present disclosure.

FIG. 15 illustrates a flowchart of a method performed by an NE in accordance with aspects of the present disclosure.

### DETAILED DESCRIPTION

In a wireless communications system, a UE and an NE (e.g., a base station, a gNB, a network function) may support transmission and reception of messages, referred to as wireless communication. The UE and/or the NE may implement security mechanisms to protect the messages. For example, the UE and/or the NE may implement integrity protection to detect unauthorized modifications to a message during transmission by generating and verifying an authentication code. Additionally, or alternatively, the UE and/or the NE may implement ciphering to transform plaintext from a message content into ciphertext, which may prevent unauthorized access to the message content. In some cases, the UE and/or the NE may implement an authenticated encryption algorithm to combine integrity protection and ciphering into a single algorithm, leading to improved throughput and reduced latency compared to using separate algorithms for integrity protection and ciphering. However, different messages and/or message portions may have varying security criteria. For example, a UE and/or an NE may implement both ciphering and integrity protection for sensitive information elements (e.g., information elements with privacy or security considerations), while implementing integrity protection without ciphering for non-sensitive information elements (e.g., information elements without privacy or security considerations). During security establishment, the UE and/or the NE may transmit one or more information elements in plaintext to enable a receiving entity to derive security keys and verify the protected message. The input parameters used by authenticated encryption algorithms, such as a nonce value and associated data, may differ from the input parameters used in current wireless communications security procedures, such as count values, bearer identifiers, and direction indicators. The mismatch between authenticated encryption algorithm input parameters and current wireless communications security parameters may result in deciphering and integrity verification failures (e.g., due to inconsistent input parameter definitions). Additionally, or alternatively, some authenticated encryption algorithms may not support selective ciphering and integrity protection of different portions of a message, which may result in increased processing overhead.

As described herein, to address the mismatch between authenticated encryption algorithm input parameters and current wireless communications security parameters, as well as to enable selective ciphering and integrity protection of different message portions, a UE and an NE may implement authenticated encryption algorithm configuration and activation that accounts for various authenticated encryption modes. The NE may transmit a first message (e.g., a security mode command, an RRC connection reconfiguration message) to a UE that indicates an authenticated encryption algorithm and an authenticated encryption mode for at least one of integrity protection or ciphering. The UE may then verify an integrity of the first message using the authenticated encryption algorithm and input parameters, such as a security key, a nonce value, and data derived from or indicated in the first message. The UE may transmit a second message (e.g., a security mode complete message, an RRC connection reconfiguration complete message) after the UE verifies the integrity of the first message, where the second message activates at least one of the integrity protection or the ciphering according to the authenticated encryption mode. The NE may receive the second message and may activate ciphering and/or integrity protection according to the authenticated encryption mode.

By performing the described techniques, a device (e.g., a UE and/or an NE) in a wireless communications system may provide for improved security flexibility, reduced processing overhead, and enhanced interoperability during security establishment procedures. For example, the UE and the NE use authenticated encryption algorithms with configurable modes to enable selective application of ciphering and integrity protection according to the sensitivity of different message portions, which reduces processing overhead for non-sensitive information elements. Additionally, or alternatively, the use of authenticated encryption algorithms with configurable modes enables the UE and the NE to establish consistent security parameters during security establishment procedures, which enhances interoperability and reduces the likelihood of deciphering and integrity verification failures that may otherwise occur due to inconsistent input parameter definitions between devices.

Reference is made herein to communicating data or information, such as signaling communication resources and/or communications that are transmitted or received between devices. It is to be appreciated that other terms may be used interchangeably with communicating, such as signaling, transmitting, receiving, outputting, forwarding, retrieving, obtaining, and so forth.

Aspects of the present disclosure are described in the context of a wireless communications system. Aspects of the present disclosure are further set forth in the accompanying drawings and the description below. The description set forth herein, in connection with the accompanying drawings, describes example implementations and does not represent all the implementations that may be implemented or that are within the scope of the claims. The detailed description includes specific details for the purpose of providing an understanding of the described implementations. These implementations, however, may be practiced without these specific details. Additionally, the description set forth herein, in connection with the accompanying drawings, is provided to enable a person having ordinary skill in the art to make or use the present disclosure. Various modifications to the disclosure will be apparent to a person having ordinary skill in the art, and the generic principles defined herein may be applied to other variations without departing from the scope of the present disclosure. Thus, the present disclosure is not limited to the examples and implementations described herein but is to be accorded the broadest scope consistent with the principles and novel features disclosed herein.

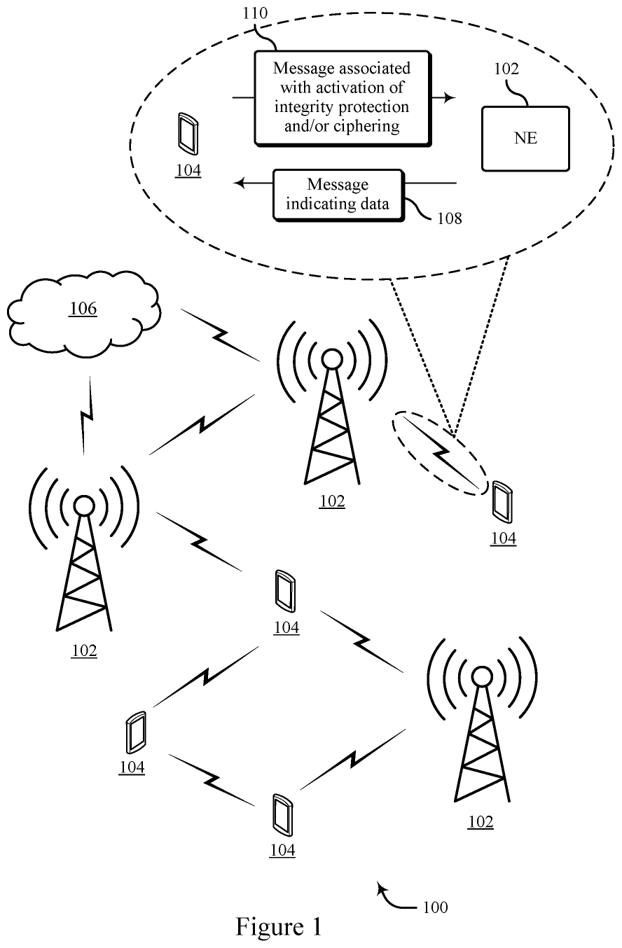

FIG. 1 illustrates an example of a wireless communications system 100 in accordance with aspects of the present disclosure. The wireless communications system 100 may include one or more NEs 102, one or more UEs 104, and a core network (CN) 106. The wireless communications system 100 may support various radio access technologies. In some implementations, the wireless communications system 100 may be a 4G network, such as an LTE network or an LTE-Advanced (LTE-A) network. In some other implementations, the wireless communications system 100 may be a NR network, such as a 5G network, a 5G-Advanced (5G-A) network, or a 5G ultrawideband (5G-UWB) network. In other implementations, the wireless communications system 100 may be a combination of a 4G network and a 5G network, or other suitable radio access technology including Institute of Electrical and Electronics Engineers (IEEE) 802.11 (Wi-Fi), IEEE 802.16 (WiMAX), IEEE 802.20. The wireless communications system 100 may support radio access technologies beyond 5G, for example, 6G. Additionally, the wireless communications system 100 may support technologies, such as time division multiple access (TDMA), frequency division multiple access (FDMA), or code division multiple access (CDMA), etc.

The one or more NEs 102 may be dispersed throughout a geographic region to form the wireless communications system 100. One or more of the NEs 102 described herein may be or include or may be referred to as a network node, a base station, an access point (AP), a network element, a network function, a network equipment, network infrastructure (or infrastructure), a radio access network (RAN), a NodeB, an eNodeB (eNB), a next-generation NodeB (gNB), or other suitable terminology. An NE 102 and a UE 104 may communicate via a communication link, which may be a wireless or wired connection. For example, an NE 102 and a UE 104 may perform wireless communication (e.g., receive signaling, transmit signaling) over a Uu interface.

An NE 102 may provide a geographic coverage area for which the NE 102 may support services for one or more UEs 104 within the geographic coverage area. For example, an NE 102 and a UE 104 may support wireless communication of signals related to services (e.g., voice, video, packet data, messaging, broadcast, etc.) according to one or multiple radio access technologies. In some implementations, an NE 102 may be movable, for example, a satellite associated with a non-terrestrial network (NTN). In some implementations, different geographic coverage areas associated with the same or different radio access technologies may overlap, but the different geographic coverage areas may be associated with different NEs 102.

The one or more UEs 104 may be dispersed throughout a geographic region of the wireless communications system 100. A UE 104 may include or may be referred to as a remote unit, a mobile device, a wireless device, a remote device, a subscriber device, a transmitter device, a receiver device, or some other suitable terminology. In some implementations, the UE 104 may be referred to as a unit, a station, a terminal, or a client, among other examples. Additionally, or alternatively, the UE 104 may be referred to as an Internet-of-Things (IoT) device, an Internet-of-Everything (IoE) device, or a machine-type communication (MTC) device, among other examples.

A UE 104 may be able to support wireless communication directly with other UEs 104 over a communication link. For example, a UE 104 may support wireless communication directly with another UE 104 over a device-to-device (D2D) communication link. In some implementations, such as vehicle-to-vehicle (V2V) deployments, vehicle-to-everything (V2X) deployments, or cellular-V2X deployments, the communication link may be referred to as a sidelink. For example, a UE 104 may support wireless communication directly with another UE 104 over a PC5 interface.

An NE 102 may support communications with the CN 106, or with another NE 102, or both. For example, an NE 102 may interface with other NEs 102 or the CN 106 through one or more backhaul links (e.g., S1, N2, N6, or other network interfaces). In some implementations, the NEs 102 may communicate with each other directly. In some other implementations, the NEs 102 may communicate with each other indirectly (e.g., via the CN 106). In some implementations, one or more NEs 102 may include subcomponents, such as an access NE, which may be an example of an access node controller (ANC). An ANC may communicate with the one or more UEs 104 through one or more other access network transmission entities, which may be referred to as radio heads, smart radio heads, or transmission-reception points (TRPs).

In some implementations, an NE 102 may be configured in a disaggregated architecture, which may be configured to utilize a protocol stack physically or logically distributed among two or more network entities, such as an integrated access backhaul (IAB) network, an open RAN (O-RAN) (e.g., a network configuration sponsored by the O-RAN Alliance), or a virtualized RAN (vRAN) (e.g., a cloud RAN (C-RAN)). For example, an NE 102 may include one or more of a central unit (CU), a distributed unit (DU), a radio unit (RU), a RAN Intelligent Controller (RIC) (e.g., a Near-Real Time RIC (Near-RT RIC), a Non-Real Time RIC (Non-RT RIC)), a Service Management and Orchestration (SMO) system, or any combination thereof.

An RU may also be referred to as a radio head, a smart radio head, a remote radio head (RRH), a remote radio unit (RRU), or a transmission reception point (TRP). One or more components of the network entities in a disaggregated RAN architecture may be co-located, or one or more components of the network entities may be located in distributed locations (e.g., separate physical locations). In some implementations, one or more network entities of a disaggregated RAN architecture may be implemented as virtual units (e.g., a virtual CU (VCU), a virtual DU (VDU), a virtual RU (VRU)).

Split of functionality between a CU, a DU, and an RU may be flexible and may support different functionalities depending upon which functions (e.g., network layer functions, protocol layer functions, baseband functions, radio frequency functions, and any combinations thereof) are performed at a CU, a DU, or an RU. For example, a functional split of a protocol stack may be employed between a CU and a DU such that the CU may support one or more layers of the protocol stack and the DU may support one or more different layers of the protocol stack. In some implementations, the CU may host upper protocol layer (e.g., a layer 3 (L3), a layer 2 (L2)) functionality and signaling (e.g., RRC, service data adaptation protocol (SDAP), Packet Data Convergence Protocol (PDCP)). The CU may be connected to one or more DUs or RUs, and the one or more DUs or RUs may host lower protocol layers, such as a layer 1 (L1) (e.g., physical (PHY) layer) or an L2 (e.g., radio link control (RLC) layer, medium access control layer) functionality and signaling, and may each be at least partially controlled by the CU.

Additionally, or alternatively, a functional split of the protocol stack may be employed between a DU and an RU such that the DU may support one or more layers of the protocol stack, and the RU may support one or more different layers of the protocol stack. The DU may support one or multiple different cells (e.g., via one or more RUs). In some implementations, a functional split between a CU and a DU, or between a DU and an RU may be within a protocol layer (e.g., some functions for a protocol layer may be performed by one of a CU, a DU, or an RU, while other functions of the protocol layer are performed by a different one of the CU, the DU, or the RU).

A CU may be functionally split further into CU control plane (CU-CP) and CU user plane (CU-UP) functions. A CU may be connected to one or more DUs via a midhaul communication link (e.g., F1, F1-c, F1-u), and a DU may be connected to one or more RUs via a fronthaul communication link (e.g., open fronthaul (FH) interface). In some implementations, a midhaul communication link or a fronthaul communication link may be implemented in accordance with an interface (e.g., a channel) between layers of a protocol stack supported by respective network entities that are in communication via such communication links.

The CN 106 may support user authentication, access authorization, tracking, connectivity, and other access, routing, or mobility functions. The CN 106 may be an evolved packet core (EPC), or a 5G core (5GC), which may include a control plane entity that manages access and mobility (e.g., a mobility management entity (MME), an AMF) and a user plane entity that routes packets or interconnects to external networks (e.g., a serving gateway (S-GW), a packet data network (PDN) gateway (P-GW), or a user plane function (UPF)). In some implementations, the control plane entity may manage NAS functions, such as mobility, authentication, and bearer management (e.g., data bearers, signal bearers, etc.) for the one or more UEs 104 served by the one or more NEs 102 associated with the CN 106.

The CN 106 may communicate with a packet data network over one or more backhaul links (e.g., via an S1, N2, N6, or other network interface). The packet data network may include an application server. In some implementations, one or more UEs 104 may communicate with the application server. A UE 104 may establish a session (e.g., a protocol data unit (PDU) session, or the like) with the CN 106 via an NE 102. The CN 106 may route traffic (e.g., control information, data, and the like) between the UE 104 and the application server using the established session (e.g., the established PDU session). The PDU session may be an example of a logical connection between the UE 104 and the CN 106 (e.g., one or more network functions of the CN 106).

In the wireless communications system 100, the NEs 102 and the UEs 104 may use resources of the wireless communications system 100 (e.g., time resources (e.g., symbols, slots, subframes, frames, or the like) or frequency resources (e.g., subcarriers, carriers)) to perform various operations (e.g., wireless communications). In some implementations, the NEs 102 and the UEs 104 may support different resource structures. For example, the NEs 102 and the UEs 104 may support different frame structures. In some implementations, such as in 4G, the NEs 102 and the UEs 104 may support a single frame structure. In some other implementations, such as in 5G and among other suitable radio access technologies, the NEs 102 and the UEs 104 may support various frame structures (i.e., multiple frame structures). The NEs 102 and the UEs 104 may support various frame structures based on one or more numerologies.

One or more numerologies may be supported in the wireless communications system 100, and a numerology may include a subcarrier spacing and a cyclic prefix. A first numerology (e.g., μ=0) may be associated with a first subcarrier spacing (e.g., 15 kHz) and a normal cyclic prefix. In some implementations, the first numerology (e.g., μ=0) associated with the first subcarrier spacing (e.g., 15 kHz) may utilize one slot per subframe. A second numerology (e.g., μ=1) may be associated with a second subcarrier spacing (e.g., 30 kHz) and a normal cyclic prefix. A third numerology (e.g., μ=2) may be associated with a third subcarrier spacing (e.g., 60 kHz) and a normal cyclic prefix or an extended cyclic prefix. A fourth numerology (e.g., μ=3) may be associated with a fourth subcarrier spacing (e.g., 120 kHz) and a normal cyclic prefix. A fifth numerology (e.g., μ=4) may be associated with a fifth subcarrier spacing (e.g., 240 kHz) and a normal cyclic prefix.

A time interval of a resource (e.g., a communication resource) may be organized according to frames (also referred to as radio frames). Each frame may have a duration, for example, a 10 millisecond (ms) duration. In some implementations, each frame may include multiple subframes. For example, each frame may include 10 subframes, and each subframe may have a duration, for example, a 1 ms duration. In some implementations, each frame may have the same duration. In some implementations, each subframe of a frame may have the same duration.

Additionally, or alternatively, a time interval of a resource (e.g., a communication resource) may be organized according to slots. For example, a subframe may include a number (e.g., quantity) of slots. The number of slots in each subframe may also depend on the one or more numerologies supported in the wireless communications system 100. For instance, the first, second, third, fourth, and fifth numerologies (i.e., μ=0, μ=1, μ=2, μ=3, μ=4) associated with respective subcarrier spacings of 15 kHz, 30 kHz, 60 kHz, 120 kHz, and 240 kHz may utilize a single slot per subframe, two slots per subframe, four slots per subframe, eight slots per subframe, and 16 slots per subframe, respectively. Each slot may include a number (e.g., quantity) of symbols (e.g., OFDM symbols). In some implementations, the number (e.g., quantity) of slots for a subframe may depend on a numerology. For a normal cyclic prefix, a slot may include 14 symbols. For an extended cyclic prefix (e.g., applicable for 60 kHz subcarrier spacing), a slot may include 12 symbols. The relationship between the number of symbols per slot, the number of slots per subframe, and the number of slots per frame for a normal cyclic prefix and an extended cyclic prefix may depend on a numerology. It should be understood that reference to a first numerology (e.g., μ=0) associated with a first subcarrier spacing (e.g., 15 kHz) may be used interchangeably between subframes and slots.

In the wireless communications system 100, an electromagnetic (EM) spectrum may be split, based on frequency or wavelength, into various classes, frequency bands, frequency channels, etc. By way of example, the wireless communications system 100 may support one or multiple operating frequency bands, such as frequency range designations FR1 (410 MHz-7.125 GHZ), FR2 (24.25 GHz-52.6 GHz), FR3 (7.125 GHz-24.25 GHZ), FR4 (52.6 GHz-114.25 GHZ), FR4a or FR4-1 (52.6 GHz-71 GHz), and FR5 (114.25 GHz-300 GHz). In some implementations, the NEs 102 and the UEs 104 may perform wireless communications over one or more of the operating frequency bands. In some implementations, FR1 may be used by the NEs 102 and the UEs 104, among other equipment or devices for cellular communications traffic (e.g., control information, data). In some implementations, FR2 may be used by the NEs 102 and the UEs 104, among other equipment or devices for short-range, high data rate capabilities.

FR1 may be associated with one or multiple numerologies (e.g., at least three numerologies). For example, FR1 may be associated with a first numerology (e.g., μ=0), which includes 15 kHz subcarrier spacing; a second numerology (e.g., μ=1), which includes 30 kHz subcarrier spacing; and a third numerology (e.g., μ=2), which includes 60 kHz subcarrier spacing. FR2 may be associated with one or multiple numerologies (e.g., at least two numerologies). For example, FR2 may be associated with a third numerology (e.g., μ=2), which includes 60 kHz subcarrier spacing; and a fourth numerology (e.g., μ=3), which includes 120 kHz subcarrier spacing.

In the wireless communications system 100, an NE 102 may include, or may be an example of, various network devices involved in security procedures for wireless communications. For example, an NE 102 may include, or may be, an AMF, a RAN node, including a gNB or an ng-eNB, or other network functions that participate in the security procedures. The AMF may be a control plane entity within the CN 106 that manages NAS security procedures, including NAS security mode command procedures for establishing a NAS security context between the UE 104 and the AMF. The gNB or ng-eNB may be a RAN node that manages AS security procedures, including AS security mode command procedures for establishing an AS security context (e.g., RRC security and user plane security) between the UE 104 and the RAN node. The NE 102 may also participate in RRC connection reconfiguration procedures for activating user plane security on a per data radio bearer (DRB) basis. A bearer refers to a logical channel or data path established between the UE 104 and the network for carrying user data or signaling information. For example, a DRB may carry user plane data, including internet traffic or voice data, among other examples, while a signaling radio bearer (SRB) may carry control plane signaling, including RRC messages. Each bearer may be identified by a bearer identifier, which is used as an input parameter for security procedures to ensure that security protection is applied on a per-bearer basis.

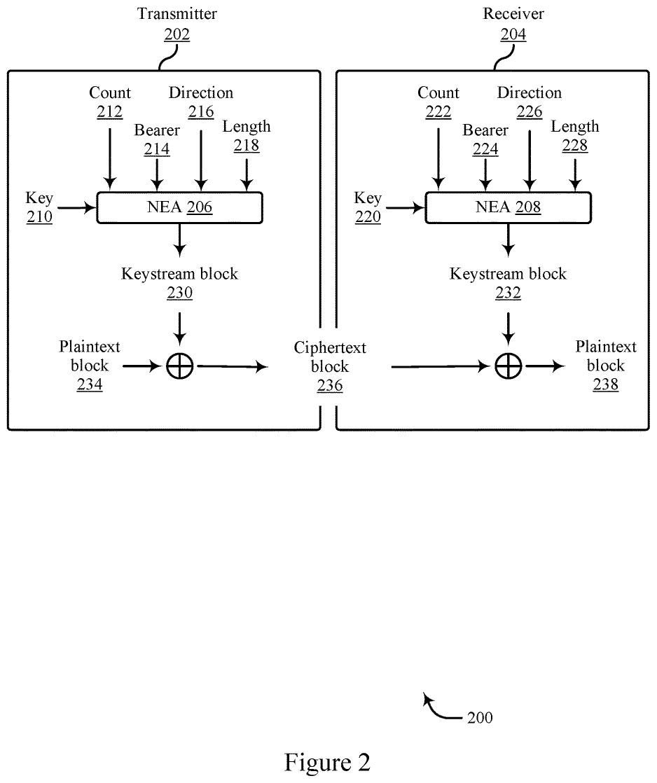

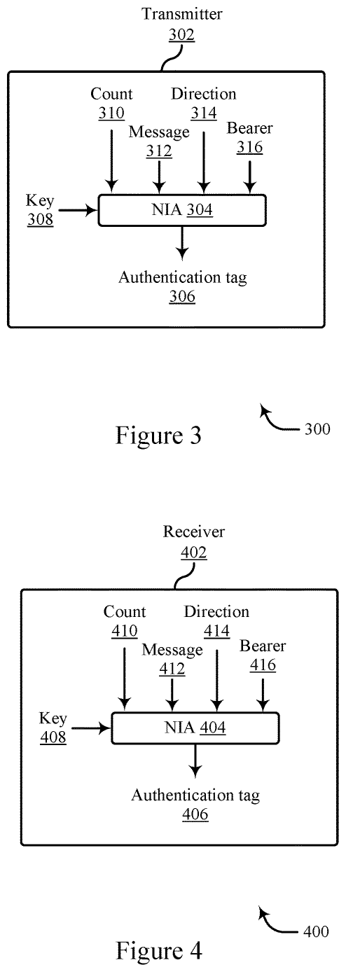

Security procedures in the wireless communications system 100 may include integrity protection and ciphering operations. For integrity protection, one or more devices (e.g., NEs 102 and/or UEs 104) may ensure an authenticity and integrity of a message by detecting unauthorized modifications during transmission. For ciphering and/or deciphering (e.g., which may be referred to as ciphering), the devices may provide confidentiality protection by transforming plaintext data into ciphertext to prevent unauthorized entities from accessing the content of the message. In some examples, integrity protection and ciphering may be performed as separate operations using independent algorithms with distinct security keys. For example, a sender may provide input parameters, including a security key, a count value, a bearer identifier, a direction indicator, and/or a message, to an algorithm for integrity protection. The algorithm may output (e.g., generate) a message authentication code (MAC) or authentication tag that is appended to a message for verification by a receiver, which is described in further detail with respect to FIGS. 3 and 4. A count value refers to a sequence number or counter that is maintained by both the transmitting (e.g., sending) and receiving entities to ensure freshness and prevent replay attacks. For example, a NAS count may be used for NAS layer security operations between the UE 104 and the AMF, while a PDCP count may be used for AS layer security operations between the UE 104 and the RAN node. The direction indicator indicates whether the transmission is in the uplink direction (e.g., from UE 104 to NE 102) or the downlink direction (e.g., from NE 102 to UE 104). Additionally, or alternatively, a sender may provide input parameters to an algorithm for ciphering, as well as the plaintext message, and may obtain a keystream (e.g., cipher stream, encryption stream) that is combined with the plaintext as output from the algorithm to produce ciphertext, which is described in further detail with respect to FIG. 2.

Authenticated encryption algorithms, including authenticated encryption with associated data (AEAD) algorithms, combine integrity protection and ciphering operations into a single unified algorithm. The authenticated encryption algorithm may be a numerical quantity of bits, such as a 256-bit cryptographic algorithm. An authenticated encryption algorithm may receive inputs, including a secret key, a nonce value, associated data (e.g., which may also be referred to as data), and plaintext. The authenticated encryption algorithm may produce outputs, including ciphertext and an authentication tag. A nonce value refers to a number used once that provides uniqueness for each invocation of the authenticated encryption algorithm. The nonce value may be unique (e.g., distinct, non-repeating) for each invocation of the authenticated encryption algorithm for a security key. For example, the nonce value may be constructed from parameters, such as a count value, a direction bit, a bearer identifier, or an algorithm identifier, or may be generated using a counter, a sequence number, a random value, or time information. The associated data (e.g., data) represents data that is to be authenticated (e.g., integrity protected), but not encrypted (e.g., ciphered). For example, the associated data may include non-sensitive information elements, such as message headers or security context information, that implement integrity protection, but do not implement confidentiality protection. The plaintext represents data that is to be both encrypted and authenticated. The ciphertext represents the encrypted form of the plaintext, and the authentication tag provides integrity verification for both the ciphertext and the associated data.

Authenticated encryption algorithms may provide security advantages for the wireless communications system 100. For example, the devices in the wireless communications system 100 (e.g., UEs 104 and/or NEs 102) may adopt the authenticated encryption algorithms, including AEAD algorithms, to increase throughput and support data-intensive applications. In some 5G systems, authenticated encryption is achieved in PDCP and NAS protocols by invoking different combinations of standalone ciphering and integrity algorithms. A PDCP protocol is a layer 2 protocol that performs functions, including header compression, ciphering, and integrity protection, for user plane and control plane data in the RAN. The NAS layer is a protocol layer between the UE 104 and the CN 106 (e.g., the AMF) that handles functions, such as mobility management, session management, and security. Authenticated encryption algorithms provide authenticated encryption in a single invocation, which may improve throughput and reduce latency compared to performing separate ciphering and integrity protection operations.

Integrity protection for encrypted user plane data addresses security vulnerabilities that have been identified in some wireless communications systems. In some 5G systems, integrity protection for user plane is possible, but remains optional. For some 6G systems, the integrity protection for encrypted user plane data may not be optional to address evolving threat environments, where technology for mounting man-in-the-middle attacks on the air interface is increasingly available. To use authenticated encryption algorithms for NAS and AS security, including control plane and user plane security, some AS and NAS security procedures may be enhanced to support input parameter usage at the UE 104 and the NE 102, including to enable selective ciphering and integrity protection using authenticated encryption algorithms. In some cases, 5G NAS and AS security mode command procedures involve NAS count as an input parameter for NAS protection and PDCP count as an input parameter for AS protection, including RRC and user plane protection. The NAS count and PDCP count are available at both the UE 104 and the NE 102, so no count value is explicitly transmitted over NAS or AS messages to support integrity verification and deciphering. However, some authenticated encryption algorithms may use a nonce value as an input parameter, such as for authenticated encryption algorithms-based ciphering and integrity protection. Without mechanisms for nonce value transmission between the NE 102 and the UE 104, and without input parameter definitions for use between the UE 104 and the NE 102, deciphering and integrity verification failures may occur.

Existing authenticated encryption algorithms support integrated complete ciphering and integrity protection, but may not facilitate selective ciphering and integrity protection of a message. Communications between the UE 104 and the NE 102 in the wireless communications system 100 may benefit from performance improvements and lower latency. One or more information elements in messages may be used for connection establishment and security establishment purposes. If the information elements are not sensitive, then the information elements may be authenticity or integrity protected without confidentiality protection. An information element refers to a discrete unit of data within a message that conveys defined information, such as a security algorithm identifier, a key set identifier, or UE security capabilities. Sensitive information elements may include data with privacy or security considerations, such as subscriber identifiers or encryption keys. Non-sensitive information elements may include data without privacy or security considerations, such as protocol version numbers or message type indicators. In some cases, authenticated encryption algorithms may not support flexible ciphering and integrity protection, which may result in increased processing overhead.

In some cases, the input parameters used by authenticated encryption algorithms may differ from the input parameters used in current wireless communications security procedures, which are described in further detail with respect to FIGS. 2 through 4. For example, the input parameters for current ciphering algorithms may include a cipher key, a count value, a bearer identity, a direction indicator, and a length parameter. The length parameter indicates the length of a keystream for the encryption operation. The ciphering algorithm generates a keystream block based on the input parameters, and the keystream block is combined with the plaintext using a bit-per-bit binary addition to produce ciphertext, which is described in further detail with respect to FIG. 2. Additionally, or alternatively, the input parameters for current integrity protection algorithms may include an integrity key, a count value, a bearer identity, a direction indicator, and the message. The integrity algorithm generates an authentication tag to be appended to the message for transmission, which is described in further detail with respect to FIG. 3. The receiver computes an expected authentication tag using the same integrity protection algorithm and input parameters, and verifies the data integrity by comparing the computed value with the received authentication tag, which is described in further detail with respect to FIG. 4.

The authenticated encryption algorithms, as described herein, use different input parameters than the current ciphering algorithms and integrity protection algorithms. For example, a transmitting device may provide input parameters to the authenticated encryption algorithm, including a secret key, a nonce value, associated data, and plaintext. The authenticated encryption algorithm outputs ciphertext and an authentication tag. The authentication tag is a cryptographic value that provides integrity verification, enabling a receiving device to detect any unauthorized modifications to the ciphertext or associated data. The receiving device may provide the input parameters to the authenticated encryption algorithm, including the secret key, the nonce value, the associated data, and the ciphertext, and the authenticated encryption algorithm outputs either the plaintext if the inputs are authentic or a failure indication if the inputs are not authentic.

In some cases, if the associated data input is constructed out of multiple data elements, then the associated data input may be unambiguously parseable into constituent elements, without the use of unauthenticated data in the parsing process. In mathematical terms, the associated data input may be an injective function of the data elements. If an application constructs the associated data input such that there are two distinct sets of data elements that result in the same associated data value, then an attacker could cause a receiver to accept a false set by substituting one set for the other. The associated data being uniquely parseable ensures that the attack is not possible. In some cases, to meet the criteria of being uniquely parseable, the associated data is composed of fixed-width elements. If the associated data includes a variable-length string, for example, then the criteria of being uniquely parseable can be met by also including the length of the string in the associated data. Similarly, if the plaintext is constructed out of multiple data elements, then the plaintext may be unambiguously parseable into constituent elements, without using unauthenticated data in the parsing process. Data included in the associated data may be used when parsing the plaintext, since the associated data is not encrypted, there is a potential loss of confidentiality when information about the plaintext is included in the associated data.

In some cases, to use an authenticated encryption algorithm, an application may define how the inputs of the authenticated encryption algorithm are defined in terms of application data, and how the ciphertext and nonce value are conveyed. For example, each input may be expressed in terms of the data that form the input, then the application data may be expressed in terms of the outputs of the authenticated encryption algorithm. For example, the authenticated encryption algorithm inputs may include a plaintext, P, which is constructed as P=RestOfPayloadData∥TFCpadding∥Padding∥PadLength∥NextHeader. A nonce value, N, is constructed as N=Salt∥IV. The associated data, A, is constructed as A=SPI∥SequenceNumber. In the expressions of the inputs, the symbol “∥” denotes a concatenation operation, and the fields RestOfPayloadData, TFCpadding, Padding, PadLength, NextHeader, SPI, SequenceNumber, Salt, and IV are defined values. The field RestOfPayloadData includes the plaintext data that is described by the NextHeader field, and no other data. The PayloadData field includes both the IV and the RestOfPayloadData. The format of a data packet can be expressed as ESP=SPI∥SequenceNumber∥IV∥C, where C is the authenticated encryption algorithm ciphertext, which incorporates the authentication tag.

In some cases, an authenticated encryption algorithm is defined by two operations, including authenticated encryption and authenticated decryption. The authenticated encryption operation is a deterministic operation that has four inputs, each a binary string (e.g., a secret key, K, of a fixed bit length, a nonce value, N, associated data, A, and a plaintext, P). The plaintext includes data to be encrypted and authenticated, and the associated data includes data to be authenticated (e.g., and not encrypted). Each nonce value may be unique in each distinct invocation of the operation for a value of the key. The authenticated encryption operation outputs a ciphertext, C. The authenticated decryption operation is also a deterministic operation that has four inputs, each a binary string (e.g., a secret key, K, of a fixed bit length, a nonce value, N, associated data, A, and a ciphertext, C). The decryption operation verifies the integrity of the ciphertext and associated data and decrypts the ciphertext. The operation returns a symbol (e.g., FAIL) if the inputs are not authentic. Otherwise, the operation returns a plaintext, P. In some cases, the authentication tag may be an independent output of the encryption operation and an independent input of the decryption operation.

In some cases, the input parameters for ciphering and integrity protection using an advanced encryption standard (AES), Zhou Zhongzhi (ZUC) stream cipher algorithm, and/or SNOW stream cipher algorithm may include count, direction, and bearer inputs, which are different from the definition of input parameters used by the authenticated encryption algorithm variants of AES, ZUC, and SNOW, such as a nonce value and associated data inputs. The mismatch between the input parameters used by authenticated encryption algorithms (e.g., the nonce value and associated data) and the input parameters used in the ciphering and integrity protection (e.g., in current wireless communications security procedures) may result in interoperability issues. For example, if the UE 104 and the NE 102 do not use consistent input parameter definitions when invoking the authenticated encryption algorithm, deciphering and integrity verification failures may occur. Additionally, or alternatively, the lack of a clear definition of input parameters for authenticated encryption algorithms to be used between the UE 104 and the NE 102 for message protection in the wireless communications system 100 may lead to operational issues.

Additionally, or alternatively, authenticated encryption algorithms may not support selective ciphering and integrity protection of different portions of a message. In some cases, a message exchanged between the UE 104 and the NE 102 may include both sensitive information elements (e.g., information elements with privacy or security considerations) and non-sensitive information elements (e.g., information elements without privacy or security considerations). The UE 104 and the NE 102 may implement both ciphering and integrity protection for the sensitive information elements, while implementing integrity protection without ciphering for the non-sensitive information elements. However, existing authenticated encryption algorithms may not facilitate selective protection, which may result in increased processing overhead if the entire (e.g., full) message is ciphered (e.g., even though portions of the message may not benefit from confidentiality protection).

During security establishment procedures, the UE 104 and the NE 102 may transmit one or more information elements in plaintext to enable a receiving entity to derive security keys and verify the protected message. For example, during a security mode command procedure, the NE 102 may transmit a security mode command message that includes information elements, such as the selected security algorithms, replayed UE security capabilities, and a key set identifier. A key set identifier is a value that identifies a security context or set of security keys, enabling the UE 104 and the NE 102 to reference the correct keys for security operations. The UE 104 uses the information elements to derive security keys and verify the integrity of the security mode command message. If the security mode command message is integrity protected using an authenticated encryption algorithm, then the UE 104 may obtain the input parameters (e.g., the nonce value, associated data) to perform the integrity verification. Without mechanisms for conveying the input parameters, the UE 104 may be unable to verify the integrity of the security mode command message, which may result in security establishment failures.

According to implementations, one or more of the NEs 102 and the UEs 104 are operable to implement various aspects of the techniques described with reference to the present disclosure. An NE 102 (e.g., a base station, gNB, AMF) transmits a message indicating data 108 to a UE 104. In some cases, the message indicating data 108 indicates an authenticated encryption algorithm and an authenticated encryption mode for at least one of integrity protection or ciphering. For example, the authenticated encryption mode may include selective ciphering or deciphering and integrity protection, combined ciphering or deciphering and integrity protection, ciphering or deciphering (e.g., without integrity protection), or integrity protection (e.g., without ciphering or deciphering). The data may include, but is not limited to, a nonce value, security context information, and the selected authenticated encryption mode. The UE 104 may use the data as input to the authenticated encryption algorithm to derive security keys and verify the integrity of the received message. For example, the UE 104 verifies the integrity of the message indicating data 108 using the indicated authenticated encryption algorithm and input parameters, including a security key, a nonce value, and additional data that the UE 104 derives from or obtains from the message indicating data 108. After the UE 104 verifies the integrity of the message indicating data 108, the UE 104 transmits a message associated with activation of integrity protection and/or ciphering 110 to the NE 102. In some cases, the message associated with activation of integrity protection and/or ciphering 110 indicates that at least one of the integrity protection or the ciphering has been activated at the UE 104 based on the authenticated encryption mode indicated in the message indicating data 108. In some other cases, the message associated with activation of integrity protection and/or ciphering 110 activates at least one of the integrity protection or the ciphering according to the authenticated encryption mode indicated in the message indicating data 108. The NE 102 receives the message associated with activation of the integrity protection and/or the ciphering 110 and activates ciphering and/or integrity protection according to the authenticated encryption mode.

Reference is made herein to communicating data or information, such as signaling communication resources and/or communications that are transmitted or received between devices. It is to be appreciated that other terms may be used interchangeably with communicating, such as signaling, transmitting, receiving, outputting, forwarding, retrieving, obtaining, and so forth.

FIG. 2 illustrates an example of a ciphering diagram 200 in accordance with aspects of the present disclosure. In some examples, the ciphering diagram 200 implements or is implemented by aspects of the wireless communications system 100. For example, the ciphering diagram 200 may be implemented by one or more UEs and/or NEs, which may be an example of NEs 102 and UEs 104, as described with reference to FIG. 1. The ciphering diagram 200 illustrates an example of a ciphering architecture for encrypting plaintext and decrypting ciphertext between a transmitter 202 and a receiver 204. The transmitter 202 may be an example of a transmitting entity, such as a UE or an NE, that performs ciphering operations on plaintext data before transmission. The receiver 204 may be an example of a receiving entity, such as a UE or an NE, that performs deciphering operations on received ciphertext to recover the original plaintext data.

The ciphering diagram 200 illustrates the use of ciphering algorithms to encrypt plaintext by applying a keystream using a bit-per-bit binary addition of the plaintext and the keystream. A keystream refers to a sequence of pseudorandom bits generated by a ciphering algorithm that is combined with plaintext to produce ciphertext, or combined with ciphertext to recover plaintext. The transmitter 202 includes a next-generation encryption algorithm (NEA) 206, which the transmitter 202 uses to transform plaintext into ciphertext. The receiver 204 includes a NEA 208 that the receiver 204 uses for deciphering operations, which may be a same NEA as the NEA 206 that the transmitter 202 uses for ciphering operations. The receiver 204 recovers the plaintext by generating the same keystream using the same input parameters and applying a bit-per-bit binary addition with the ciphertext.

In some cases, the transmitter 202 may provide one or more input parameters to the NEA 206, including a key 210 (e.g., a 128-bit cipher key), a count 212 (e.g., a 32-bit count value), a bearer 214 (e.g., a 5-bit bearer identity), a direction 216 (e.g., a 1-bit direction of the transmission), and a length 218 of the keystream. In some examples, the bit for the direction 216 may be zero for uplink and one for downlink. At the receiver 204, the NEA 208 receives corresponding input parameters, including a key 220, a count 222, a bearer 224, a direction 226, and a length 228. The input parameter, length 218 and/or length 228, may impact the length of a keystream block (e.g., a keystream block 230 and/or a keystream block 232), not the bits in the keystream block. A keystream block refers to a block of keystream bits generated by the ciphering algorithm based on the input parameters.

In some cases, the NEA 206 generates the keystream block 230 as output in response to the input parameters. The NEA 208 generates the keystream block 232 as output in response to the input parameters. The transmitter 202 uses the keystream block 230 to encrypt a plaintext block 234 to generate a ciphertext block 236. A plaintext block refers to a block of unencrypted data that is to be ciphered, and a ciphertext block refers to a block of encrypted data produced by combining the plaintext block with the keystream block. In some cases, the transmitter 202 combines the keystream block 230 with the plaintext block 234 through a bit-per-bit binary addition to produce the ciphertext block 236. The transmitter 202 sends the ciphertext block 236 to the receiver 204. The receiver 204 combines the keystream block 232 with the received ciphertext block 236 through a bit-per-bit binary addition to recover a plaintext block 238.

The transmitter 202 and the receiver 204 perform the ciphering and deciphering according to the ciphering diagram 200 to provide confidentiality protection for wireless communications. However, the transmitter 202 and the receiver 204 may apply ciphering and integrity protection operations separately, which may result in increased processing overhead and latency. Additionally, or alternatively, the input parameters that the transmitter 202 and the receiver 204 use for the ciphering algorithm (e.g., the count 212, the count 222, the bearer 214, the bearer 224, the direction 216, and/or the direction 226, among other examples) differ from the input parameters that authenticated encryption algorithms use (e.g., nonce values, associated data), which may lead to interoperability issues if a UE and an NE implement authenticated encryption-based security mechanisms. The techniques described herein enable a UE and an NE to use authenticated encryption algorithms with configurable modes that combine ciphering and integrity protection into a single operation, thereby reducing processing overhead and latency. Additionally, or alternatively, the techniques provide mechanisms for the UE and the NE to determine nonce values from existing parameters (e.g., count values, bearer identifiers, direction indicators) and/or to convey nonce values and associated data between the UE and the NE, which enables consistent input parameter usage and reduces the likelihood of deciphering and integrity verification failures.

FIG. 3 illustrates an example of an integrity protection diagram 300 in accordance with aspects of the present disclosure. In some examples, the integrity protection diagram 300 implements, or is implemented by, aspects of the wireless communications system 100 and/or the ciphering diagram 200. For example, the integrity protection diagram 300 may be implemented by one or more UEs and/or NEs, which may be an example of NEs 102 and UEs 104, as described with reference to FIG. 1. The integrity protection diagram 300 illustrates an example of an integrity protection architecture at a transmitter 302 for using a next-generation integrity algorithm (NIA) 304 to generate an authentication tag 306. An NIA 304 refers to an integrity algorithm used in wireless communications systems to provide integrity protection by generating an authentication tag 306 that enables detection of unauthorized modifications to a message during transmission.

The transmitter 302 may be an example of a transmitting entity, such as a UE or an NE, that performs integrity protection operations on a message before transmission. In some cases, the transmitter 302 may provide one or more input parameters to the NIA 304, including a key 308 (e.g., a 128-bit integrity key), a count 310 (e.g., a 32-bit count value), a message 312, a direction 314 (e.g., a 1-bit direction of the transmission), and a bearer 316 (e.g., a 5-bit bearer identity). In some examples, the bit for the direction 314 may be zero for uplink and one for downlink. The key 308 provides the integrity key used for generating the authentication tag 306. The count 310 represents a count value, such as a NAS count or PDCP count, that the transmitter 302 maintains for the communication protocol. The message 312 includes the data to be integrity protected. The direction 314 indicates the transmission direction. The bearer 316 identifies the bearer for the communication.

The transmitter 302 generates the authentication tag 306 (e.g., a 32-bit value) using the integrity algorithm, NIA 304, and the input parameters. The authentication tag 306 may be an example of a MAC for integrity (MAC-I), which is generated at the AS layer for RRC and user plane integrity protection. Additionally, or alternatively, the authentication tag 306 may be an example of a NAS-MAC, which is generated at the NAS layer for NAS signaling integrity protection. The MAC-I is used for AS layer communications between the UE and the RAN node, while the NAS-MAC is used for NAS layer communications between the UE and the AMF. The transmitter 302 appends the authentication tag 306 to the message when the transmitter 302 transmits the message. For integrity protection algorithms, the receiver computes the expected message authentication code (e.g., an XMAC-I and/or an XNAS-MAC) on the received message in the same way as the transmitter 302 computed the authentication tag 306 on the transmitted message. The receiver verifies the data integrity of the message by comparing the computed expected message authentication code to the received authentication tag 306. The integrity verification process at the receiver is described in further detail with respect to FIG. 4.

The transmitter 302 performs the integrity protection process to detect unauthorized modifications to messages during wireless communications. The transmitter 302 may apply integrity protection and ciphering operations separately, which may result in increased processing overhead and latency. Additionally, or alternatively, the input parameters that the transmitter 302 and the receiver use for the integrity algorithm (e.g., count 310, bearer 316, direction 314) differ from the input parameters used by authenticated encryption algorithms (e.g., nonce values, associated data), which may lead to interoperability issues when a UE and an NE implement authenticated encryption-based security mechanisms. The techniques described herein address the limitations by enabling a UE and an NE to use authenticated encryption algorithms with configurable modes that combine integrity protection and ciphering into a single operation, thereby reducing processing overhead and latency. Additionally, or alternatively, the techniques provide mechanisms for the UE and the NE to determine nonce values from existing parameters (e.g., count values, bearer identifiers, direction indicators) and/or to convey nonce values and associated data between the UE and the NE, which enables consistent input parameter usage and reduces the likelihood of integrity verification failures.

FIG. 4 illustrates an example of an integrity protection diagram 400 in accordance with aspects of the present disclosure. In some examples, the integrity protection diagram 400 implements or is implemented by aspects of the wireless communications system 100, the ciphering diagram, and/or the integrity protection diagram 300. For example, the integrity protection diagram 400 may be implemented by one or more UEs and/or NEs, which may be an example of NEs 102 and UEs 104, as described with reference to FIG. 1. The integrity protection diagram 400 illustrates an example of an integrity protection architecture at a receiver 402 for using an NIA 404 to generate an authentication tag 406.

The receiver 402 may be an example of a receiving entity, such as a UE or an NE, that performs integrity verification operations on a received message. In some cases, the receiver 402 may provide one or more input parameters to the NIA 404, including a key 408 (e.g., a 128-bit integrity key), a count 410 (e.g., a 32-bit count value), a message 412, a direction 414 (e.g., a 1-bit direction of the transmission), and a bearer 416 (e.g., a 5-bit bearer identity). In some examples, the bit for the direction 414 may be zero for uplink and one for downlink. The key 408 provides the integrity key used for generating the authentication tag 406. The count 410 represents a count value, such as a NAS count or PDCP count, that the receiver 402 maintains for the communication protocol. The message 412 includes the data to be integrity protected. The direction 414 indicates the transmission direction. The bearer 416 identifies the bearer for the communication.

The receiver 402 generates an expected authentication tag 406 (e.g., an expected MAC-I (XMAC-I) or an expected NAS-MAC (XNAS-MAC)) using the integrity algorithm, NIA 404, and the input parameters. The receiver 402 extracts the received authentication tag (e.g., MAC-I or NAS-MAC) that was appended to the message by the sender and compares the received authentication tag with the locally computed authentication tag 406. If the authentication tag 406 matches the received authentication tag, then the integrity verification is successful. If the integrity verification is successful, then the message 412 has not been modified during transmission, and the sender possessed the correct integrity key. If the authentication tag 406 does not match the received authentication tag, then the integrity verification fails, indicating potential message modification or a mismatch in security parameters between the sender and receiver. The receiver 402 performs the integrity verification process to detect unauthorized modifications to messages during wireless communications.

The receiver 402 may apply integrity verification and deciphering operations separately, which may result in increased processing overhead and latency. Additionally, or alternatively, the input parameters that the receiver 402 uses for the integrity algorithm (e.g., count 410, bearer 416, direction 414) differ from the input parameters used by authenticated encryption algorithms (e.g., nonce values, associated data), which may lead to interoperability issues if a UE and an NE implement authenticated encryption-based security mechanisms. The techniques described herein address the limitations by enabling a UE and an NE to use authenticated encryption algorithms with configurable modes that combine integrity verification and deciphering into a single operation, thereby reducing processing overhead and latency.

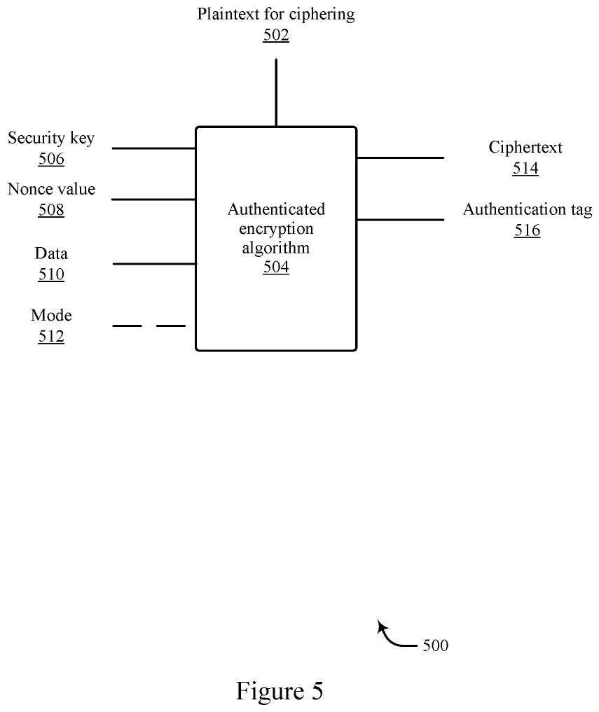

FIG. 5 illustrates an example of an authenticated encryption algorithm diagram 500 in accordance with aspects of the present disclosure. In some examples, the authenticated encryption algorithm diagram 500 implements, or is implemented by, aspects of the wireless communications system 100, the ciphering diagram, the integrity protection diagram 300, and/or the integrity protection diagram 400. For example, the authenticated encryption algorithm diagram 500 may be implemented by one or more UEs and/or NEs, which may be an example of UEs 104 and NEs 102, as described with reference to FIG. 1. The authenticated encryption algorithm diagram 500 illustrates an example of an authenticated encryption architecture for performing ciphering and integrity protection operations on plaintext for ciphering 502 using an authenticated encryption algorithm 504.

In some examples, a sender and/or a receiver may provide multiple input parameters to an authenticated encryption algorithm 504 and obtain outputs for both ciphering and integrity protection. The authenticated encryption algorithm 504 may be an example of an AEAD algorithm, such as a 256-bit SNOW 3G-based AEAD algorithm, a 256-bit AES-based AEAD algorithm, or a 256-bit ZUC-based AEAD algorithm. The authenticated encryption algorithm 504 may also be referred to as a next-generation combined algorithm (NCA) that combines ciphering and integrity protection into a single cryptographic operation. A transmitter (e.g., a UE or an NE) may provide input parameters to the authenticated encryption algorithm 504, including a security key 506, a nonce value 508, data 510 (e.g., associated data), a mode 512, and plaintext for ciphering 502. The authenticated encryption algorithm 504 generates a ciphertext 514 and an authentication tag 516 from the input parameters. The ciphertext 514 represents an encrypted form of the plaintext for ciphering 502, and the authentication tag 516 provides integrity verification for both the ciphertext 514 and/or the data 510. The transmitter transmits the ciphertext 514, the data 510, and the authentication tag 516 to a receiver, which uses the same authenticated encryption algorithm 504 and input parameters to verify the integrity of the received message and decrypt the ciphertext 514 to recover the plaintext.

In some examples, a UE and an NE may determine (e.g., generate, construct, identify, obtain) and use the same input parameters for authenticated encryption or AEAD-based combined ciphering and integrity protection for a message. The input parameters may include a nonce input and an associated data input. The nonce input provides uniqueness for each invocation of the authenticated encryption algorithm 504, while the associated data input indicates data that is to be authenticated but not encrypted. For the nonce input, the UE and the NE may construct a nonce value 508 that is available at both the UE and the NE using one or more parameters, such as a count value, a direction indicator, and a bearer identifier. The UE and the NE construct the nonce value 508 by concatenating the count value, the direction indicator, and the bearer identifier in a defined order and/or format that is determined during security establishment or indicated by a communication protocol. The count value may be a NAS count, a PDCP count, or any count associated with the protocol associated with the end-points of the communication, such as between a UE and a network, between networks, or between UEs (e.g., where a network may refer to either a radio network or a CN). For example, the NAS count is maintained between the UE and the AMF for NAS layer security operations, while the PDCP count is maintained between the UE and the RAN node for AS layer security operations. The direction indicator specifies whether the transmission is in the uplink direction (e.g., from UE to NE) or the downlink direction (e.g., from NE to UE). The UE and/or the NE may determine the direction indicator based on the source and destination of the message, where a value of zero indicates uplink transmission and a value of one indicates downlink transmission. The bearer identifier identifies the bearer, such as a DRB or SRB, for which the security protection is applied. The UE and/or the NE may obtain the bearer identifier from the bearer configuration established during connection setup or reconfiguration procedures.

Additionally, or alternatively, the UE or the NE may generate and transmit a nonce value 508 from one entity to the other entity, such as from the UE to the network or from the network to the UE, or from one UE to another UE, or from one network to another network, during a security mode command procedure for security establishment. The UE or the NE may construct the nonce value 508 using any counter or sequence number incremented from zero or one to a higher value, a random value, time information, or a security mode indicator, such as integrity protection and ciphering (e.g., selected integrity protection and ciphering or combined integrity protection and ciphering), ciphering (e.g., encryption), or integrity protection. When using a counter or sequence number, the generating entity initializes the counter to a starting value and increments the counter for each new nonce value generation, ensuring uniqueness across multiple invocations. When using a random value, the generating entity implements a cryptographically secure random number generator to produce a value with sufficient entropy to prevent nonce reuse. When using time information, the generating entity obtains a timestamp from a synchronized clock source and incorporates the timestamp into the nonce construction. The nonce value 508 may be a standalone input or may be part of the data 510 (e.g., associated data).

For the data 510 (e.g., associated data) input, the UE and/or the NE may configure the data 510 based on the type of protection to be applied. The data 510 represents information that is to be integrity protected but not ciphered, enabling a receiver to verify the authenticity of the data without decryption (e.g., deciphering). The configuration of the data 510 varies depending on the authenticated encryption mode 512 selected for the communication. The UE and/or the NE determines the authenticated encryption mode 512 based on the mode indicator received in the security mode command message or based on a preconfigured policy. For a selected or partial ciphering and integrity protection mode, the UE and/or the NE groups or formats non-sensitive information elements, data, or security establishment assistance information for integrity protection and that is expected to be sent in plaintext between a transmitter and a receiver as data 510. The UE and/or the NE uses the data 510 as input to the authenticated encryption algorithm 504 (e.g., an AEAD algorithm). The UE and/or the NE identifies non-sensitive information elements by classifying each information element according to defined sensitivity criteria, where information elements including subscriber identifiers, encryption keys, or location information are classified as sensitive, and information elements including protocol version numbers, message type indicators, or algorithm identifiers are classified as non-sensitive.

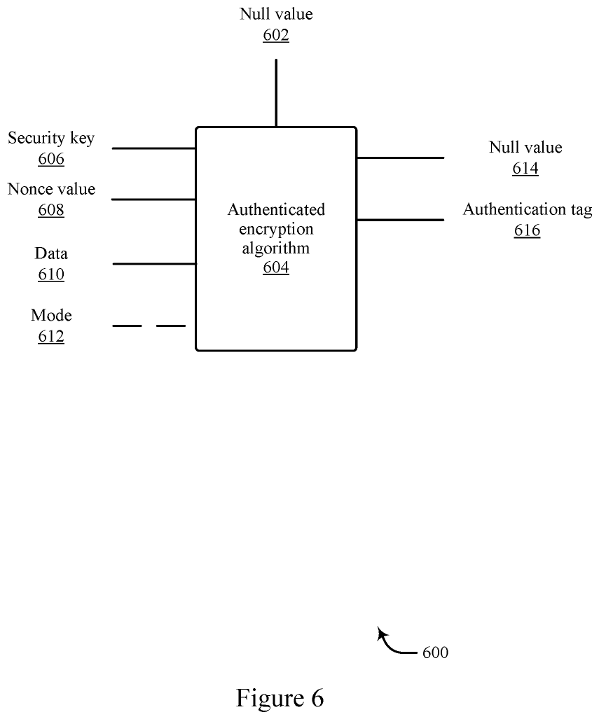

For an integrity protection mode (e.g., without ciphering), the UE and/or the NE may set the message or plaintext field, as well as the non-sensitive information elements, data, or security establishment assistance information, as the value of the data 510 and may set the message or plaintext field to a null value, which is described in further detail with respect to FIG. 6. The null value indicates that no ciphering operation is to be performed on the plaintext. The UE and/or the NE sets the plaintext field to a null value by providing an empty string or a zero-length input to the authenticated encryption algorithm 504. Additionally, or alternatively, the UE and/or the NE may use a mode 512 input that indicates the integrity protection mode is enabled, where the authenticated encryption algorithm 504 (e.g., an AEAD algorithm) ignores the plaintext or skips (e.g., refrains from, cancels) ciphering and directly performs authentication tag 516 generation from the data 510 value using other inputs. The mode 512 input is set by the UE and/or the NE based on the authenticated encryption mode indicated in the security mode command message or based on the security policy configured for the communication. The UE and/or the NE may use the configuration when the message content does not implement confidentiality protection, but does implement integrity verification to detect unauthorized modifications during transmission.

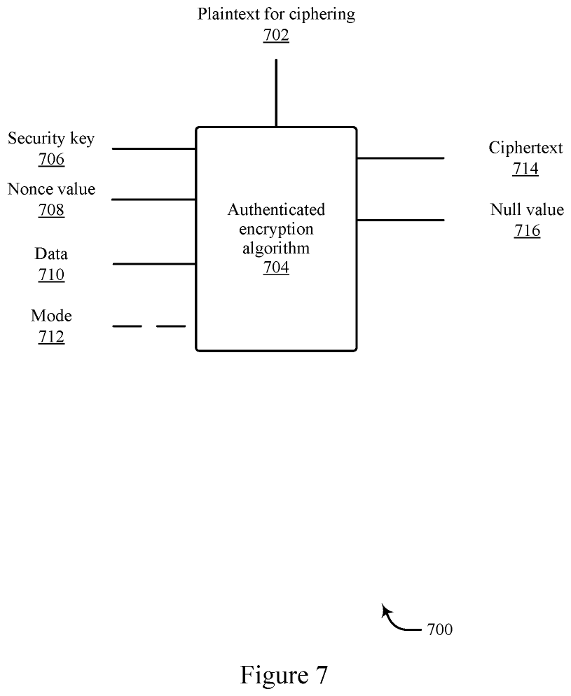

For a ciphering mode (e.g., without integrity protection), the UE and/or the NE may set the value of the data 510 to a null value and may use a mode 512 input that indicates ciphering protection is enabled, which is described in further detail with respect to FIG. 7. The UE and/or the NE sets the data 510 to a null value by providing an empty string or a zero-length input to the data 510 parameter of the authenticated encryption algorithm 504. The nonce value 508 is expected to be known at the communication end-points, either through derivation from shared parameters or through prior exchange during security establishment. The UE and/or the NE derive the nonce value 508 from shared parameters by applying a defined construction rule that combines the count value, direction indicator, bearer identifier, and algorithm identifier in a specified order and format. Additionally, or alternatively, the UE or the NE may set the security establishment assistance information as the value of the data 510 and may use a mode 512 input that indicates ciphering protection is enabled. The authenticated encryption algorithm 504 (e.g., an AEAD algorithm) does not acknowledge the data 510 (e.g., ignores the data 510) or skips integrity protection, meaning authentication tag 516 generation of the data 510, following the plaintext ciphering process. The algorithm determines whether to skip integrity protection based on the mode 512 input value, where a mode value indicating a ciphering mode causes the algorithm to bypass the authentication tag 516 generation step. The configuration provides confidentiality protection without integrity verification, which the UE and/or the NE may implement for scenarios where message authenticity is established through other mechanisms.

For a combined ciphering and integrity protection mode, the UE and/or the NE may set the value of the data 510 to a null value and may use a mode 512 input that indicates combined ciphering plus integrity protection or authenticated encryption protection is enabled. The nonce value 508 is expected to be known at the communication end-points. The UE and/or the NE ensure the nonce value 508 is known at both end-points by either deriving the nonce value 508 independently using shared parameters, such as the count value, direction indicator, and bearer identifier, or by transmitting the nonce value 508 from the transmitter to the receiver as part of the security mode command procedure. Additionally, or alternatively, the UE and/or the NE may set the security establishment assistance information as the value of the data 510 and may use a mode 512 input that indicates combined ciphering and integrity protection or authenticated encryption protection is enabled. Based on the mode 512, the authenticated encryption algorithm 504 (e.g., an AEAD algorithm) performs ciphering of the plaintext for ciphering 502 and then performs integrity protection of the ciphertext 514 and the data 510 by authentication tag 516 generation. The algorithm determines the order of operations based on the mode 512 input, where a mode value indicating encryption-then-MAC causes the authenticated encryption algorithm 504 to first encrypt the plaintext for ciphering 502 to produce ciphertext 514 and then generate the authentication tag 516 over the ciphertext 514 and data 510. The configuration provides both confidentiality and integrity protection in a single cryptographic operation, which reduces processing overhead compared to performing separate ciphering and integrity protection operations.

In some cases, for selected ciphering and integrity protection using authenticated encryption algorithms (e.g., AEAD algorithms), different portions of a message receive different levels of protection. The input parameters to the authenticated encryption algorithm 504, which may be a next-generation or 6G combined algorithm, enable selected ciphering and integrity protection, as shown in the authenticated encryption algorithm diagram 500. In some cases, selected ciphering may be referred to as partial ciphering, and may be used if a message includes both sensitive information elements and non-sensitive information elements. For partial ciphering and authentication tag 516 (e.g., a MAC-I tag) generation in the selected ciphering and integrity protection mode, a transmitter (e.g., an AMF, a RAN node, any network function, or a UE) derives a security key 506 (e.g., a secret key) as an authenticated encryption or AEAD security key from an anchor key or AMF key associated with the subscriber or UE in the case of NAS connection security. The anchor key serves as a root key from which other security keys are derived. The AMF key (e.g., K_{AMF}) is a key maintained at the AMF and the UE that is used to derive NAS security keys. The transmitter derives the security key 506 using a key derivation function with inputs including the security anchor key or AMF key, the authenticated encryption or AEAD or NCA algorithm identifier, the authenticated encryption or AEAD mode 512, and the nonce value 508. The key derivation function applies a cryptographic hash function or pseudorandom function to the input parameters to produce the derived key, where the hash function or pseudorandom function is determined by a key derivation algorithm indicated in a security protocol. The algorithm identifier distinguishes between different authenticated encryption algorithms, such as 256-bit SNOW 3G-based AEAD, 256-bit AES-based AEAD, or 256-bit ZUC-based AEAD. The algorithm identifier is represented as a numeric value that uniquely identifies the algorithm, where the mapping between numeric values and algorithms is defined (e.g., in a security specification).

For AS connection security for the selected ciphering and integrity protection mode, the transmitter derives the security key 506 as an authenticated encryption or AEAD security key from a radio anchor key or RAN key, such as a gNB key (e.g., K_{gNB}) or equivalent, associated with the subscriber or UE. The gNB key is a key maintained at the gNB and the UE that is used to derive AS security keys for RRC and user plane protection. The transmitter derives the security key 506 using a key derivation function with inputs including the security anchor key or radio key, the authenticated encryption or AEAD or NCA algorithm identifier, the authenticated encryption or AEAD mode 512, and the nonce value 508. The transmitter obtains the radio anchor key from the security context established during an initial context setup procedure, where the AMF provides the gNB key to the RAN node as part of the initial context setup request message.

For a user plane, a control plane, or a UE-network connection security for the selected ciphering and integrity protection mode, the transmitter derives the security key 506 as an authenticated encryption or AEAD security key from an anchor key associated with the subscriber or UE and available at the network connection end-point. The transmitter identifies the anchor key based on the type of connection and the security context established for that connection, where the anchor key selection is determined by the protocol layer and the communicating entities involved. The transmitter derives the security key 506 using a key derivation function with inputs including the security anchor key, the authenticated encryption or AEAD or NCA algorithm identifier, the authenticated encryption or AEAD mode 512, and the nonce value 508.

After deriving the security key 506, the transmitter formats a network message with two segments for the selected ciphering and integrity protection mode. A first segment refers to sensitive information elements, a message body, confidential information, or an actual message, which constitutes the plaintext for ciphering 502. Sensitive information elements may include subscriber identifiers, encryption keys, location information, or other data with privacy or security considerations. The transmitter identifies sensitive information elements by comparing each information element to defined sensitivity criteria indicated in a security policy or protocol specification (e.g., configured or preconfigured). A second segment refers to non-sensitive information elements, a message header, or security context information. Non-sensitive information elements may include protocol version numbers, message type indicators, or other data without privacy or security considerations that can be transmitted in plaintext. The transmitter formats the two segments by organizing the information elements into separate data structures, where the first segment is prepared for encryption and the second segment is prepared for inclusion in the data 510.

For partial ciphering for the selected ciphering and integrity protection mode, the transmitter uses the first segment as the plaintext for ciphering 502 or message value to enable ciphering, as well as integrity protection, and uses the second segment as the data 510 value to enable integrity protection (e.g., without ciphering). Thus, the transmitter may apply different levels of protection to different portions of the message based on the sensitivity of the information. The transmitter determines which information elements belong to each segment by using a classification table or applying classification rules that map information element types to sensitivity levels. The transmitter provides the plaintext for ciphering 502 or message and the data 510 value as input to the NCA, authenticated encryption algorithm 504, or AEAD algorithms, as well as one or more input parameters (e.g., the security key 506, the nonce value 508, the data 510, and/or the mode 512).

For the nonce input in the selected ciphering and integrity protection mode, the transmitter may use a nonce value 508 that is available at the transmitter and receiver (e.g., a UE and an NE). The transmitter constructs the nonce value 508 at the UE and network side using available parameters, such as a count value, a direction bit, a bearer identifier, and an AEAD, authenticated encryption, or NCA algorithm identifier. The count value may be a NAS count, a PDCP count, or any count associated with the protocol associated with the end-points of the communication, as applicable. For example, the nonce value 508 may be constructed by concatenating the count value, the direction bit, the bearer identifier, and the algorithm identifier in a defined order and format. The defined order and format are indicated in a security protocol, where the count value occupies the most significant bits, followed by the direction bit, the bearer identifier, and the algorithm identifier, where padding may be applied to achieve a nonce length.

Additionally, or alternatively, for the nonce input in the selected ciphering and integrity protection mode, the transmitter may use a nonce value 508 that is generated and sent from one entity to the other entity, such as from the UE to the network or from the network to the UE, in the security mode command procedure for security establishment. The transmitter constructs the nonce value 508 using any counter or sequence number incremented from zero or one to a higher value, a random value, time information, or a security mode indicator. The transmitter constructing the nonce value 508 provides flexibility in nonce generation and may be used when the parameters for constructing the nonce value 508 are not available at both end-points prior to security establishment.

For the mode 512 input in the selected ciphering and integrity protection mode, the transmitter indicates partial ciphering with integrity protection or indicates a partial ciphering indication, integrity and encryption, or encryption and integrity, respectively. The mode 512 input informs the authenticated encryption algorithm 504 of the type of protection to be applied. The transmitter sets the mode 512 input by encoding the protection type as a numeric value or bit field according to the mode encoding scheme defined in a security specification. Additionally, or alternatively, the data 510 input parameter may include information, such as the mode 512, the count value, the bearer identifier, the direction bit, and the plaintext security context information. Additionally, or alternatively, the data 510 input parameter may include the plaintext security context information, which includes the mode 512, the count value, the bearer identifier, and/or the direction bit. The security context information refers to information that assists in identifying or establishing the security context between the communicating entities. The transmitter constructs the security context information by concatenating the relevant parameters in a defined format that enables the receiver to parse and extract each parameter.

The above input parameters to the authenticated encryption algorithm 504 (e.g., an AEAD algorithm) in the selected ciphering and integrity protection mode result in the following operations. For encryption or ciphertext 514 generation, the transmitter computes the authenticated encryption or AEAD function with inputs including the security key 506, the nonce value 508, the data 510, the mode 512, and the message or plaintext for ciphering 502. The ciphertext 514 represents the encrypted form of the plaintext for ciphering 502, providing confidentiality protection for the sensitive information elements. The transmitter computes the ciphertext 514 by invoking the encryption component of the authenticated encryption algorithm 504, which applies a block cipher or stream cipher to the plaintext for ciphering 502 using the security key 506 and nonce value 508 as inputs. For authentication or authentication tag 516 (e.g., a MAC-tag) generation, the transmitter computes the authentication function with inputs including the security key 506, the nonce value 508, the data 510, the mode 512, and the ciphertext 514. The authentication tag 516 (e.g., a MAC-I tag) provides integrity verification for both the ciphertext 514 and the data 510. The transmitter computes the authentication tag 516 by invoking the authentication component of the authenticated encryption algorithm 504, which applies a message authentication code function to the ciphertext 514 and data 510 using the security key 506 and nonce value 508 as inputs. A size of the authentication tag 516 may be any of 4, 8, 16, 32, or an integer N number of bytes, depending on the security criteria and the authenticated encryption algorithm 504 used. In some cases, the size of the authentication tag 516 is determined by the algorithm specification or by a configuration parameter negotiated during security establishment. Additionally, or alternatively, in a single pass operation, the transmitter represents the ciphering and integrity protection as the authenticated encryption or AEAD function with inputs, including the security key 506, the nonce value 508, the data 510, the mode 512, the encryption of the plaintext for ciphering 502 or message, and the authentication of the ciphertext 514 plus the data 510, which optionally includes the mode 512 and the nonce value 508, as well.

The output of the selected ciphering and integrity protection mode includes partial plaintext, such as the nonce value 508, the data 510 including the security context information, and the mode 512, as applicable, concatenated with the ciphertext 514 and the authentication tag 516. The partial plaintext portion is transmitted without encryption, but with integrity protection, while the ciphertext 514 portion is transmitted with both encryption and integrity protection. The transmitter formats the output by concatenating the components in a defined order, where the partial plaintext precedes the ciphertext 514 and the authentication tag 516 is appended at the end, enabling the receiver to parse the received message and extract each component. If the transmitter generates the nonce value 508 that is common to the transmitter and receiver, then the nonce value 508 may not be included in the output (e.g., because the receiver can independently construct the same nonce value 508 using the shared parameters). If the transmitter generates the nonce value 508 that is not common to the transmitter and receiver, then the transmitter includes the nonce value 508 in the output to enable the receiver to use the same nonce value 508 for integrity verification and decryption.

Additionally, or alternatively, in the selected ciphering and integrity protection mode, the transmitter may construct the nonce value 508 or initialization vector input from the NAS count, the bearer identifier, and the direction bit. The transmitter constructs the nonce value 508 by concatenating the NAS count, the bearer identifier, and the direction bit according to a defined bit layout, where the NAS count occupies the most significant bits, followed by the bearer identifier and the direction bit, with the total length matching the nonce size utilized by the authenticated encryption algorithm 504. The transmitter sets the data 510 to the plaintext security context information. The output, meaning the information sent from the transmitter to the receiver, includes the ciphertext 514 concatenated with the data 510 or integrity protected plaintext concatenated with the authentication tag 516. This format enables the receiver to identify the data 510, verify the integrity of the entire message, and decrypt the ciphertext 514 to recover the sensitive information elements.

For expected authentication tag 516 (e.g., a MAC-I tag) generation and verification and partial deciphering in the selected ciphering and integrity protection mode, a receiver (e.g., a UE, an AMF, a RAN node, or any network function) derives the security key 506 or an authenticated encryption or AEAD security key using an anchor key or any UE security context or network context available at its side, as well as other input parameters, such as those performed by the transmitter. The receiver obtains the anchor key from the security context stored locally, where the security context is established during a prior authentication or security establishment procedure. The receiver may also use the security context information in the authenticated encryption or AEAD security key generation, as applicable. The receiver extracts the security context information from the received message by parsing the data 510 portion according to the defined format. The receiver uses the AEAD security key in the authentication tag 516 or authentication tag generation and decryption process. The receiver may use the same input parameters and key derivation process as the transmitter to ensure successful integrity verification and decryption.

In some cases, for the selected ciphering and integrity protection mode at the receiver, the receiver generates an authentication tag 516 (e.g., a MAC tag) for integrity verification. The receiver computes the authentication function with inputs, including the security key 506, the nonce value 508, the data 510, the mode 512, and the ciphertext 514, and checks if the computed value matches the received authentication tag 516. The receiver obtains the nonce value 508 either by constructing the nonce value 508 from shared parameters (e.g., using the same construction method as the transmitter) or by extracting the nonce value 508 from the received message if the nonce value 508 was included in the transmission. The receiver extracts the data 510, the ciphertext 514, and the received authentication tag 516 from the received message by parsing the message according to the defined format, where the boundaries between components are determined by fixed lengths or length indicators included in the message. If both values match, then the integrity verification succeeds, indicating that the message has not been modified during transmission and that the transmitter possessed the correct security key 506. Otherwise, the receiver considers the verification a failure, which may indicate message tampering or a mismatch in security parameters between the transmitter and receiver.

After verifying that the values match for the authentication tag 516, the receiver performs decryption (e.g., deciphering). The receiver decrypts the ciphertext 514 using the authenticated encryption algorithm 504 (e.g., an AEAD algorithm) and input parameters, meaning the decryption function with inputs including the security key 506, the nonce value 508, the data 510, the mode 512, and the ciphertext 514, which results in the plaintext or message. The receiver invokes the decryption component of the authenticated encryption algorithm 504, which applies the inverse of the encryption operation to the ciphertext 514 using the security key 506 and nonce value 508 as inputs. The decrypted plaintext includes the sensitive information elements that were encrypted by the transmitter. Additionally, or alternatively, in a single pass operation, the receiver represents the integrity protection and deciphering as the authenticated encryption or AEAD function with inputs, including the security key 506, the nonce value 508, the data 510, the mode 512, the authentication of the ciphertext 514 plus the data 510, which optionally includes the mode 512 and the nonce value 508, and the decryption of the ciphertext 514.

The protection mechanisms described herein are applicable for any connection between a UE and a NE, including NAS connections between the UE and the AMF, AS connections between the UE and the RAN node, and user plane connections for data transmission. The order of input parameters and keys used for integrity protection, meaning authentication tag 516 generation, and encryption at the transmitter side and the respective integrity verification and decryption at the receiver side may follow a same order and format. The order and format are indicated in a security protocol and may include a sequence in which parameters are concatenated, the bit lengths of each parameter, and any padding or encoding rules applied to the parameters.

In some examples, a transmitter and a receiver (e.g., a UE and/or an NE) may implement combined ciphering and integrity protection using authenticated encryption algorithms (e.g., AEAD algorithms), where an entire message receives both ciphering and integrity protection without selective treatment of different message portions. The input parameters to an authenticated encryption algorithm 504 may enable the ciphering and the integrity protection. The transmitter and the receiver may implement the combined ciphering and integrity protection if each information element in a message implements both confidentiality and integrity protection, or if an overhead of selective protection exceeds a threshold value.

For ciphering and authentication tag 516 (e.g., a MAC-I tag) generation in the combined ciphering and integrity protection mode, a transmitter derives a security key 506 as an authenticated encryption or AEAD security key from an anchor key or AMF key, radio key, or any network key associated with the subscriber or UE. The transmitter derives the security key 506 using a key derivation function with inputs including the security anchor key, AMF key, or any UE-network level key, as described for the selected ciphering and integrity protection mode, the authenticated encryption or AEAD or NCA algorithm identifier, the authenticated encryption or AEAD mode 512, and the nonce value 508. The key derivation process is similar to that described for the selected ciphering and integrity protection mode, but the mode 512 input indicates combined protection, rather than partial protection. The transmitter sets the mode 512 input to a value that indicates combined ciphering and integrity protection, where the value is defined in the mode encoding scheme of the security specification.

For the combined ciphering and integrity protection mode, the transmitter uses the plaintext for ciphering 502 or message value to enable ciphering, as well as integrity protection. The transmitter sets the data 510 value to a null value to skip integrity protection without ciphering of any data. The transmitter sets the data 510 to a null value by providing an empty string or a zero-length input to the data 510 parameter of the authenticated encryption algorithm 504. Unlike the selected ciphering and integrity protection mode, where the data 510 includes non-sensitive information elements, the combined mode treats the entire message as implementing both ciphering and integrity protection. The transmitter provides the plaintext for ciphering 502 or message and the data 510 value as input to the NCA, authenticated encryption algorithm 504, or AEAD algorithms, as well as one or more input parameters.

For the nonce input in the combined ciphering and integrity protection mode, the transmitter may use a nonce value 508 that is available at the UE and the NE, as described for the selected ciphering and integrity protection mode. Additionally, or alternatively, for the combined ciphering and integrity protection mode, the transmitter may use a nonce value 508 that is generated and sent from one entity to the other entity, as described for the selected ciphering and integrity protection mode. For the mode 512 input in the combined ciphering and integrity protection mode, the transmitter indicates ciphering with integrity protection or indicates integrity and encryption or encryption and integrity, respectively. The mode parameter for the combined ciphering and integrity protection mode differs from the mode parameter for the partial ciphering and integrity protection mode in that the mode 512 indicates that the entire plaintext for ciphering 502 is to be ciphered and integrity protected, rather than selectively protecting different portions. The transmitter encodes the mode 512 input as a numeric value or bit field according to the mode encoding scheme, where the value for combined ciphering and integrity protection is distinct from the values for partial ciphering, integrity, or ciphering modes. Additionally, or alternatively, the data 510 input parameter may include the mode 512, the count value, the bearer identifier, the direction bit, and the plaintext security context information. However, in the combined mode, the data 510 may be set to a null value because the data implementing protection is included in the plaintext for ciphering 502.

The above input parameters to the authenticated encryption algorithm 504 (e.g., an AEAD algorithm) in the combined ciphering and integrity protection mode result in the following operations. For encryption or ciphertext 514 generation, the transmitter computes the authenticated encryption or AEAD function with inputs including the security key 506, the nonce value 508, the mode 512, the data 510, and the message or plaintext for ciphering 502. The entire plaintext for ciphering 502 is encrypted to produce the ciphertext 514. The transmitter invokes the encryption component of the authenticated encryption algorithm 504, which processes the entire plaintext for ciphering 502 as a single input and produces the ciphertext 514 as output. For authentication or authentication tag 516 (e.g., a MAC-tag) generation, the transmitter computes the authentication function with inputs including the security key 506, the nonce value 508, the data 510, the mode 512, and the ciphertext 514. The authentication tag 516 provides integrity verification for the ciphertext 514. The transmitter invokes the authentication component of the authenticated encryption algorithm 504, which computes the authentication tag 516 over the ciphertext 514 using the security key 506 and nonce value 508, where the data 510 is set to a null value and does not contribute to the authentication tag 516 computation. The size of the authentication tag 516 may be any of 4, 8, 16, 32, or N number of bytes.

The output of the combined ciphering and integrity protection mode includes the nonce value 508, if applicable, the mode 512, if applicable, concatenated with the ciphertext 514 and the authentication tag 516. Unlike the selected ciphering and integrity protection mode, the output may not include a separate data 510 portion, because the data 510 is set to a null value. The transmitter formats the output by concatenating the nonce value 508, if applicable, the mode 512, if applicable, the ciphertext 514, and the authentication tag 516 in a defined order, where the boundaries between components are determined by fixed lengths or length indicators to enable the receiver to parse the received message. If the transmitter generates the nonce value 508 that is common to the transmitter and receiver, then the nonce value 508 may not be included in the output. If the transmitter generates the nonce value 508 that is not common to the transmitter and receiver, then the transmitter includes the nonce value 508 in the output to enable the receiver to use the same nonce value 508 for integrity verification and decryption.

Additionally, or alternatively, for the combined ciphering and integrity protection mode, the transmitter may construct the nonce value 508 or initialization vector input from the NAS count, the bearer identifier, and the direction bit. The transmitter constructs the nonce value 508 by concatenating the NAS count, the bearer identifier, and the direction bit according to the defined bit layout indicated in a security protocol. The transmitter sets the data 510 to zero or a null value. The output (e.g., the information sent from the transmitter to the receiver) includes the nonce value 508, if applicable, the mode 512, if applicable, concatenated with the ciphertext 514 and the authentication tag 516. This format is simpler than the selected ciphering and integrity protection mode because there is no separate data 510 to transmit.

For expected authentication tag 516 (e.g., a MAC-I tag) generation and verification and deciphering in the combined ciphering and integrity protection mode, a receiver (e.g., a UE, an AMF, a RAN node, or any network function) derives the security key 506 or an authenticated encryption or AEAD security key using an anchor key or any UE security context or network context available at the receiver, as well as other input parameters similar to the transmitter side process. The receiver obtains the anchor key from the locally stored security context and applies the same key derivation function with the same input parameters as the transmitter. The receiver may also use the security context information in the authenticated encryption or AEAD security key generation, as applicable. The receiver uses the AEAD security key in the authentication tag 516 or authentication tag generation and decryption process.

In some cases, for the combined ciphering and integrity protection mode at the receiver, the receiver generates an authentication tag 516 (e.g., a MAC tag) for integrity verification. The receiver computes the authentication function with inputs including the security key 506, the nonce value 508, the mode 512, the data 510 set to a null value, and the ciphertext 514 and checks if the computed value matches the received authentication tag 516. The receiver obtains the nonce value 508 either by constructing the nonce value 508 from shared parameters or by extracting the nonce value 508 from the received message, and extracts the ciphertext 514 and received authentication tag 516 by parsing the received message according to the defined format. If both values match, then the integrity verification succeeds. Otherwise, the receiver considers the verification a failure. The use of a null value for the data 510 distinguishes this mode from the selected ciphering and integrity protection mode.

After verifying that the values of the authentication tag 516 match, the receiver performs decryption (e.g., deciphering). The receiver decrypts the ciphertext 514 using the authenticated encryption algorithm 504 (e.g., an AEAD algorithm) and input parameters, meaning the decryption function with inputs including the security key 506, the nonce value 508, the mode 512, the data 510 set to a null value, and the ciphertext 514, which results in the plaintext or message. The receiver invokes the decryption component of the authenticated encryption algorithm 504, which applies the inverse of the encryption operation to the ciphertext 514 to recover the original plaintext. The decrypted plaintext includes the entire message content. Additionally, or alternatively, in a single pass operation, the receiver represents the integrity protection and decryption as the authenticated encryption or AEAD function with inputs including the security key 506, the nonce value 508, the mode 512, the data 510 set to a null value, the authentication of the ciphertext 514, and the decryption of the ciphertext 514.

The order of input parameters and keys used for integrity protection, meaning authentication tag 516 generation, and encryption at the transmitter side and the respective integrity verification and decryption at the receiver side may follow the same order and format. This criterion applies to both the selected ciphering and integrity protection mode and the combined ciphering and integrity protection mode. The order and format are established during security establishment and are indicated in a security protocol, ensuring that both the transmitter and receiver use consistent parameter ordering for cryptographic operations. In the selected ciphering and integrity protection mode, the data 510 includes non-sensitive information elements that receive integrity protection without ciphering, while in the combined ciphering and integrity protection mode, the data 510 is set to a null value and the entire message is ciphered and integrity protected.

FIG. 6 illustrates an example of an authenticated encryption algorithm diagram 600 in accordance with aspects of the present disclosure. In some examples, the authenticated encryption algorithm diagram 600 implements, or is implemented by, aspects of the wireless communications system 100, the ciphering diagram, the integrity protection diagram 300, the integrity protection diagram 400, and/or the authenticated encryption algorithm diagram 500. For example, the authenticated encryption algorithm diagram 600 may be implemented by one or more UEs and/or NEs, which may be an example of UEs 104 and NEs 102, as described with reference to FIG. 1. The authenticated encryption algorithm diagram 600 illustrates an example of an integrity protection architecture using a plaintext input set to a null value 602 for an authenticated encryption algorithm 604.

In some examples, a sender and/or a receiver may provide multiple input parameters to an authenticated encryption algorithm 604 and obtain outputs for integrity protection without ciphering. The authenticated encryption algorithm 604 may be an example of an AEAD algorithm, such as a 256-bit SNOW 3G-based AEAD algorithm, a 256-bit AES-based AEAD algorithm, or a 256-bit ZUC-based AEAD algorithm. The authenticated encryption algorithm 604 may also be referred to as an NCA configured to perform integrity protection without encryption. A transmitter (e.g., a UE or an NE) may provide input parameters to the authenticated encryption algorithm 604, including a security key 606, a nonce value 608, data 610 (e.g., associated data including the message to be integrity protected), a mode 612, and a null value 602 as the plaintext input to skip ciphering. The authenticated encryption algorithm 604 generates a null value 614 as the ciphertext output and an authentication tag 616 from the input parameters. The null value 614 indicates that no ciphering operation was performed on the input, and the authentication tag 616 provides integrity verification for the data 610. In some cases, the transmitter transmits the data 610 and the authentication tag 616 to a receiver, which uses the same authenticated encryption algorithm 604 and input parameters to verify the integrity of the received message without performing decryption (e.g., deciphering).

In some examples, a transmitter and a receiver (e.g., a UE and/or an NE) may implement integrity protection using authenticated encryption algorithms (e.g., AEAD algorithms). The input parameters to an authenticated encryption algorithm 604 may enable integrity protection without ciphering. For integrity protection, the transmitter sets the plaintext or message input to a null value 602 to skip ciphering and sets the data 610 (e.g., associated data) input value to the plaintext or message to enable integrity protection for the message, which together includes the security context information.

For authentication tag 616 (e.g., a MAC-I tag) generation in the integrity protection mode, a transmitter (e.g., an AMF, a RAN node, any network function, or a UE) derives a security key 606 (e.g., a secret key) as an authenticated encryption or AEAD security key from an anchor key or AMF key, radio key, or any network key associated with the subscriber or UE. The transmitter derives the security key 606 using a key derivation function with inputs including the security anchor key or AMF key or any UE-network level key, the authenticated encryption or AEAD or NCA algorithm identifier, the authenticated encryption or authenticated encryption mode 612, and the nonce value 608. Additionally, or alternatively, an integrity key (e.g., KNASint, KRRCint, or KUPint, as applicable to the UE-network communication) may be used as the security key.

The transmitter provides the plaintext or message as a null value 602 and the data 610 value as input to the NCA, authenticated encryption algorithm 604, or AEAD algorithms, as well as one or more input parameters. For the nonce input in the integrity protection mode, the transmitter may use a nonce value 608 that is available at the UE and the NE. The transmitter constructs the nonce value 608 at the UE and network side using available parameters, such as a count value, a direction bit, a bearer identifier, and an AEAD, authenticated encryption, or NCA algorithm identifier. The count value may be a NAS count, a PDCP count, or any count associated with the protocol associated with the end-points of the communication, as applicable. Additionally, or alternatively, for the nonce input in the integrity protection mode, the transmitter may use a nonce value 608 that is generated and sent from one entity to the other entity, such as from the UE to the network or from the network to the UE, in the security mode command procedure for security establishment. The transmitter constructs the nonce value 608 using any counter or sequence number incremented from zero or one to a higher value, a random value, time information, or a security mode indicator (e.g., integrity-only or integrity).

For the mode 612 input in the integrity protection mode, the transmitter indicates integrity protection or indicates integrity, respectively. Additionally, or alternatively, the data 610 input parameter may include information, such as the mode 612, the count value, the bearer identifier, the direction bit, security context information, and the plaintext or message. Additionally, or alternatively, the data 610 input parameter may include the security context information and plaintext, as the rest of the input parameters may be part of the nonce input (e.g., the mode 612, the count value, the bearer identifier, and the direction bit).

The input parameters to the authenticated encryption algorithm 604 (e.g., an AEAD algorithm) in the integrity protection mode result in the following operations. For encryption or ciphertext generation, no ciphertext is generated or a null value 614 is output. Additionally, or alternatively, based on the mode 612, encryption is skipped. In some cases, applying encryption to a null text may be interpreted as an empty string or a zero-length input, which results in a non-null, fixed-length block of binary data. For example, if the system converts null to an empty string before encrypting, the output is not empty and will be a valid, encoded ciphertext block (e.g., 16 bytes for AES) including initialization vectors and padding.

For authentication or authentication tag 616 (e.g., a MAC-tag) generation in the integrity protection mode, the transmitter may compute the authentication tag 616. In some cases, the transmitter computes the authentication tag 616 as the authentication function with inputs including the security key 606, the nonce value 608, ciphertext equal to null, and the data 610. Additionally, or alternatively, the transmitter computes the authentication tag 616 as the authentication function with inputs including the security key 606, the nonce value 608, and the data 610. Additionally, or alternatively, the transmitter computes the authentication tag 616 as the authentication function with inputs including the security key 606, the nonce value 608, plaintext or padded ciphertext that refers to null ciphering, and the data 610, where the plaintext or padded ciphertext refers to null ciphering. The size of the authentication tag 616 may be any of 4, 8, 16, 32, or N number of bytes.

The output of the integrity protection mode may include the nonce value 608 concatenated with the plaintext concatenated with the authentication tag 616. Additionally, or alternatively, the output may include the data 610 value (e.g., which includes the nonce value 608 concatenated with the plaintext) concatenated with the authentication tag 616. If the transmitter generates the nonce value 608 that is common to the transmitter and receiver, then the nonce value 608 may not be included in the output. If the transmitter generates the nonce value 608 that is not common to the transmitter and receiver, then the transmitter includes the nonce value 608 in the output. Additionally, or alternatively, the nonce value 608 or initialization vector may be constructed from the NAS count, the bearer identifier, and the direction bit, in which case the data 610 may include the plaintext, and the output sent from the transmitter to the receiver includes the nonce value 608 concatenated with the plaintext concatenated with the authentication tag 616. Additionally, or alternatively, if the transmitter computes the authentication tag 616 as the authentication function with the inputs including the security key 606, the nonce value 608, plaintext (e.g., the final option for authentication tag 616 generation), and the data is used, then the output sent from the transmitter to the receiver includes ciphertext indicating a null cipher concatenated with the data 610 (e.g., which includes the nonce value 608) concatenated with the authentication tag 616.

For expected authentication tag 616 (e.g., a MAC-I tag) generation and verification in the integrity protection mode, a receiver (e.g., a UE, an AMF, a RAN node, or any network function) derives the security key 606 or an authenticated encryption or AEAD security key using an anchor key or any UE security context or network context available at the receiver, as well as other input parameters similar to the transmitter side process. The receiver may also use the security context information in the authenticated encryption or AEAD security key generation, as applicable. The receiver uses the AEAD security key in the authentication tag 616 or authentication tag generation and verification process. Additionally, or alternatively, decryption of null ciphered data may be performed.

In some cases, for the integrity protection mode at the receiver, the receiver generates an authentication tag 616 (e.g., a MAC tag) for integrity verification. The receiver computes the authentication function with inputs including the security key 606, the nonce value 608, the data 610, and null or null ciphertext, and checks if the computed value matches the received authentication tag 616. If both values match, then the integrity verification succeeds. Otherwise, the receiver considers the verification a failure. The receiver then skips decryption based on the indicated mode 612 or performs decryption of null ciphered text. The receiver decrypts the ciphertext using the authenticated encryption algorithm 604 (e.g., an AEAD algorithm) and input parameters, meaning the decryption function with inputs including the security key 606, the nonce value 608, the data 610, and null or null ciphertext, which results in the plaintext or message. Additionally, or alternatively, in a single pass operation, the receiver represents the integrity protection and decryption as the authenticated encryption or AEAD function with inputs including the security key 606, the nonce value 608, the data 610, the authentication of the null ciphertext plus the data 610, and the decryption of null or null ciphertext. The order of input parameters and keys used for integrity protection, meaning authentication tag 616 generation, and encryption at the transmitter side and the respective integrity verification and decryption at the receiver side may follow the same order and format.

FIG. 7 illustrates an example of an authenticated encryption algorithm diagram 700 in accordance with aspects of the present disclosure. In some examples, the authenticated encryption algorithm diagram 700 implements, or is implemented by, aspects of the wireless communications system 100, the ciphering diagram, the integrity protection diagram 300, the integrity protection diagram 400, the authenticated encryption algorithm diagram 500, and/or the authenticated encryption algorithm diagram 600. For example, the authenticated encryption algorithm diagram 700 may be implemented by one or more UEs and/or NEs, which may be an example of UEs 104 and NEs 102, as described with reference to FIG. 1. The authenticated encryption algorithm diagram 700 illustrates an example of a ciphering architecture using plaintext for ciphering 702 as input to an authenticated encryption algorithm 704.

In some examples, a sender and/or a receiver may provide multiple input parameters to an authenticated encryption algorithm 704 and obtain outputs for ciphering without integrity protection. The authenticated encryption algorithm 704 may be an example of an AEAD algorithm, such as a 256-bit SNOW 3G-based AEAD algorithm, a 256-bit AES-based AEAD algorithm, or a 256-bit ZUC-based AEAD algorithm. The authenticated encryption algorithm 704 may also be referred to as an NCA configured to perform ciphering without integrity protection. A transmitter (e.g., a UE or an NE) may provide input parameters to the authenticated encryption algorithm 704, including a security key 706, a nonce value 708, data 710 (e.g., associated data set to a null value to skip integrity protection), a mode 712, and plaintext for ciphering 702 as the message input to be encrypted. The authenticated encryption algorithm 704 generates ciphertext 714 and a null value 716 from the input parameters. The ciphertext 714 represents the encrypted form of the plaintext for ciphering 702, and the null value 716 indicates that no authentication tag was generated based on the ciphering mode. The transmitter transmits the ciphertext 714 to a receiver, which uses the same authenticated encryption algorithm 704 and input parameters to decrypt the ciphertext 714 and recover the plaintext without performing integrity verification.

In some examples, a transmitter and a receiver (e.g., a UE and/or an NE) may implement ciphering protection using authenticated encryption algorithms (e.g., AEAD algorithms). The input parameters to an authenticated encryption algorithm 704 may enable ciphering protection without integrity protection, as shown in the authenticated encryption algorithm diagram 700. For ciphering protection, the transmitter sets the data 710 (e.g., associated data) input value to a null value to skip integrity protection and sets the plaintext for ciphering 702 input value to the message to enable ciphering protection for the message.

For ciphertext 714 generation in the ciphering protection mode, a transmitter (e.g., an AMF, a RAN node, any network function, or a UE) derives a security key 706 (e.g., a secret key) as an authenticated encryption or AEAD security key from an anchor key or AMF key, radio key, or any network key associated with the subscriber or UE. The transmitter derives the security key 706 using a key derivation function with inputs including the security anchor key or AMF key or any UE-network level key, the authenticated encryption or AEAD or NCA algorithm identifier, the authenticated encryption or authenticated encryption mode 712, and the nonce value 708. Additionally, or alternatively, an encryption or cipher key from existing systems (e.g., KNASenc, KRRCenc, or KUPenc, as applicable to the UE-network communication) may be used as the secret key.

The transmitter provides the plaintext for ciphering 702 or message as input and sets the data 710 input value to null. The transmitter provides the plaintext for ciphering 702 and the data 710 value as input to the NCA, authenticated encryption algorithm 704, or AEAD algorithms, as well as one or more input parameters. For the nonce input in the ciphering protection mode, the transmitter may use a nonce value 708 that is available at the UE and the NE. The transmitter constructs the nonce value 708 at the UE and network side using available parameters, such as a count value, a direction bit, a bearer identifier, and an AEAD, authenticated encryption, or NCA algorithm identifier. The count value may be a NAS count, a PDCP count, or any count associated with the protocol associated with the end-points of the communication, as applicable. Additionally, or alternatively, for the nonce input in the ciphering protection mode, the transmitter may use a nonce value 708 that is generated and sent from one entity to the other entity, such as from the UE to the network or from the network to the UE, in the security mode command procedure for security establishment. The transmitter constructs the nonce value 708 using any counter or sequence number incremented from zero or one to a higher value, a random value, time information, or a security mode indicator (e.g., ciphering-only or encryption).

For the mode 712 input in the ciphering protection mode, the transmitter indicates ciphering or confidentiality protection or indicates encryption or encryption, respectively. Additionally, or alternatively, the data 710 input parameter may include information, such as the mode 712, the count value, the bearer identifier, the direction bit, and plaintext security context information, or the data 710 input parameter may be set to null.

The above input parameters to the authenticated encryption algorithm 704 (e.g., an AEAD algorithm) in the ciphering protection mode result in the following operations. For encryption or ciphertext 714 generation, the transmitter computes the authenticated encryption or AEAD function with inputs including the security key 706, the nonce value 708, the data 710 set to null, the mode 712, and the message or plaintext for ciphering 702. For authentication or authentication tag generation, the transmitter computes the authentication tag as a null value 716 based on the ciphering mode. The size of the authentication tag may be any of 4, 8, 16, 32, or N number of bytes.

The output of the ciphering protection mode may include partial plaintext (such as the nonce value 708 and security context information, if applicable) concatenated with the ciphertext 714. If the transmitter generates the nonce value 708 that is common to the transmitter and receiver, then the nonce value 708 may not be included in the output. If the transmitter generates the nonce value 708 that is not common to the transmitter and receiver, then the transmitter includes the nonce value 708 in the output. Security context information may or may not be included in the output, as applicable. Additionally, or alternatively, the nonce value 708 or initialization vector may be constructed from the NAS count, the bearer identifier, and the direction bit, in which case the data 710 may be set to plaintext security context information, and the output sent from the transmitter to the receiver includes the ciphertext 714 concatenated with the data 710 or integrity protected plaintext concatenated with the authentication tag. The transmitter sends the output to the receiver in a format. The formats may include, but are not limited to, the nonce value 708, the mode 712, and security context information, if applicable, concatenated with the ciphertext 714; the ciphertext 714 alone; or the ciphertext 714 concatenated with the data 710 or integrity protected plaintext concatenated with the authentication tag.

For deciphering in the ciphering protection mode, a receiver (e.g., a UE, an AMF, a RAN node, or any network function) derives the security key 706 or an authenticated encryption or AEAD security key using an anchor key or any UE security context or network context available at the receiver, as well as other input parameters similar to the transmitter side process. The receiver may also use the security context information in the authenticated encryption or AEAD security key generation, as applicable. The receiver uses the AEAD security key in the decryption process.

In some cases, for the ciphering protection mode at the receiver, the receiver skips authentication tag verification for integrity check based on the mode 712 indication. The receiver then performs decryption by decrypting the ciphertext 714 using the authenticated encryption algorithm 704 (e.g., an AEAD algorithm) and input parameters, meaning the decryption function with inputs including the security key 706, the nonce value 708, the mode 712, the data 710 set to null, and the ciphertext 714, which results in the plaintext or message. Additionally, or alternatively, in a single pass operation, the receiver represents the decryption as the authenticated encryption or AEAD function with inputs including the security key 706, the nonce value 708, the data 710 set to null, the mode 712, authentication of null, and decryption of the ciphertext 714. The order of input parameters and keys used for integrity protection, meaning authentication tag generation, and encryption at the transmitter side and the respective integrity verification and decryption at the receiver side may follow the same order and format.

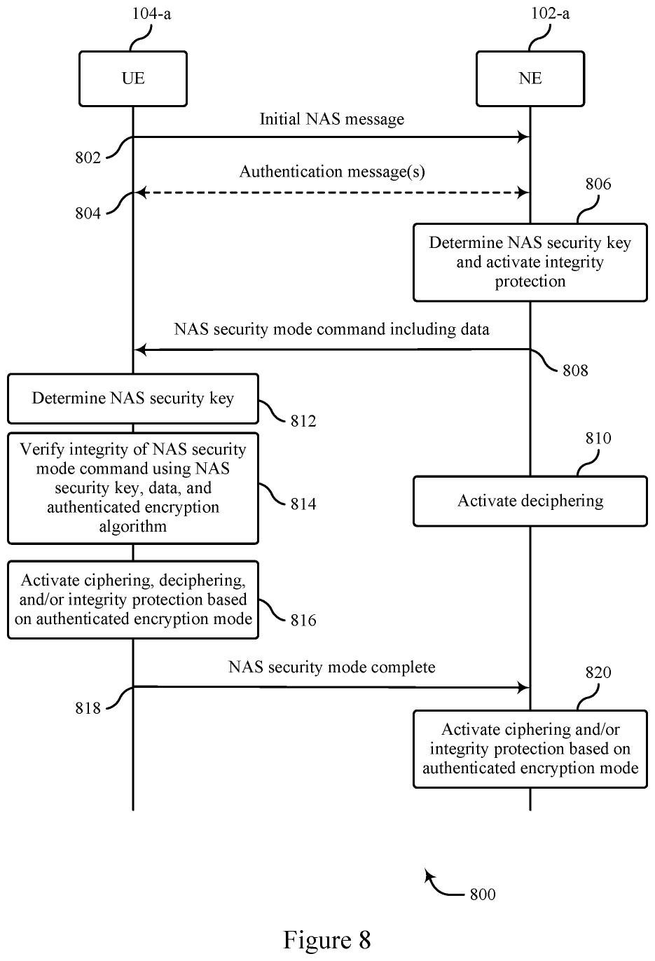

FIG. 8 illustrates an example of a signaling diagram 800 in accordance with aspects of the present disclosure. In some examples, the signaling diagram 800 implements or is implemented by aspects of the wireless communications system 100, the ciphering diagram, the integrity protection diagram 300, the integrity protection diagram 400, the authenticated encryption algorithm diagram 500, the authenticated encryption algorithm diagram 600, and/or the authenticated encryption algorithm diagram 700. The signaling diagram 800 may implement or be implemented by a UE 104-a and an NE 102-a, which may be examples of the corresponding devices as described with reference to FIG. 1. The signaling diagram 800 illustrates a method for selecting and using an authenticated encryption mode during a NAS security mode command procedure for NAS security establishment. Alternative examples of the following may be implemented, where some processes are performed in a different order than described or are not performed. In some cases, processes may include additional features not mentioned below, or further processes may be added.

In some cases, the NE 102-a may be an example of a transmitter, such as an AMF or other network function, that transmits a NAS security mode command message to the UE 104-a. The UE 104-a may be an example of a receiver that receives the NAS security mode command message, verifies the integrity of the message using an authenticated encryption algorithm, and transmits a NAS security mode complete message to the NE 102-a. The NE 102-a acts as a transmitter when sending the NAS security mode command message and acts as a receiver when receiving the NAS security mode complete message. The UE 104-a acts as a receiver when receiving the NAS security mode command message and acts as a transmitter when sending the NAS security mode complete message. The signaling diagram 800 illustrates the exchange of messages between the UE 104-a and the NE 102-a for establishing NAS security context using authenticated encryption algorithms with configurable modes.

In some examples, the NE 102-a determines and applies a combined authenticated encryption algorithm to an NCA for NAS protection, such as by using input parameters. The input parameters may include, but are not limited to, data (e.g., associated data), a nonce value or NAS count, a mode (e.g., including ciphering and/or integrity protection, as described with reference to FIGS. 5 through 7), and a NAS security key (e.g., K_{NASaead}, using 256-bit keys). The NE 102-a selects the combined authenticated encryption algorithm according to a capability of the UE 104-a to support combined authenticated encryption algorithms (e.g., algorithms related to SNOW 3G, AES, and ZUC), and related different AEAD modes (e.g., encryption plus integrity (EtM), integrity plus encryption (MtE), encryption, and integrity). In some examples, the AEAD modes may be examples of, or may be referred to as, authenticated encryption modes, including a partial integrity protection and ciphering mode, a combined integrity protection and ciphering mode, an integrity protection mode (e.g., without ciphering), and a ciphering mode (e.g., without integrity protection), as described with reference to FIGS. 5 through 7.

For example, the authenticated encryption modes described with reference to FIGS. 5 through 7 may correspond to different orderings of ciphering and integrity protection operations. An EtM mode may refer to an authenticated encryption mode in which the authenticated encryption algorithm first encrypts the plaintext to produce ciphertext and then generates an authentication tag over the ciphertext and associated data. The EtM mode may correspond to the combined ciphering and integrity protection mode or the selected ciphering and integrity protection mode, as described with reference to FIG. 5, where the ciphering operation precedes the authentication tag generation. An MtE mode may refer to an authenticated encryption mode in which the authenticated encryption algorithm first generates an authentication tag over the plaintext and associated data and then encrypts the plaintext and the authentication tag together to produce ciphertext. The MtE mode may correspond to an alternative ordering of the combined ciphering and integrity protection mode, as described with reference to FIG. 5, where the authentication tag generation precedes the ciphering operation. An encryption (e.g., enc or enc-only) mode may correspond to the ciphering mode, as described with reference to FIG. 7, where the authenticated encryption algorithm performs ciphering without generating an authentication tag for integrity protection. An integrity (e.g., int or int-only) mode may correspond to the integrity protection mode, as described with reference to FIG. 6, where the authenticated encryption algorithm generates an authentication tag without performing ciphering. The mode input to the authenticated encryption algorithm may indicate any of the EtM, MtE, enc, or int modes, and the authenticated encryption algorithm may determine the order and type of operations based on the mode input.

The NAS security mode command procedure establishes NAS security context between the UE 104-a and the NE 102-a. The procedure includes a roundtrip of messages between the NE 102-a and the UE 104-a, where the NE 102-a sends the NAS security mode command message to the UE 104-a, and the UE 104-a replies with the NAS security mode complete message. The UE 104-a in RRC_Connected and a serving network, such as the NE 102-a, agree upon algorithms for 128-bit or 256-bit NAS ciphering and NAS integrity protection to be used between the UE 104-a and the NE 102-a to support AEAD or authenticated encryption for NAS signaling protection. RRC_Connected refers to an RRC state in which the UE has an established RRC connection with the network and is actively communicating with a serving cell (e.g., the NE 102-a). In the RRC_Connected state, the UE 104-a may transmit and receive data, and the NE 102-a maintains context information for the UE 104-a, including security context for NAS and AS layer protection.

In some cases, at 802, the UE 104-a transmits an initial NAS message to the NE 102-a. If the UE 104-a is capable of supporting combined authenticated encryption, then the UE 104-a indicates the security capabilities of the UE 104-a to support combined authenticated encryption algorithms and the related different authenticated encryption modes supported to the NE 102-a in an initial NAS message. The initial NAS message may be an example of a registration request, a mobility registration update, a periodic registration update, or a PDU session establishment or modification request message. The initial NAS message may include a UE identifier of the UE 104-a, such as a subscription concealed identifier (SUCI) or a 5G globally unique temporary identifier (5G-GUTI). A SUCI is a privacy-preserving identifier that conceals the subscription permanent identifier (SUPI) of the UE. A 5G-GUTI (5G) is a temporary identifier assigned by the network to identify the UE 104-a without revealing the permanent subscriber identity. The UE 104-a integrity protects the initial NAS message using the authenticated encryption algorithm, and the NE 102-a verifies the integrity protection of the received initial NAS message. The UE 104-a supporting the combined authenticated encryption algorithms may indicate authenticated encryption algorithms or AEAD, combined authenticated encryption algorithms using SNOW 3G, AES, or ZUC, which may be 128-bit, 256-bit, 512-bit, or other bit-length operations. The UE 104-a supporting an authenticated encryption mode may indicate operations related to encryption and integrity, integrity and encryption, encryption, or integrity, indicating whether the UE can support integrity and/or ciphering. If the UE 104-a supports both integrity protection and ciphering, then the UE capability may indicate the order for NAS signaling protection. Ciphering and encryption may be used interchangeably, and deciphering and decryption may be used interchangeably. Additionally, or alternatively, the UE 104-a sends UE security capabilities with combined authenticated encryption algorithms and the related different authenticated encryption modes supported in any NAS message. Additionally, or alternatively, the UE 104-a sends UE security capabilities with a UE-supported authenticated encryption algorithms list, as well as the UE-supported authenticated encryption or authenticated encryption modes.

In some cases, at 804, the UE 104-a and the NE 102-a exchange one or more authentication messages, such as to perform primary authentication. Primary authentication refers to an authentication procedure between the UE 104-a and the NE 102-a that verifies the identities of both entities and establishes shared security keys. For example, the UE 104-a and the NE 102-a may exchange one or more authentication messages that enable each entity to verify the identity of the other entity using cryptographic operations based on a shared security key. Upon successful mutual authentication, both the UE 104-a and the NE 102-a derive the same set of security keys, including the K_{AMF}, which serves as the basis for deriving NAS security keys used in subsequent security procedures. If the primary authentication succeeds, then the NE 102-a initiates the NAS security mode command procedure.

At 806, the NE 102-a determines a NAS security key and activates integrity protection. For example, the NE 102-a selects and applies a combined authenticated encryption algorithm for NAS integrity and ciphering protection if the NE 102-a received UE security capabilities supporting combined authenticated encryption algorithms, as well as authenticated encryption modes. Additionally, or alternatively, the NE 102-a selects and applies the combined authenticated encryption algorithm if an operator configuration policy includes combined authenticated encryption algorithms in a prioritized list. If the NE 102-a determines to apply a combined authenticated encryption algorithm for NAS security, then the NE 102-a generates the NAS security key using a nonce value as the input parameter. The NE 102-a activates NAS integrity protection before sending the NAS security mode command message. The NE 102-a uses the selected combined authenticated encryption algorithm in the authenticated encryption mode for integrity protection. The NE 102-a uses the NAS security key, such as a security key or K_{NASint}, as well as input parameters such as data and a nonce value or NAS count. The NE 102-a provides these input parameters to the NCA algorithm for integrity protection for NAS signaling protection. For NAS security keys, in some cases, the NE 102-a may derive a 256-bit NAS security key from an existing 256-bit K_{AMF} using an authenticated encryption algorithm identifier (e.g., an algorithm type distinguisher N-NAS-authenc-alg as 0x07), a nonce value, and a mode (e.g., an authenticated encryption mode distinguisher). The authenticated encryption mode applies if the implementation and usage involve more than one authenticated encryption mode. In some other cases, the NE 102-a may derive the NAS security key based on the authenticated encryption mode of operation. When the authenticated encryption mode of operation implements both encryption and integrity protection, the NE 102-a concatenates an existing 128-bit NAS encryption key and a 128-bit NAS integrity key to form a 256-bit NAS security key (K_{NASaead}). When the authenticated encryption operation involves encryption without integrity protection, the NE 102-a uses an existing 256-bit K_{NASenc}. When the authenticated encryption operation involves integrity protection without ciphering, the NE 102-a uses an existing 256-bit K_{NASint}.

In some cases, the ciphering algorithm identifier values may be defined according to Table 1, where the ciphering algorithm identifiers and names are for 5G NAS and NR.

TABLE 1
Ciphering algorithm identifiers

| Identifier | Type | Description |
|---|---|---|
| 0000₂ | NEA0 | Null ciphering algorithm |
| 0001₂ | 128-NEA1 | 128-bit SNOW 3G-based algorithm |
| 0010₂ | 128-NEA2 | 128-bit AES-based algorithm |
| 0011₂ | 128-NEA3 | 128-bit ZUC-based algorithm |
| 0100₂ | 256-NEA4 | 256-bit SNOW 3G-based algorithm |
| 0101₂ | 256-NEA5 | 256-bit AES-based algorithm |
| 0110₂ | 256-NEA6 | 256-bit ZUC-based algorithm |

In some cases, the integrity protection algorithm identifier values may be defined according to Table 2, where the ciphering algorithm identifiers and names are for 5G NAS and NR.

TABLE 2
Integrity protection algorithm identifiers

| Identifier | Type | Description |
|---|---|---|
| 0000₂ | NIA0 | Null integrity protection algorithm |
| 0001₂ | 128-NIA1 | 128-bit SNOW 3G-based algorithm |
| 0010₂ | 128-NIA2 | 128-bit AES-based algorithm |
| 0011₂ | 128-NIA3 | 128-bit ZUC-based algorithm |
| 0100₂ | 256-NIA4 | 256-bit SNOW 3G-based algorithm |
| 0101₂ | 256-NIA5 | 256-bit AES-based algorithm |
| 0110₂ | 256-NIA6 | 256-bit ZUC-based algorithm |

In some cases, the combined authenticated encryption algorithms at a UE, a RAN (e.g., AS, RRC, and user plane), and CN functions (e.g., AMF, NAS) may be defined according to Table 3.

TABLE 3
Integrity protection algorithm identifiers

| Identifier | Type | Description |
|---|---|---|
| 0000₂ or 0111₂ | 256-NCA7 | 256-bit SNOW 3G-based algorithm - |
| | | AEAD |
| 0001₂ or 1000₂ | 256-NCA8 | 256-bit AES-based algorithm - AEAD |
| 0010₂ or 1001₂ | 256-NCA9 | 256-bit ZUC-based algorithm - AEAD |

At 808, the NE 102-a sends the NAS security mode command message including data to the UE 104-a (e.g., a first message including data that indicates an authenticated encryption algorithm and an authenticated encryption mode associated with at least one of integrity protection or ciphering). The NAS security mode command message includes an associated data portion. The associated data portion includes the UE security capabilities with support of combined authenticated encryption algorithms, the related different authenticated encryption modes supported per algorithm, the selected NAS algorithms including the combined authenticated encryption algorithm, the enabled or selected authenticated encryption mode, a nonce value, and the ngKSI that identifies the K_{AMF}. The NAS security mode command message may include a K_AMF_change_flag carried in the additional 5G security parameters information element. The flag indicates that the network calculated a new K_{AMF}. The NAS security mode command message may also include a flag requesting the complete initial NAS message and an anti-bidding down between architectures parameter. The anti-bidding down parameter indicates that combined authenticated encryption is activated or indicates that the UE 104-a is to use the NAS security key. For horizontal derivation of K_{AMF} during mobility registration update or during multiple registration in the same public land mobile network (PLMN), the NE 102-a includes the K_AMF_change_flag in the NAS security mode command message. The associated data portion sent in the NAS security mode command message indicates that the NE 102-a and the UE 104-a integrity protect the information included in the associated data without ciphering. The nonce value indicates to the UE 104-a that the UE 104-a uses the nonce value in the NAS security key generation, such as the security key or K_{NASint} key generation. If the NE 102-a determines to apply combined authenticated encryption for NAS protection, then the NE 102-a integrity protects the NAS security mode command message but does not cipher the message with the NAS security key (e.g., K_{NASaead}). The NE 102-a derives the key from the K_{AMF} indicated by the ngKSI in the NAS security mode command message. The NE 102-a may send the combined authenticated encryption activated indication or the use NAS security key indication to the UE 104-a as part of the anti-bidding down between architectures parameter, or as an individual information element. If the network supports interworking using an N26 interface between an MME and an AMF, then the AMF also includes the selected evolved packet system (EPS) NAS algorithms in the NAS security mode command message. The UE 104-a uses the algorithms after mobility to an EPS. The UE 104-a stores the algorithms for use after mobility to EPS using the N26 interface between the MME and the AMF. The AMF stores the selected EPS NAS algorithms at the UE security context. When an AMF change happens (e.g., either due to N2-handover or idle mode mobility), the source AMF includes the selected EPS NAS algorithms in the 5G UE security context and provides the algorithms to the target AMF as part of the 5G UE security context.

At 810, the NE 102-a activates deciphering. For example, if the NE 102-a determines to apply a combined authenticated encryption algorithm for NAS protection, then the NE 102-a activates NAS uplink deciphering after sending the NAS security mode command message. The NE 102-a uses the NAS security key in the authenticated encryption mode that the NE 102-a selected and indicated at 808. The NE 102-a also uses other inputs, such as associated data and a nonce value or NAS count.

At 812, the UE 104-a determines a NAS security key. For example, the UE 104-a determines to derive the NAS security key using a derivation similar to the derivation described at 806. The UE 104-a derives the key in response to receiving the selected NAS algorithms and nonce value that indicate combined authenticated encryption. The UE 104-a also derives the key in response to receiving the combined authenticated encryption activated indication or the use NAS security key indication from the NE 102-a.

At 814, the UE 104-a verifies an integrity of the NAS security mode command message (e.g., the first message) using the NAS security key, data, and the authenticated encryption algorithm. The verification includes the UE 104-a checking that the UE security capabilities with combined authenticated encryption support information and the related authenticated encryption mode support information match the capabilities stored in the UE 104-a. In some cases, the UE 104-a performs the check if the UE 104-a sent the capabilities at 802. The check ensures that an attacker did not modify the capabilities. The verification also includes the UE 104-a verifying the integrity protection using the indicated NAS protection algorithm, which is the combined authenticated encryption algorithm. The UE 104-a uses the NAS security key derived from the K_{AMF} indicated by the ngKSI. The UE 104-a uses the received associated data and nonce value or NAS count, as well as other input parameters to the NCA algorithms for NAS protection. In some cases, the UE 104-a generates an expected authentication tag using the authenticated encryption algorithm based on the NAS security key, the nonce value, and the data, and verifies the integrity of the NAS security mode command message based on the expected authentication tag matching a received authentication tag included in the NAS security mode command message. In some cases, the nonce value is constructed by the UE 104-a using parameters available at both the UE 104-a and the NE 102-a, such as a count value, a direction bit, a bearer identifier, and an algorithm identifier associated with the authenticated encryption algorithm. If the NAS security mode command message includes a K_AMF_change_flag, then the UE 104-a derives a new K_{AMF} and sets the NAS counts to zero.

At 816, if the UE 104-a successfully verifies the integrity of the NAS security mode command message, the UE 104-a activates ciphering, deciphering, and/or integrity protection based on the authenticated encryption mode. The UE 104-a uses the nonce value and the indicated combined authenticated encryption algorithm in the authenticated encryption mode that the NE 102-a selected and indicated at 808. The UE 104-a uses the security context, which is the NAS security key indicated by the ngKSI, and the received nonce value.

The UE 104-a and the NE 102-a apply security protection to subsequent messages according to the authenticated encryption mode. For example, if the authenticated encryption mode indicates partial ciphering with integrity protection, then the UE 104-a identifies sensitive information elements and non-sensitive information elements within a message, provides the sensitive information elements as plaintext input and the non-sensitive information elements as data input to the authenticated encryption algorithm, and generates ciphertext and an authentication tag, as described with reference to FIG. 5. If the authenticated encryption mode indicates integrity protection without ciphering, then the UE 104-a sets the plaintext input to a null value and provides the message as data to the authenticated encryption algorithm, generating an authentication tag without generating ciphertext, as described with reference to FIG. 6. If the authenticated encryption mode indicates ciphering without integrity protection, then the UE 104-a sets the data to a null value and provides the message as plaintext input to the authenticated encryption algorithm, generating ciphertext without generating an authentication tag, as described with reference to FIG. 7. If the authenticated encryption mode indicates combined ciphering and integrity protection, then the UE 104-a provides the entire message as plaintext input with the data set to a null value, generating both ciphertext and an authentication tag, as described with reference to FIG. 5.

At 818, the UE 104-a sends the NAS security mode complete message to the NE 102-a (e.g., a second message associated with activation of at least one of the integrity protection or the ciphering based on the authenticated encryption mode). If the UE 104-a selected and used the combined authenticated encryption algorithm, then the UE 104-a ciphers and integrity protects the message with the NAS security key. The NAS security mode complete message includes a paging early indicator (PEI) if the NE 102-a requested the PEI in the NAS security mode command message. In some cases, the NAS security mode complete message also includes a nonce value. The NE 102-a sets the NAS counts to zero if the NE 102-a performs horizontal derivation of K_{AMF}. The UE 104-a may include the complete initial NAS message. If the UE 104-a does not successfully verify the NAS security mode command message, then the UE 104-a replies with a NAS security mode reject message. The UE 104-a protects the NAS security mode reject message and subsequent NAS messages with the previous 5G NAS security context, if any. The previous 5G NAS security context is the 5G NAS security context that the UE 104-a used prior to the failed NAS security mode command message. If no 5G NAS security context existed prior to the NAS security mode command message, then the NAS security mode reject message remains unprotected. If the uplink NAS count is to wrap around by sending the NAS security mode reject message, then the UE 104-a releases the NAS connection instead of sending the NAS security mode reject message.

At 820, the NE 102-a activates ciphering and/or integrity protection based on the authenticated encryption mode. For example, the NE 102-a deciphers and checks the integrity protection of the NAS security mode complete message. If the UE 104-a selected and used the combined authenticated encryption algorithm, then the NE 102-a uses the key, nonce value, and algorithm with the NAS security key in the authenticated encryption mode that the NE 102-a selected and indicated at 808. The NE 102-a uses the algorithm indicated in the NAS security mode command message. The NE 102-a starts NAS downlink ciphering with the security context after receiving the NAS security mode complete message. If the UE 104-a selected and used the combined authenticated encryption algorithm, then the NE 102-a activates NAS downlink ciphering with the NAS security key in the authenticated encryption mode. The NE 102-a uses the mode that the NE 102-a selected and indicated at 808. The NE 102-a also uses other inputs, such as associated data and a nonce value or NAS count. If the NE 102-a successfully validates the NAS security mode complete message, then the NE 102-a has successfully confirmed that the SUPI received from the home network and the SUPI used by the UE 104-a match. However, integrity check failure of the NAS security mode complete message at the NE 102-a may have other causes than a mismatch of the SUPIs.

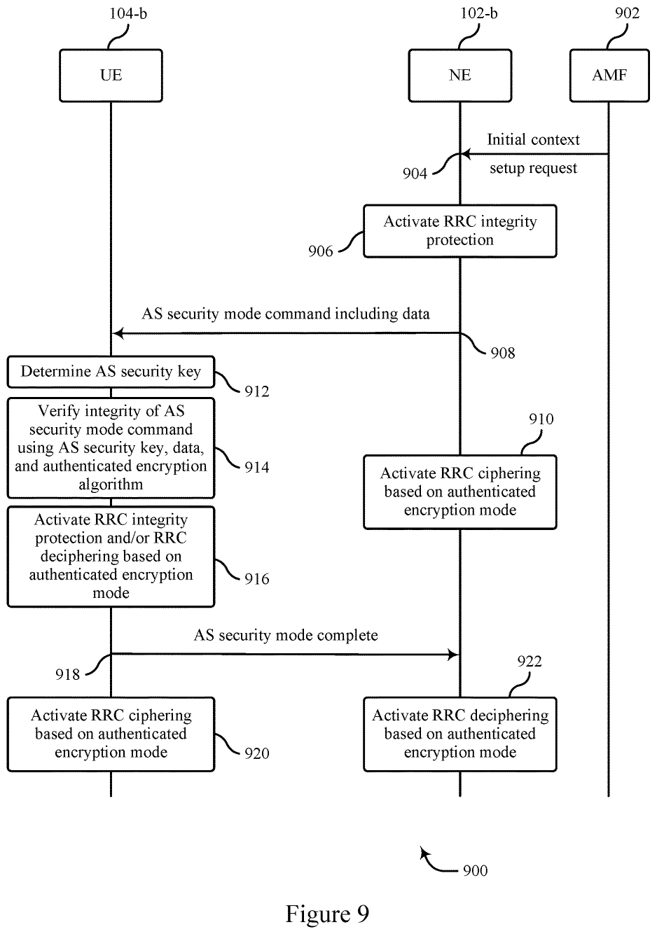

FIG. 9 illustrates an example of a signaling diagram 900 in accordance with aspects of the present disclosure. In some examples, the signaling diagram 900 implements or is implemented by aspects of the wireless communications system 100, the ciphering diagram, the integrity protection diagram 300, the integrity protection diagram 400, the authenticated encryption algorithm diagram 500, the authenticated encryption algorithm diagram 600, the authenticated encryption algorithm diagram 700, and/or the signaling diagram 800. The signaling diagram 900 may implement or be implemented by a UE 104-b, an NE 102-b, and an AMF 902, which may be examples of the corresponding devices as described with reference to FIG. 1. The signaling diagram 900 illustrates a method for selecting and using an authenticated encryption mode during an AS security mode command procedure for AS security establishment. Alternative examples of the following may be implemented, where some processes are performed in a different order than described or are not performed. In some cases, processes may include additional features not mentioned below, or further processes may be added.

In some cases, the NE 102-b may be an example of a transmitter, such as a gNB, ng-eNB, or other RAN node, that transmits an AS security mode command message to the UE 104-b. The AMF 902 may be an example of a CN function that communicates with the NE 102-b via an N2 interface or other backhaul connection. The AMF 902 provides security context information, including UE security capabilities and security keys, such as KgNB, to the NE 102-b through signaling messages, such as an initial context setup request. The NE 102-b uses the security context information received from the AMF 902 to establish AS security with the UE 104-b. The UE 104-b may be an example of a receiver that receives the AS security mode command message, verifies the integrity of the message using an authenticated encryption algorithm, and transmits an AS security mode complete message to the NE 102-b. The NE 102-b acts as a transmitter when sending the AS security mode command message and acts as a receiver when receiving the AS security mode complete message. The UE 104-b acts as a receiver when receiving the AS security mode command message and acts as a transmitter when sending the AS security mode complete message. The signaling diagram 900 illustrates the exchange of messages between the UE 104-b, the NE 102-b, and the AMF 902 for establishing AS security context using authenticated encryption algorithms with configurable modes.

In some examples, the NE 102-b determines and applies a combined authenticated encryption algorithm to an NCA for AS protection, such as by using input parameters. The input parameters may include, but are not limited to, data (e.g., associated data), a nonce value or RRC count or PDCP count, a mode (e.g., including ciphering and/or integrity protection, as described with reference to FIGS. 5 through 7), and an AS security key (e.g., K_{RRCaead} and K_{UPaead}, using 256-bit keys). The NE 102-b selects the combined authenticated encryption algorithm according to a capability of the UE 104-b to support combined authenticated encryption algorithms (e.g., algorithms related to SNOW 3G, AES, and ZUC), and related different AEAD modes (e.g., EtM, MtE, encryption, and integrity). In some examples, the AEAD modes may be examples of, or may be referred to as, authenticated encryption modes. The authenticated encryption modes include a partial integrity protection and ciphering mode, a combined integrity protection and ciphering mode, an integrity protection mode (e.g., without ciphering), and a ciphering mode (e.g., without integrity protection), as described with reference to FIGS. 5 through 7. The AS security mode command procedure establishes AS security context between the UE 104-b and the NE 102-b. The procedure includes messages between the NE 102-b and the UE 104-b. The NE 102-b sends the AS security mode command message to the UE 104-b, and the UE 104-b replies with the AS security mode complete message. The UE 104-b in an RRC_Connected state and the NE 102-b may agree upon algorithms for 128-bit or 256-bit ciphering and integrity protection to be used between the UE 104-b and the NE 102-b. The agreed upon algorithms support authenticated encryption for RRC signaling protection and user plane protection.

In some cases, at 904, the AMF 902 transmits an initial context setup request message to the NE 102-b. The AMF 902 may receive UE security capabilities indicating support for combined authenticated encryption algorithms and the related different authenticated encryption modes. If the AMF 902 determines to select and apply a combined authenticated encryption algorithm for NAS integrity and ciphering protection following successful reception of a NAS security mode complete message, then the AMF 902 initiates the NGAP procedure initial context setup. The initial context setup request message includes UE security capabilities supporting combined authenticated encryption algorithms (e.g., code related to SNOW 3G, AES, and ZUC-based authenticated encryption), the related different authenticated encryption modes supported per algorithm (e.g., NCA7, NCA8, NCA9), an enable or activate authenticated encryption mode indication, and K_{gNB}. Additionally, or alternatively, the initial context setup request message may include a use authenticated encryption AS key indication.

At 906, the NE 102-b activates RRC integrity protection. For example, the NE 102-b determines to select and apply a combined authenticated encryption algorithm for AS security (e.g., RRC integrity and/or ciphering protection and user plane integrity and/or ciphering protection). The NE 102-b may select and apply the combined authenticated encryption algorithm if the NE 102-b received UE security capabilities indicating support for combined authenticated encryption algorithms and supported authenticated encryption modes from the AMF 902 in the initial context setup request. Additionally, or alternatively, the NE 102-b may select and apply the combined authenticated encryption algorithm if an operator configuration policy includes combined authenticated encryption algorithms in a prioritized list. If the NE 102-b determines to apply a combined authenticated encryption algorithm for AS (e.g., RRC and user plane) security, then the NE 102-b performs the authenticated encryption RRC security key derivation (e.g., K_{RRCaead}) and authenticated encryption user plane security key derivation (e.g., K_{UPaead}) using a nonce value as an input parameter. The NE 102-b activates RRC integrity protection before sending the AS security mode command message by using the selected combined authenticated encryption algorithm in the authenticated encryption mode for integrity protection. The NE 102-b uses the authenticated encryption RRC key for RRC signaling protection, as well as input parameters (e.g., data and a nonce value or RRC count or PDCP count), to the NCA algorithm for integrity protection according to the authenticated encryption mode.

In some cases, for RRC security keys, the NE 102-b derives a 256-bit authenticated encryption RRC security key from an existing 256-bit K_{gNB} or KSN. The NE 102-b uses an authenticated encryption algorithm identifier (e.g., an algorithm type distinguisher N-RRC-authenc-alg as 0x08), a nonce value, and a mode (e.g., an authenticated encryption mode distinguisher) for the derivation. The authenticated encryption mode applies if the implementation and usage involve more than one authenticated encryption mode. In some other cases, the NE 102-b derives the RRC security key according to the authenticated encryption mode of operation. When the authenticated encryption mode of operation implements both encryption and integrity protection, the NE 102-b concatenates an existing 128-bit RRC encryption key and a 128-bit RRC integrity key to form a 256-bit authenticated encryption RRC security key (e.g., K_{RRCaead}). When the authenticated encryption operation involves encryption without integrity protection, the NE 102-b uses an existing 256-bit K_{RRCenc}. When the authenticated encryption operation involves integrity protection without ciphering, the NE 102-b uses an existing 256-bit KRRCint.

In some cases, for user plane security keys, the NE 102-b derives a 256-bit authenticated encryption user plane security key from an existing 256-bit K_{gNB} or KSN. The NE 102-b uses an authenticated encryption algorithm identifier (e.g., an algorithm type distinguisher N-UP-authenc-alg as 0x09), a nonce value, and a mode (e.g., an authenticated encryption mode distinguisher) for the derivation. The authenticated encryption mode applies if the implementation and usage involve more than one authenticated encryption mode. In some other cases, the NE 102-b derives the user plane security key according to the authenticated encryption mode of operation. When the authenticated encryption mode of operation implements both encryption and integrity protection, the NE 102-b concatenates an existing 128-bit user plane encryption key and a 128-bit user plane integrity key to form a 256-bit authenticated encryption user plane security key (e.g., K_{UPaead}). When the authenticated encryption operation involves encryption without integrity protection, the NE 102-b uses an existing 256-bit K_{UPenc}. When the authenticated encryption operation involves integrity protection without ciphering, the NE 102-b uses an existing 256-bit K_{UPint}.

At 908, the NE 102-b sends the AS security mode command message, including data, to the UE 104-b (e.g., a first message including data that indicates an authenticated encryption algorithm and an authenticated encryption mode associated with at least one of integrity protection or ciphering). The AS security mode command message includes an associated data portion. The associated data portion includes the selected combined authentication algorithms for RRC and user plane encryption and/or integrity algorithms, a nonce value, and the enabled or selected authenticated encryption mode. The NE 102-b integrity protects the AS security mode command message with the authenticated encryption RRC integrity key derived from the current K_{gNB}. The NE 102-b uses the selected combined authentication algorithm for integrity protection in the authenticated encryption mode for integrity protection. The additional data portion sent in the AS security mode command message indicates that the NE 102-b and the UE 104-b integrity protect the information included in the additional data without ciphering. The nonce value indicates to the UE 104-b that the UE 104-b uses the nonce value in the authenticated encryption AS key generation, such as the security key or KRRCint key generation.

At 910, the NE 102-b activates RRC ciphering based on the authenticated encryption mode. For example, the NE 102-b starts RRC downlink ciphering after sending the AS security mode command message using the combined authenticated encryption algorithm and authenticated encryption mode as indicated at 908. If the NE 102-b determines to apply a combined authenticated encryption algorithm for AS protection, then the NE 102-b activates RRC uplink deciphering using the authenticated encryption RRC key in the authenticated encryption mode after sending the AS security mode command message.

At 912, the UE 104-b determines an AS security key. For example, the UE 104-b determines to derive the authenticated encryption RRC key using the received selected RRC algorithm indicating combined authenticated encryption, the nonce value, and/or the received enabled or selected authenticated encryption mode from the NE 102-b. The UE 104-b determines to derive and use authenticated encryption AS keys (e.g., authenticated encryption RRC key K_{RRCaead} and authenticated encryption user plane key K_{UPaead}) using the received combined authenticated encryption algorithm information or indication from the NE 102-b.

At 914, the UE 104-b verifies an integrity of the AS security mode command message (e.g., the first message) using the AS security key, data, and the authenticated encryption algorithm. The verification includes the UE 104-b verifying the integrity protection using the indicated combined authenticated encryption algorithm with the authenticated encryption mode for integrity protection and the authenticated encryption RRC key. The UE 104-b also uses the received additional data and nonce value or RRC count or PDCP count, as well as other input parameters to the NCA algorithms for AS or RRC protection. In some cases, the UE 104-b generates an expected authentication tag using the authenticated encryption algorithm based on the AS security key, the nonce value, and the data, and verifies the integrity of the AS security mode command message based on the expected authentication tag matching a received authentication tag included in the AS security mode command message. In some cases, the nonce value is constructed by the UE 104-b using parameters available at both the UE 104-b and the NE 102-b, such as a count value, a direction bit, a bearer identifier, and an algorithm identifier associated with the authenticated encryption algorithm.

At 916, if the UE 104-b successfully verifies the integrity of the AS security mode command message, the UE 104-b activates RRC integrity protection and/or RRC deciphering according to the authenticated encryption mode. The UE 104-b starts RRC downlink deciphering after receiving and successfully verifying the AS security mode command message with the authenticated encryption RRC security key in the authenticated encryption mode. The UE 104-b also uses other inputs, such as additional data and nonce value or RRC count or PDCP count, if a combined authenticated encryption algorithm was selected and used. The UE 104-b and the NE 102-b apply security protection to subsequent messages according to the authenticated encryption mode, as described with reference to the authenticated encryption modes at 816 of FIG. 8.

At 918, the UE 104-b sends the AS security mode complete message to the NE 102-b (e.g., a second message associated with activation of at least one of the integrity protection or the ciphering based on the authenticated encryption mode). The UE 104-b ciphers and/or integrity protects the AS security mode complete message in an order determined by the selected combined authenticated encryption algorithm and authenticated encryption mode indicated in the AS security mode command message. The UE 104-b uses the nonce value and the authenticated encryption RRC key derived from the current K_{gNB}. In some cases, the AS security mode complete message also includes a nonce value. If any control of the AS security mode command is not successful at the UE 104-b, then the UE 104-b replies with an unprotected security mode failure message.

At 920, the UE 104-b activates RRC ciphering (e.g., encryption) based on the authenticated encryption mode. For example, the UE 104-b starts RRC uplink ciphering after sending the AS security mode complete message with the authenticated encryption RRC security key in the authenticated encryption mode. The UE 104-b also uses other inputs, such as additional data and nonce value or RRC count or PDCP count, if a combined authenticated encryption algorithm was selected and used.

At 922, the NE 102-b activates RRC deciphering (e.g., decryption) based on the authenticated encryption mode. For example, the NE 102-b starts RRC uplink deciphering after receiving and successfully verifying the AS security mode complete message. The UE 104-b and the NE 102-b start ciphering and/or integrity protection of user plane downlink and uplink with the authenticated encryption user plane security key and selected combined authenticated encryption algorithm with the selected authenticated encryption mode as part of the user plane security activation procedure. The AS security mode command procedure is used during an initial context setup between the UE 104-b and the NE 102-b (e.g., to activate an initial K_{gNB} at RRC_Idle to RRC_Connected state transition). Derivation of a K_{gNB} at RRC_Idle to RRC_Connected state ensures that the AS security mode command procedure establishes a fresh K_{gNB}. Additionally, or alternatively, the PDCP counts can be reset.

The UE 104-b and the NE 102-b may follow the procedures described with reference to FIGS. 5 through 7 to perform the user plane security related integrity and/or ciphering protection and the related verification.

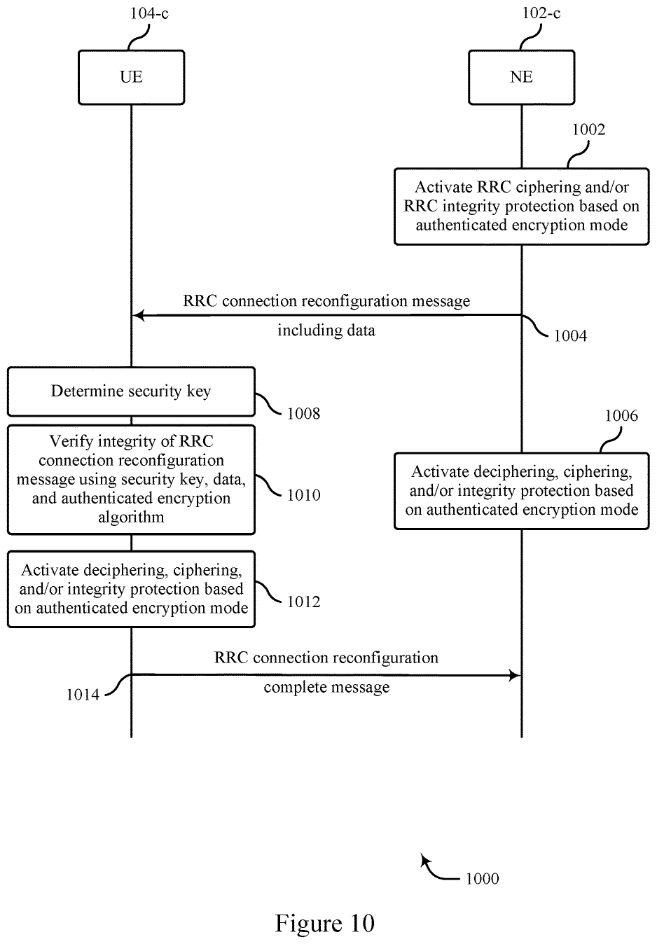

FIG. 10 illustrates an example of a signaling diagram 1000 in accordance with aspects of the present disclosure. In some examples, the signaling diagram 1000 implements or is implemented by aspects of the wireless communications system 100, the ciphering diagram, the integrity protection diagram 300, the integrity protection diagram 400, the authenticated encryption algorithm diagram 500, the authenticated encryption algorithm diagram 600, the authenticated encryption algorithm diagram 700, the signaling diagram 800, and/or the signaling diagram 900. The signaling diagram 900 may implement or be implemented by a UE 104-c and an NE 102-c, which may be examples of the corresponding devices as described with reference to FIG. 1. The signaling diagram 1000 illustrates a method for selecting and using an authenticated encryption mode during an RRC connection reconfiguration procedure. Alternative examples of the following may be implemented, where some processes are performed in a different order than described or are not performed. In some cases, processes may include additional features not mentioned below, or further processes may be added.

In some cases, the NE 102-c may be an example of a transmitter, such as a gNB, ng-eNB, or other RAN node, that transmits an RRC connection reconfiguration message to the UE 104-c. The UE 104-c may be an example of a receiver that receives the RRC connection reconfiguration message, verifies the integrity of the message using an authenticated encryption algorithm, and transmits an RRC connection reconfiguration complete message to the NE 102-c. The NE 102-c acts as a transmitter when sending the RRC connection reconfiguration message and acts as a receiver when receiving the RRC connection reconfiguration complete message. The UE 104-c acts as a receiver when receiving the RRC connection reconfiguration message and acts as a transmitter when sending the RRC connection reconfiguration complete message. The signaling diagram 1000 illustrates the exchange of messages between the UE 104-c and the NE 102-c for activating user plane security per DRB using authenticated encryption algorithms with configurable modes.

In some examples, the NE 102-c determines and applies a combined authenticated encryption algorithm to an NCA for user plane protection, such as by using input parameters. The input parameters may include, but are not limited to, data (e.g., associated data), a nonce value or PDCP count, a mode (e.g., including ciphering and/or integrity protection, as described with reference to FIGS. 5 through 7), and a user plane security key (e.g., K_{UPaead}, using 256-bit keys). The NE 102-c selects the combined authenticated encryption algorithm according to a capability of the UE 104-c to support combined authenticated encryption algorithms (e.g., algorithms related to SNOW 3G, AES, and ZUC), and related different AEAD modes (e.g., EtM, MtE, encryption, and integrity). In some examples, the AEAD modes may be examples of, or may be referred to as, authenticated encryption modes. The authenticated encryption modes include a partial integrity protection and ciphering mode, a combined integrity protection and ciphering mode, an integrity protection mode (e.g., without ciphering), and a ciphering mode (e.g., without integrity protection), as described with reference to FIGS. 5 through 7.

The NE 102-c uses the RRC connection reconfiguration procedure to add DRBs and activate user plane security after the NE 102-c and the UE 104-c have activated RRC security as part of the AS security mode command procedure. In some cases, a session management function (SMF) sends a user plane security policy to the NE 102-c. The user plane security policy indicates whether the NE 102-c activates user plane integrity protection and/or ciphering for each DRB.

At 1002, the NE 102-c activates RRC ciphering and/or RRC integrity protection based on the authenticated encryption mode. For example, the NE 102-c performs the RRC connection reconfiguration procedure after the NE 102-c and the UE 104-c have activated RRC security as part of the AS security mode command procedure. The NE 102-c uses the authenticated encryption mode to determine input parameters, such as data, nonce value or PDCP count, and provides the input parameters to the NCA algorithm for user plane security establishment.

At 1004, the NE 102-c sends the RRC connection reconfiguration message including data to the UE 104-c (e.g., a first message including data that indicates an authenticated encryption algorithm and an authenticated encryption mode associated with at least one of integrity protection or ciphering). The RRC connection reconfiguration message includes an associated data portion for user plane security activation. The associated data portion includes indications of a specific authenticated encryption mode (e.g., encryption and integrity, integrity and encryption, encryption, or integrity) that the NE 102-c uses for the activation of user plane integrity protection and/or ciphering for each DRB, and a nonce value according to the security policy. Additionally, or alternatively, the NE 102-c sets the associated data to a null value when the NE 102-c ciphers and integrity protects the message, as described with reference to FIG. 5. For each DRB, the authenticated encryption mode indicated in the RRC connection reconfiguration message determines the type of protection that the NE 102-c and the UE 104-c apply. The protection may include user plane integrity, user plane encryption, user plane integrity protected and encrypted, or user plane encrypted and integrity protected. These protection types map to the authenticated encryption modes of integrity, encryption, encryption and integrity, or integrity and encryption, respectively.

At 1006, the NE 102-c activates deciphering, ciphering, and/or integrity protection based on the authenticated encryption mode. When the NE 102-c activates user plane integrity protection for DRBs using the selected combined authenticated encryption with an authenticated encryption mode (e.g., integrity) as indicated in the RRC connection reconfiguration message, the NE 102-c generates the authenticated encryption user plane key if the NE 102-c does not have the key. The NE 102-c starts user plane integrity protection for such DRBs. The NE 102-c uses the input parameters, such as data, nonce value or PDCP count, and provides these input parameters to the NCA algorithm for user plane protection. Additionally, or alternatively, when the NE 102-c activates user plane ciphering for DRBs using the selected combined authenticated encryption with an authenticated encryption mode (e.g., encryption and integrity, integrity and encryption, or encryption) as indicated in the RRC connection reconfiguration message, the NE 102-c generates the authenticated encryption user plane key if the NE 102-c does not have the key. The NE 102-c starts user plane ciphering for such DRBs.

In some cases, for user plane security keys, the NE 102-c derives a 256-bit authenticated encryption user plane security key from an existing 256-bit K_{gNB} or KSN. The NE 102-c uses an authenticated encryption algorithm identifier (e.g., an algorithm type distinguisher N-UP-authenc-alg as 0x09), a nonce value, and a mode (e.g., an authenticated encryption mode distinguisher) for the derivation. The authenticated encryption mode applies if the implementation and usage involve more than one authenticated encryption mode. In some other cases, the NE 102-c derives the user plane security key according to the authenticated encryption mode of operation. When the authenticated encryption mode of operation implements both encryption and integrity protection, the NE 102-c concatenates an existing 128-bit user plane encryption key and a 128-bit user plane integrity key to form a 256-bit authenticated encryption user plane security key (e.g., K_{UPaead}). When the authenticated encryption operation involves encryption without integrity protection, the NE 102-c uses an existing 256-bit K_{UPenc}. When the authenticated encryption operation involves integrity protection without ciphering, the NE 102-c uses an existing 256-bit K_{UPint}.

At 1008, the UE 104-c determines a security key. For example, the UE 104-c derives the authenticated encryption user plane key using the received selected user plane algorithm indicating combined authenticated encryption, the nonce value, and/or the received enabled or selected authenticated encryption mode from the NE 102-c.

At 1010, the UE 104-c verifies an integrity of the RRC connection reconfiguration message (e.g., the first message) using the security key, data, and the authenticated encryption algorithm. When the UE 104-c activates user plane integrity protection for DRBs using the selected combined authenticated encryption with an authenticated encryption mode (e.g., encryption and integrity, integrity and encryption, encryption, or integrity) as indicated in the RRC connection reconfiguration message, the UE 104-c generates the authenticated encryption user plane key if the UE 104-c does not have the key. The UE 104-c starts user plane integrity protection for such DRBs. The UE 104-c uses the input parameters, such as data, nonce value or PDCP count, and provides these input parameters to the NCA algorithm for user plane protection. Additionally, or alternatively, when the UE 104-c activates user plane ciphering for DRBs using the selected combined authenticated encryption with an authenticated encryption mode (e.g., encryption and integrity, integrity and encryption, encryption, or integrity) as indicated in the RRC connection reconfiguration message, the UE 104-c generates the authenticated encryption user plane key if the UE 104-c does not have the key. The UE 104-c starts user plane ciphering for such DRBs. In some cases, the UE 104-c generates an expected authentication tag using the authenticated encryption algorithm based on the security key, the nonce value, and the data, and verifies the integrity of the RRC connection reconfiguration message based on the expected authentication tag matching a received authentication tag included in the RRC connection reconfiguration message. In some cases, the nonce value is constructed by the UE 104-c using parameters available at both the UE 104-c and the NE 102-c, such as a count value, a direction bit, a bearer identifier, and an algorithm identifier associated with the authenticated encryption algorithm.

At 1012, if the UE 104-c successfully verifies the integrity of the RRC connection reconfiguration message, then the UE 104-c activates deciphering, ciphering, and/or integrity protection based on the authenticated encryption mode. The UE 104-c and the NE 102-c apply security protection to subsequent user plane messages for each DRB according to the authenticated encryption mode, as described with reference to the authenticated encryption modes at 816 of FIG. 8.

At 1014, the UE 104-c sends the RRC connection reconfiguration complete message to the NE 102-c (e.g., a second message associated with activation of at least one of the integrity protection or the ciphering based on the authenticated encryption mode). In some cases, the UE 104-c includes a nonce value in the RRC connection reconfiguration complete message. When the NE 102-c and the UE 104-c do not activate user plane integrity protection for DRBs, the NE 102-c and the UE 104-c do not integrity protect the traffic of such DRBs. The NE 102-c and the UE 104-c do not include an authentication tag in PDCP packets for such DRBs. When the NE 102-c and the UE 104-c do not activate user plane ciphering for DRBs, the NE 102-c and the UE 104-c do not cipher the traffic of the DRBs.

The UE 104-c and the NE 102-c follow the procedures described with reference to FIGS. 5 through 7 to perform the user plane security related integrity and/or ciphering protection and the related verification accordingly.

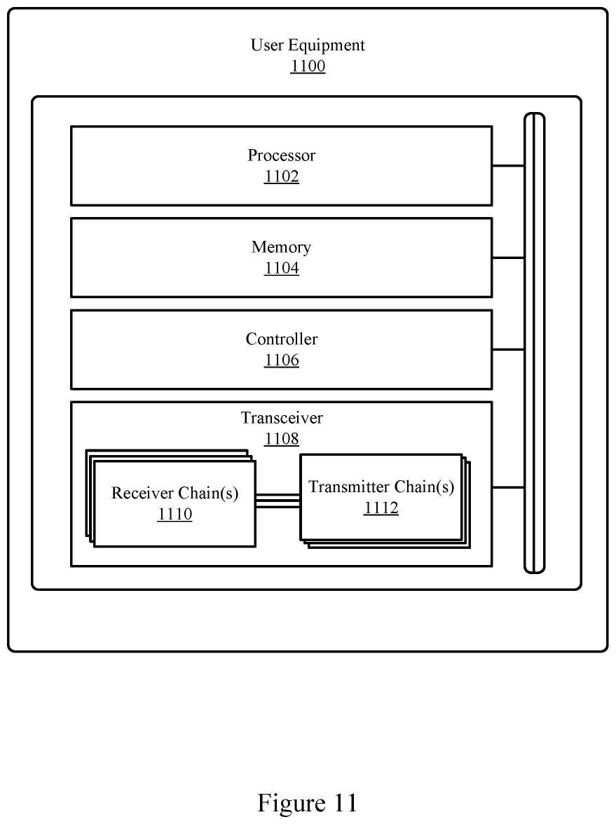

FIG. 11 illustrates an example of a UE 1100 in accordance with aspects of the present disclosure. The UE 1100 may include a processor 1102, a memory 1104, a controller 1106, and a transceiver 1108. The processor 1102, the memory 1104, the controller 1106, or the transceiver 1108, or various combinations thereof or various components thereof may be examples of means for performing various aspects of the present disclosure as described herein. These components may be coupled (e.g., operatively, communicatively, functionally, electronically, electrically) via one or more interfaces.

The processor 1102, the memory 1104, the controller 1106, or the transceiver 1108, or various combinations or components thereof may be implemented in hardware (e.g., circuitry). The hardware may include a processor, a digital signal processor (DSP), an application-specific integrated circuit (ASIC), or other programmable logic device, or any combination thereof configured as or otherwise supporting a means for performing the functions described in the present disclosure.

The processor 1102 may include an intelligent hardware device (e.g., a general-purpose processor, a DSP, a central processing unit (CPU), an ASIC, a field-programmable gate-array (FPGA), or any combination thereof). In some implementations, the processor 1102 may be configured to operate the memory 1104. In some other implementations, the memory 1104 may be integrated into the processor 1102. The processor 1102 may be configured to execute computer-readable instructions stored in the memory 1104 to cause the UE 1100 to perform various functions of the present disclosure.

The memory 1104 may include volatile or non-volatile memory. The memory 1104 may store computer-readable, computer-executable code including instructions that, when executed by the processor 1102, cause the UE 1100 to perform various functions described herein. The code may be stored in a non-transitory computer-readable medium such as the memory 1104 or another type of memory. Computer-readable media include both non-transitory computer storage media and communication media, including any medium that facilitates transfer of a computer program from one place to another. A non-transitory storage medium may be any available medium that may be accessed by a general-purpose or special-purpose computer.

In some implementations, the processor 1102 and the memory 1104 coupled with the processor 1102 may be configured to cause the UE 1100 to perform one or more of the functions described herein (e.g., executing, by the processor 1102, instructions stored in the memory 1104). For example, the processor 1102 may support wireless communication at the UE 1100 in accordance with examples as disclosed herein. The UE 1100 may be configured to or operable to support a means for receiving a first message including data that indicates an authenticated encryption algorithm and an authenticated encryption mode associated with at least one of integrity protection or ciphering, verifying, based on the data, an integrity of the first message using the authenticated encryption algorithm, and transmitting, based on the integrity of the first message being verified, a second message, where the second message is associated with activation of at least one of the integrity protection or the ciphering based on the authenticated encryption mode. By receiving and verifying the first message using the authenticated encryption algorithm and transmitting the second message associated with activation of security protection, the UE 1100 enables improved security flexibility and enhanced interoperability during security establishment procedures, while reducing processing overhead by combining integrity protection and ciphering into a single cryptographic operation.

Additionally, the UE 1100 may be configured to or operable to support any one or combination of determining a security key based on one or more of an anchor key, an algorithm identifier associated with the authenticated encryption algorithm, the authenticated encryption mode, or a nonce value, where at least one of the integrity protection or the ciphering is based on the security key, and where the anchor key includes one of an AMF key, a radio anchor key, or a network key. By deriving the security key from the anchor key and other input parameters, the UE 1100 establishes consistent security parameters with the NE, which reduces the likelihood of deciphering and integrity verification failures. Additionally, or alternatively, the UE 1100 may be configured to or operable to support determining the nonce value based on at least one of a count value, a direction bit, a bearer identifier, or the algorithm identifier. By constructing the nonce value from parameters available at both the UE and the NE, the UE 1100 enables consistent input parameter usage without explicit nonce transmission, thereby reducing signaling overhead. Additionally, or alternatively, the UE 1100 may be configured to or operable to support the data includes the nonce value, and where the nonce value is based on at least one of a counter, a sequence number, a random value, time information, or the authenticated encryption mode. By receiving the nonce value in the data, the UE 1100 ensures uniqueness for each invocation of the authenticated encryption algorithm, which prevents replay attacks and enhances security. Additionally, or alternatively, the UE 1100 may be configured to or operable to support determining the nonce value based on at least one of a counter, a sequence number, a random value, time information, or the authenticated encryption mode, where the second message indicates the nonce value. By indicating the nonce value in the second message, the UE 1100 enables the NE to use the same nonce value for subsequent security operations, ensuring consistent cryptographic processing. Additionally, or alternatively, the UE 1100 may be configured to or operable to support the first message includes a first authentication tag, and where to verify the integrity of the first message, the UE 1100 may be configured to or operable to support generating, using the authenticated encryption algorithm, a second authentication tag based on the security key, the nonce value, and the data, where the integrity of the first message is verified based on the second authentication tag matching the first authentication tag. By generating and comparing authentication tags, the UE 1100 detects unauthorized modifications to the first message during transmission, thereby ensuring message authenticity and preventing man-in-the-middle attacks.

Additionally, or alternatively, the UE 1100 may be configured to or operable to support transmitting, prior to receiving the first message, a third message that indicates UE security capabilities including support for the authenticated encryption algorithm and one or more supported authenticated encryption modes, where the data is based on the UE security capabilities. By indicating UE security capabilities prior to receiving the first message, the UE 1100 enables the NE to select an authenticated encryption algorithm and mode that both entities support, thereby enhancing interoperability and ensuring successful security establishment. Additionally, or alternatively, the UE 1100 may be configured to or operable to support the authenticated encryption mode is associated with the integrity protection and the ciphering, and the UE 1100 may be configured to or operable to support obtaining, after the activation of the integrity protection and the ciphering, a first portion associated with a third message and a second portion associated with the third message, where the first portion includes sensitive information elements and the second portion includes non-sensitive information elements, generating, using the authenticated encryption algorithm, ciphertext based on a security key, a nonce value, the second portion as additional data for the integrity protection, the authenticated encryption mode, and the first portion as plaintext, generating, using the authenticated encryption algorithm, an authentication tag based on the security key, the nonce value, the additional data, the authenticated encryption mode, and the ciphertext, and transmitting the third message including at least the ciphertext, the second portion, and the authentication tag. By selectively applying ciphering to sensitive information elements while integrity protecting non-sensitive information elements, the UE 1100 reduces processing overhead while maintaining security levels for different message portions.

Additionally, or alternatively, the UE 1100 may be configured to or operable to support the authenticated encryption mode is associated with the integrity protection and the ciphering, and the UE 1100 may be configured to or operable to support receiving, after transmitting the second message, a third message including at least a ciphertext, a second portion of the third message, and a first authentication tag, where the third message is associated with a first portion including sensitive information elements, and where the second portion includes non-sensitive information elements, generating, using the authenticated encryption algorithm, a second authentication tag based on a security key, a nonce value, the second portion as additional data, the authenticated encryption mode, and the ciphertext, verifying an integrity of the third message based on the first authentication tag matching the second authentication tag, and obtaining, using the authenticated encryption algorithm, plaintext associated with the ciphertext based on the security key, the nonce value, the additional data, the authenticated encryption mode, and the ciphertext. By verifying integrity and decrypting the ciphertext in a single authenticated encryption operation, the UE 1100 achieves improved throughput and reduced latency compared to performing separate integrity verification and decryption operations.

Additionally, or alternatively, the UE 1100 may be configured to or operable to support the authenticated encryption mode is associated with the integrity protection, and the UE 1100 may be configured to or operable to support obtaining, after the activation of the integrity protection, additional data associated with a third message, generating, using the authenticated encryption algorithm, an authentication tag based on a security key, a nonce value, and the additional data, where a ciphertext associated with the authenticated encryption algorithm includes a null value based on the authenticated encryption mode, and transmitting the third message including at least the additional data and the authentication tag. By setting the ciphertext to a null value when integrity protection is implemented, the UE 1100 avoids increased ciphering operations, thereby reducing processing overhead for messages that do not implement confidentiality protection. Additionally, or alternatively, the UE 1100 may be configured to or operable to support the authenticated encryption mode is associated with the integrity protection, and the UE 1100 may be configured to or operable to support receiving, after transmitting the second message, a third message including at least additional data, a ciphertext including a null value, and a first authentication tag, generating, using the authenticated encryption algorithm, a second authentication tag based on a security key, a nonce value, the additional data, and the null value, verifying an integrity of the third message based on the first authentication tag matching the second authentication tag, and refraining from obtaining plaintext associated with the ciphertext based on the authenticated encryption mode. By refraining from decryption when the ciphertext includes a null value, the UE 1100 reduces processing overhead while still providing integrity verification for the received message.

Additionally, or alternatively, the UE 1100 may be configured to or operable to support the authenticated encryption mode is associated with the ciphering, and the UE 1100 may be configured to or operable to support obtaining, after the activation of the ciphering, plaintext associated with a third message, where the third message includes a null value corresponding to additional data, generating, using the authenticated encryption algorithm, a ciphertext associated with the plaintext based on a security key, the null value, a nonce value, and the authenticated encryption mode, and transmitting the third message including at least the ciphertext, where an authentication tag associated with the authenticated encryption algorithm includes the null value based on the authenticated encryption mode. By setting the authentication tag to a null value when ciphering is implemented, the UE 1100 provides confidentiality protection without the overhead of authentication tag generation, which may apply when message authenticity is established through other mechanisms. Additionally, or alternatively, the UE 1100 may be configured to or operable to support the authenticated encryption mode is associated with the ciphering, and the UE 1100 may be configured to or operable to support receiving, after transmitting the second message, a third message including at least a ciphertext and a null value corresponding to additional data, refraining from verifying an integrity of the third message based on the authenticated encryption mode, and obtaining, using the authenticated encryption algorithm, plaintext associated with the ciphertext based on a security key, a nonce value, the authenticated encryption mode, the null value as the additional data, and the ciphertext. By refraining from integrity verification when the authenticated encryption mode indicates ciphering, the UE 1100 reduces processing latency while still providing confidentiality protection for the received message.

Additionally, or alternatively, the UE 1100 may be configured to or operable to support the authenticated encryption mode is associated with the integrity protection and the ciphering, and the UE 1100 may be configured to or operable to support obtaining, after the activation of the integrity protection and the ciphering, plaintext associated with a third message, where the third message includes a null value corresponding to additional data, generating, using the authenticated encryption algorithm, a ciphertext associated with the plaintext based on the plaintext, a security key, a nonce value, the authenticated encryption mode, and the null value, generating, using the authenticated encryption algorithm, an authentication tag based on the security key, the nonce value, the null value, the authenticated encryption mode, and the ciphertext, and transmitting the third message including at least the ciphertext and the authentication tag. By performing combined ciphering and integrity protection in a single authenticated encryption operation, the UE 1100 achieves improved throughput and reduced latency compared to invoking separate ciphering and integrity protection algorithms. Additionally, or alternatively, the UE 1100 may be configured to or operable to support the authenticated encryption mode is associated with the integrity protection and the ciphering, and the UE 1100 may be configured to or operable to support receiving, after transmitting the second message, a third message including ciphertext and a first authentication tag, where the third message includes a null value corresponding to additional data, generating, using the authenticated encryption algorithm, a second authentication tag based on a security key, a nonce value, the null value, the authenticated encryption mode, and the ciphertext, verifying an integrity of the third message based on the first authentication tag matching the second authentication tag, and obtaining, using the authenticated encryption algorithm, plaintext associated with the ciphertext based on the security key, the nonce value, the authenticated encryption mode, the null value, and the ciphertext. By performing combined integrity verification and decryption in a single authenticated encryption operation, the UE 1100 provides both confidentiality and integrity protection with reduced processing overhead compared to separate cryptographic operations.

Additionally, or alternatively, the UE 1100 may be configured to or operable to support the first message includes at least one of an AS security mode command, a NAS security mode command, or an RRC connection reconfiguration message, and where the second message includes at least one of an AS security mode complete message, a NAS security mode complete message, or an RRC connection reconfiguration complete message. By supporting multiple message types for security establishment, the UE 1100 enables authenticated encryption to be applied across different protocol layers. Additionally, or alternatively, the UE 1100 may be configured to or operable to support the data includes one or more of a count value, a bearer identifier, a direction bit, a nonce value, or security context information. By including these parameters in the data, the UE 1100 enables consistent input parameter definitions between the UE and the NE, which reduces the likelihood of deciphering and integrity verification failures that may otherwise occur due to inconsistent input parameter definitions.

Additionally, or alternatively, the UE 1100 may support at least one memory (e.g., the memory 1104) and at least one processor (e.g., the processor 1102) coupled with the at least one memory and configured to cause the UE to receive a first message including data that indicates an authenticated encryption algorithm and an authenticated encryption mode associated with at least one of integrity protection or ciphering, verify, based on the data, an integrity of the first message using the authenticated encryption algorithm, and transmit, based on the integrity of the first message being verified, a second message, where the second message is associated with activation of at least one of the integrity protection or the ciphering based on the authenticated encryption mode.

Additionally, the UE 1100 may be configured to support any one or combination of to determine a security key based on one or more of an anchor key, an algorithm identifier associated with the authenticated encryption algorithm, the authenticated encryption mode, or a nonce value, where at least one of the integrity protection or the ciphering is based on the security key, and where the anchor key includes one of an AMF key, a radio anchor key, or a network key. Additionally, or alternatively, the UE 1100 may be configured to or operable to support to determine the nonce value based on at least one of a count value, a direction bit, a bearer identifier, or the algorithm identifier. Additionally, or alternatively, the UE 1100 may be configured to or operable to support the data includes the nonce value, and where the nonce value is based on at least one of a counter, a sequence number, a random value, time information, or the authenticated encryption mode. Additionally, or alternatively, the UE 1100 may be configured to or operable to support to determine the nonce value based on at least one of a counter, a sequence number, a random value, time information, or the authenticated encryption mode, where the second message indicates the nonce value. Additionally, or alternatively, the UE 1100 may be configured to or operable to support the first message includes a first authentication tag, and where to verify the integrity of the first message, the UE 1100 may be configured to or operable to support to generate, using the authenticated encryption algorithm, a second authentication tag based on the security key, the nonce value, and the data, where the integrity of the first message is verified based on the second authentication tag matching the first authentication tag.

Additionally, or alternatively, the UE 1100 may be configured to or operable to support to transmit, prior to receiving the first message, a third message that indicates UE security capabilities including support for the authenticated encryption algorithm and one or more supported authenticated encryption modes, where the data is based on the UE security capabilities. Additionally, or alternatively, the UE 1100 may be configured to or operable to support the authenticated encryption mode is associated with the integrity protection and the ciphering, and the UE 1100 may be configured to or operable to support to obtain, after the activation of the integrity protection and the ciphering, a first portion associated with a third message and a second portion associated with the third message, where the first portion includes sensitive information elements and the second portion includes non-sensitive information elements, generate, using the authenticated encryption algorithm, ciphertext based on a security key, a nonce value, the second portion as additional data for the integrity protection, the authenticated encryption mode, and the first portion as plaintext, generate, using the authenticated encryption algorithm, an authentication tag based on the security key, the nonce value, the additional data, the authenticated encryption mode, and the ciphertext, and transmit the third message including at least the ciphertext, the second portion, and the authentication tag.

Additionally, or alternatively, the UE 1100 may be configured to or operable to support the authenticated encryption mode is associated with the integrity protection and the ciphering, and the UE 1100 may be configured to or operable to support to receive, after transmitting the second message, a third message including at least a ciphertext, a second portion of the third message, and a first authentication tag, where the third message is associated with a first portion including sensitive information elements, and where the second portion includes non-sensitive information elements, generate, using the authenticated encryption algorithm, a second authentication tag based on a security key, a nonce value, the second portion as additional data, the authenticated encryption mode, and the ciphertext, verify an integrity of the third message based on the first authentication tag matching the second authentication tag, and obtain, using the authenticated encryption algorithm, plaintext associated with the ciphertext based on the security key, the nonce value, the additional data, the authenticated encryption mode, and the ciphertext.

Additionally, or alternatively, the UE 1100 may be configured to or operable to support the authenticated encryption mode is associated with the integrity protection, and the UE 1100 may be configured to or operable to support to obtain, after the activation of the integrity protection, additional data associated with a third message, generate, using the authenticated encryption algorithm, an authentication tag based on a security key, a nonce value, and the additional data, where a ciphertext associated with the authenticated encryption algorithm includes a null value based on the authenticated encryption mode, and transmit the third message including at least the additional data and the authentication tag. Additionally, or alternatively, the UE 1100 may be configured to or operable to support the authenticated encryption mode is associated with the integrity protection, and the UE 1100 may be configured to or operable to support to receive, after transmitting the second message, a third message including at least additional data, a ciphertext including a null value, and a first authentication tag, generate, using the authenticated encryption algorithm, a second authentication tag based on a security key, a nonce value, the additional data, and the null value, verify an integrity of the third message based on the first authentication tag matching the second authentication tag, and refrain from obtaining plaintext associated with the ciphertext based on the authenticated encryption mode.

Additionally, or alternatively, the UE 1100 may be configured to or operable to support the authenticated encryption mode is associated with the ciphering, and the UE 1100 may be configured to or operable to support to obtain, after the activation of the ciphering, plaintext associated with a third message, where the third message includes a null value corresponding to additional data, generate, using the authenticated encryption algorithm, a ciphertext associated with the plaintext based on a security key, the null value, a nonce value, and the authenticated encryption mode, and transmit the third message including at least the ciphertext, where an authentication tag associated with the authenticated encryption algorithm includes the null value based on the authenticated encryption mode. Additionally, or alternatively, the UE 1100 may be configured to or operable to support the authenticated encryption mode is associated with the ciphering, and the UE 1100 may be configured to or operable to support to receive, after transmitting the second message, a third message including at least a ciphertext and a null value corresponding to additional data, refrain from verifying an integrity of the third message based on the authenticated encryption mode, and obtain, using the authenticated encryption algorithm, plaintext associated with the ciphertext based on a security key, a nonce value, the authenticated encryption mode, the null value as the additional data, and the ciphertext.

Additionally, or alternatively, the UE 1100 may be configured to or operable to support the authenticated encryption mode is associated with the integrity protection and the ciphering, and the UE 1100 may be configured to or operable to support to obtain, after the activation of the integrity protection and the ciphering, plaintext associated with a third message, where the third message includes a null value corresponding to additional data, generate, using the authenticated encryption algorithm, a ciphertext associated with the plaintext based on the plaintext, a security key, a nonce value, the authenticated encryption mode, and the null value, generate, using the authenticated encryption algorithm, an authentication tag based on the security key, the nonce value, the null value, the authenticated encryption mode, and the ciphertext, and transmit the third message including at least the ciphertext and the authentication tag. Additionally, or alternatively, the UE 1100 may be configured to or operable to support the authenticated encryption mode is associated with the integrity protection and the ciphering, and the UE 1100 may be configured to or operable to support to receive, after transmitting the second message, a third message including ciphertext and a first authentication tag, where the third message includes a null value corresponding to additional data, generate, using the authenticated encryption algorithm, a second authentication tag based on a security key, a nonce value, the null value, the authenticated encryption mode, and the ciphertext, verify an integrity of the third message based on the first authentication tag matching the second authentication tag, and obtain, using the authenticated encryption algorithm, plaintext associated with the ciphertext based on the security key, the nonce value, the authenticated encryption mode, the null value, and the ciphertext.

Additionally, or alternatively, the UE 1100 may be configured to or operable to support the first message includes at least one of an AS security mode command, a NAS security mode command, or an RRC connection reconfiguration message, and where the second message includes at least one of an AS security mode complete message, a NAS security mode complete message, or an RRC connection reconfiguration complete message. Additionally, or alternatively, the UE 1100 may be configured to or operable to support the data includes one or more of a count value, a bearer identifier, a direction bit, a nonce value, or security context information.

The controller 1106 may manage input and output signals for the UE 1100. The controller 1106 may also manage peripherals not integrated into the UE 1100. In some implementations, the controller 1106 may utilize an operating system such as iOS®, Android®, Windows®, or other operating systems. In some implementations, the controller 1106 may be implemented as part of the processor 1102.

In some implementations, the UE 1100 may include at least one transceiver 1108. In some other implementations, the UE 1100 may have more than one transceiver 1108. The transceiver 1108 may represent a wireless transceiver. The transceiver 1108 may include one or more receiver chains 1110, one or more transmitter chains 1112, or a combination thereof.

A receiver chain 1110 may be configured to receive signals (e.g., control information, data, packets) over a wireless medium. For example, the receiver chain 1110 may include one or more antennas to receive a signal over the air or a wireless medium. The receiver chain 1110 may include at least one amplifier (e.g., a low-noise amplifier (LNA)) configured to amplify the received signal. The receiver chain 1110 may include at least one demodulator configured to demodulate the received signal and obtain the transmitted data by reversing the modulation technique applied during transmission of the signal. The receiver chain 1110 may include at least one decoder for decoding the demodulated signal to receive the transmitted data.

A transmitter chain 1112 may be configured to generate and transmit signals (e.g., control information, data, packets). The transmitter chain 1112 may include at least one modulator for modulating data onto a carrier signal, preparing the signal for transmission over a wireless medium. The at least one modulator may be configured to support one or more techniques such as amplitude modulation (AM), frequency modulation (FM), or digital modulation schemes like phase-shift keying (PSK) or quadrature AM (QAM). The transmitter chain 1112 may also include at least one power amplifier configured to amplify the modulated signal to an appropriate power level suitable for transmission over the wireless medium. The transmitter chain 1112 may also include one or more antennas for transmitting the amplified signal into the air or the wireless medium.

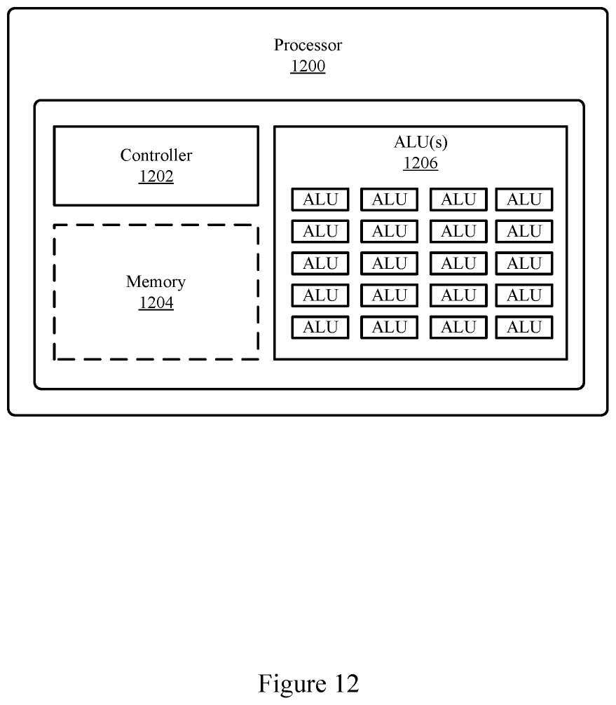

FIG. 12 illustrates an example of a processor 1200 in accordance with aspects of the present disclosure. The processor 1200 may be an example of a processor configured to perform various operations in accordance with examples as described herein. The processor 1200 may include a controller 1202 configured to perform various operations in accordance with examples as described herein. The processor 1200 may optionally include at least one memory 1204, which may be, for example, an L1/L2/L3 cache. Additionally, or alternatively, the processor 1200 may optionally include one or more arithmetic-logic units (ALUs) 1206. One or more of these components may be in electronic communication or otherwise coupled (e.g., operatively, communicatively, functionally, electronically, electrically) via one or more interfaces (e.g., buses).

The processor 1200 may be a processor chipset and include a protocol stack (e.g., a software stack) executed by the processor chipset to perform various operations (e.g., receiving, obtaining, retrieving, transmitting, outputting, forwarding, storing, determining, identifying, accessing, writing, reading) in accordance with examples as described herein. The processor chipset may include one or more cores, one or more caches (e.g., memory local to or included in the processor chipset (e.g., the processor 1200) or other memory (e.g., random access memory (RAM), read-only memory (ROM), dynamic RAM (DRAM), synchronous dynamic RAM (SDRAM), static RAM (SRAM), ferroelectric RAM (FeRAM), magnetic RAM (MRAM), resistive RAM (RRAM), flash memory, phase change memory (PCM), and others).

The controller 1202 may be configured to manage and coordinate various operations (e.g., signaling, receiving, obtaining, retrieving, transmitting, outputting, forwarding, storing, determining, identifying, accessing, writing, reading) of the processor 1200 to cause the processor 1200 to support various operations in accordance with examples as described herein. For example, the controller 1202 may operate as a control unit of the processor 1200, generating control signals that manage the operation of various components of the processor 1200. These control signals include enabling or disabling functional units, selecting data paths, initiating memory access, and coordinating timing of operations.

The controller 1202 may be configured to fetch (e.g., obtain, retrieve, receive) instructions from the memory 1204 and determine subsequent instruction(s) to be executed to cause the processor 1200 to support various operations in accordance with examples as described herein. The controller 1202 may be configured to track memory addresses of instructions associated with the memory 1204. The controller 1202 may be configured to decode instructions to determine the operation to be performed and the operands involved. For example, the controller 1202 may be configured to interpret the instruction and determine control signals to be output to other components of the processor 1200 to cause the processor 1200 to support various operations in accordance with examples as described herein. Additionally, or alternatively, the controller 1202 may be configured to manage the flow of data within the processor 1200. The controller 1202 may be configured to control the transfer of data between registers, ALUs 1206, and other functional units of the processor 1200.

The memory 1204 may include one or more caches (e.g., memory local to or included in the processor 1200 or other memory, such as RAM, ROM, DRAM, SDRAM, SRAM, MRAM, flash memory, etc.). In some implementations, the memory 1204 may reside within or on a processor chipset (e.g., local to the processor 1200). In some other implementations, the memory 1204 may reside external to the processor chipset (e.g., remote to the processor 1200).

The memory 1204 may store computer-readable, computer-executable code including instructions that, when executed by the processor 1200, cause the processor 1200 to perform various functions described herein. The code may be stored in a non-transitory computer-readable medium such as system memory or another type of memory. The controller 1202 and/or the processor 1200 may be configured to execute computer-readable instructions stored in the memory 1204 to cause the processor 1200 to perform various functions. For example, the processor 1200 and/or the controller 1202 may be coupled with or to the memory 1204, the processor 1200, and the controller 1202, and may be configured to perform various functions described herein. In some examples, the processor 1200 may include multiple processors and the memory 1204 may include multiple memories. One or more of the multiple processors may be coupled with one or more of the multiple memories, which may, individually or collectively, be configured to perform various functions herein.

The one or more ALUs 1206 may be configured to support various operations in accordance with examples as described herein. In some implementations, the one or more ALUs 1206 may reside within or on a processor chipset (e.g., the processor 1200). In some other implementations, the one or more ALUs 1206 may reside external to the processor chipset (e.g., the processor 1200). One or more ALUs 1206 may perform one or more computations such as addition, subtraction, multiplication, and division on data. For example, one or more ALUs 1206 may receive input operands and an operation code, which determines an operation to be executed. One or more ALUs 1206 may be configured with a variety of logical and arithmetic circuits, including adders, subtractors, shifters, and logic gates, to process and manipulate the data according to the operation. Additionally, or alternatively, the one or more ALUs 1206 may support logical operations such as AND, OR, exclusive-OR (XOR), not-OR (NOR), and not-AND (NAND), enabling the one or more ALUs 1206 to handle conditional operations, comparisons, and bitwise operations.

The processor 1200 may support wireless communication in accordance with examples as disclosed herein. The processor 1200 may be configured to or operable to support at least one controller (e.g., the controller 1202) coupled with at least one memory (e.g., the memory 1204) and configured to cause the processor to receive a first message including data that indicates an authenticated encryption algorithm and an authenticated encryption mode associated with at least one of integrity protection or ciphering, verify, based on the data, an integrity of the first message using the authenticated encryption algorithm, and transmit, based on the integrity of the first message being verified, a second message, where the second message is associated with activation of at least one of the integrity protection or the ciphering based on the authenticated encryption mode. By receiving and verifying the first message using the authenticated encryption algorithm and transmitting the second message associated with activation of security protection, the processor 1200 enables improved security flexibility and enhanced interoperability during security establishment procedures, while reducing processing overhead by combining integrity protection and ciphering into a single cryptographic operation.

Additionally, the processor 1200 may be configured to or operable to support any one or combination of to determine a security key based on one or more of an anchor key, an algorithm identifier associated with the authenticated encryption algorithm, the authenticated encryption mode, or a nonce value, where at least one of the integrity protection or the ciphering is based on the security key, and where the anchor key includes one of an AMF key, a radio anchor key, or a network key. By deriving the security key from the anchor key and other input parameters, the processor 1200 establishes consistent security parameters with the NE, which reduces the likelihood of deciphering and integrity verification failures. Additionally, or alternatively, the processor 1200 may be configured to or operable to support to determine the nonce value based on at least one of a count value, a direction bit, a bearer identifier, or the algorithm identifier. By constructing the nonce value from parameters available at both the UE and the NE, the processor 1200 enables consistent input parameter usage without explicit nonce transmission, thereby reducing signaling overhead. Additionally, or alternatively, the processor 1200 may be configured to or operable to support the data includes the nonce value, and where the nonce value is based on at least one of a counter, a sequence number, a random value, time information, or the authenticated encryption mode. By receiving the nonce value in the data, the processor 1200 ensures uniqueness for each invocation of the authenticated encryption algorithm, which prevents replay attacks and enhances security. Additionally, or alternatively, the processor 1200 may be configured to or operable to support to determine the nonce value based on at least one of a counter, a sequence number, a random value, time information, or the authenticated encryption mode, where the second message indicates the nonce value. By indicating the nonce value in the second message, the processor 1200 enables the NE to use the same nonce value for subsequent security operations, ensuring consistent cryptographic processing.

Additionally, or alternatively, the processor 1200 may be configured to or operable to support the first message includes a first authentication tag, and where to verify the integrity of the first message, the processor 1200 may be configured to or operable to support to generate, using the authenticated encryption algorithm, a second authentication tag based on the security key, the nonce value, and the data, where the integrity of the first message is verified based on the second authentication tag matching the first authentication tag. By generating and comparing authentication tags, the processor 1200 detects unauthorized modifications to the first message during transmission, thereby ensuring message authenticity and preventing man-in-the-middle attacks. Additionally, or alternatively, the processor 1200 may be configured to or operable to support to transmit, prior to receiving the first message, a third message that indicates UE security capabilities including support for the authenticated encryption algorithm and one or more supported authenticated encryption modes, where the data is based on the UE security capabilities. By indicating UE security capabilities prior to receiving the first message, the processor 1200 enables the NE to select an authenticated encryption algorithm and mode that both entities support, thereby enhancing interoperability and ensuring successful security establishment.

Additionally, or alternatively, the processor 1200 may be configured to or operable to support the authenticated encryption mode is associated with the integrity protection and the ciphering, and the processor 1200 may be configured to or operable to support to obtain, after the activation of the integrity protection and the ciphering, a first portion associated with a third message and a second portion associated with the third message, where the first portion includes sensitive information elements and the second portion includes non-sensitive information elements, generate, using the authenticated encryption algorithm, ciphertext based on a security key, a nonce value, the second portion as additional data for the integrity protection, the authenticated encryption mode, and the first portion as plaintext, generate, using the authenticated encryption algorithm, an authentication tag based on the security key, the nonce value, the additional data, the authenticated encryption mode, and the ciphertext, and transmit the third message including at least the ciphertext, the second portion, and the authentication tag. By selectively applying ciphering to sensitive information elements while integrity protecting non-sensitive information elements, the processor 1200 reduces processing overhead while maintaining security levels for different message portions.

Additionally, or alternatively, the processor 1200 may be configured to or operable to support the authenticated encryption mode is associated with the integrity protection and the ciphering, and the processor 1200 may be configured to or operable to support to receive, after transmitting the second message, a third message including at least a ciphertext, a second portion of the third message, and a first authentication tag, where the third message is associated with a first portion including sensitive information elements, and where the second portion includes non-sensitive information elements, generate, using the authenticated encryption algorithm, a second authentication tag based on a security key, a nonce value, the second portion as additional data, the authenticated encryption mode, and the ciphertext, verify an integrity of the third message based on the first authentication tag matching the second authentication tag, and obtain, using the authenticated encryption algorithm, plaintext associated with the ciphertext based on the security key, the nonce value, the additional data, the authenticated encryption mode, and the ciphertext. By verifying integrity and decrypting the ciphertext in a single authenticated encryption operation, the processor 1200 achieves improved throughput and reduced latency compared to performing separate integrity verification and decryption operations. Additionally, or alternatively, the processor 1200 may be configured to or operable to support the authenticated encryption mode is associated with the integrity protection, and the processor 1200 may be configured to or operable to support to obtain, after the activation of the integrity protection, additional data associated with a third message, generate, using the authenticated encryption algorithm, an authentication tag based on a security key, a nonce value, and the additional data, where a ciphertext associated with the authenticated encryption algorithm includes a null value based on the authenticated encryption mode, and transmit the third message including at least the additional data and the authentication tag. By setting the ciphertext to a null value when integrity protection is implemented, the processor 1200 avoids increased ciphering operations, thereby reducing processing overhead for messages that do not implement confidentiality protection.

Additionally, or alternatively, the processor 1200 may be configured to or operable to support the authenticated encryption mode is associated with the integrity protection, and the processor 1200 may be configured to or operable to support to receive, after transmitting the second message, a third message including at least additional data, a ciphertext including a null value, and a first authentication tag, generate, using the authenticated encryption algorithm, a second authentication tag based on a security key, a nonce value, the additional data, and the null value, verify an integrity of the third message based on the first authentication tag matching the second authentication tag, and refrain from obtaining plaintext associated with the ciphertext based on the authenticated encryption mode. By refraining from decryption when the ciphertext includes a null value, the processor 1200 reduces processing overhead while still providing integrity verification for the received message. Additionally, or alternatively, the processor 1200 may be configured to or operable to support the authenticated encryption mode is associated with the ciphering, and the processor 1200 may be configured to or operable to support to obtain, after the activation of the ciphering, plaintext associated with a third message, where the third message includes a null value corresponding to additional data, generate, using the authenticated encryption algorithm, a ciphertext associated with the plaintext based on a security key, the null value, a nonce value, and the authenticated encryption mode, and transmit the third message including at least the ciphertext, where an authentication tag associated with the authenticated encryption algorithm includes the null value based on the authenticated encryption mode. By setting the authentication tag to a null value when ciphering is implemented, the processor 1200 provides confidentiality protection without the overhead of authentication tag generation, which may apply when message authenticity is established through other mechanisms.

Additionally, or alternatively, the processor 1200 may be configured to or operable to support the authenticated encryption mode is associated with the ciphering, and the processor 1200 may be configured to or operable to support to receive, after transmitting the second message, a third message including at least a ciphertext and a null value corresponding to additional data, refrain from verifying an integrity of the third message based on the authenticated encryption mode, and obtain, using the authenticated encryption algorithm, plaintext associated with the ciphertext based on a security key, a nonce value, the authenticated encryption mode, the null value as the additional data, and the ciphertext. By refraining from integrity verification when the authenticated encryption mode indicates ciphering, the processor 1200 reduces processing latency while still providing confidentiality protection for the received message. Additionally, or alternatively, the processor 1200 may be configured to or operable to support the authenticated encryption mode is associated with the integrity protection and the ciphering, and the processor 1200 may be configured to or operable to support to obtain, after the activation of the integrity protection and the ciphering, plaintext associated with a third message, where the third message includes a null value corresponding to additional data, generate, using the authenticated encryption algorithm, a ciphertext associated with the plaintext based on the plaintext, a security key, a nonce value, the authenticated encryption mode, and the null value, generate, using the authenticated encryption algorithm, an authentication tag based on the security key, the nonce value, the null value, the authenticated encryption mode, and the ciphertext, and transmit the third message including at least the ciphertext and the authentication tag. By performing combined ciphering and integrity protection in a single authenticated encryption operation, the processor 1200 achieves improved throughput and reduced latency compared to invoking separate ciphering and integrity protection algorithms.

Additionally, or alternatively, the processor 1200 may be configured to or operable to support the authenticated encryption mode is associated with the integrity protection and the ciphering, and the processor 1200 may be configured to or operable to support to receive, after transmitting the second message, a third message including ciphertext and a first authentication tag, where the third message includes a null value corresponding to additional data, generate, using the authenticated encryption algorithm, a second authentication tag based on a security key, a nonce value, the null value, the authenticated encryption mode, and the ciphertext, verify an integrity of the third message based on the first authentication tag matching the second authentication tag, and obtain, using the authenticated encryption algorithm, plaintext associated with the ciphertext based on the security key, the nonce value, the authenticated encryption mode, the null value, and the ciphertext. By performing combined integrity verification and decryption in a single authenticated encryption operation, the processor 1200 provides both confidentiality and integrity protection with reduced processing overhead compared to separate cryptographic operations. Additionally, or alternatively, the processor 1200 may be configured to or operable to support the first message includes at least one of an AS security mode command, a NAS security mode command, or an RRC connection reconfiguration message, and where the second message includes at least one of an AS security mode complete message, a NAS security mode complete message, or an RRC connection reconfiguration complete message. By supporting multiple message types for security establishment, the processor 1200 enables authenticated encryption to be applied across different protocol layers. Additionally, or alternatively, the processor 1200 may be configured to or operable to support the data includes one or more of a count value, a bearer identifier, a direction bit, a nonce value, or security context information. By including these parameters in the data, the processor 1200 enables consistent input parameter definitions between the UE and the NE, which reduces the likelihood of deciphering and integrity verification failures that may otherwise occur due to inconsistent input parameter definitions.

The processor 1200 may be configured to or operable to support at least one controller (e.g., the controller 1202) coupled with at least one memory (e.g., the memory 1204) and configured to cause the processor to transmit a first message including data that indicates an authenticated encryption algorithm and an authenticated encryption mode associated with at least one of integrity protection or ciphering, and receive a second message based on the authenticated encryption mode and an integrity of the first message, where the second message is associated with activation of at least one of the integrity protection or the ciphering. By transmitting the first message indicating the authenticated encryption algorithm and mode and receiving the second message associated with activation of security protection, the processor 1200 enables efficient security establishment with configurable modes that reduce processing overhead and enhance interoperability between communicating entities.

Additionally, the processor 1200 may be configured to or operable to support any one or combination of to determine a security key based on one or more of an anchor key, an algorithm identifier associated with the authenticated encryption algorithm, the authenticated encryption mode, or a nonce value, where at least one of the integrity protection or the ciphering is based on the security key, and where the anchor key includes one of an AMF key, a radio anchor key, or a network key. By deriving the security key from the anchor key and other input parameters, the processor 1200 establishes consistent security parameters with the UE, which reduces the likelihood of deciphering and integrity verification failures. Additionally, or alternatively, the processor 1200 may be configured to or operable to support to determine the nonce value based on at least one of a count value, a direction bit, a bearer identifier, or the algorithm identifier. By constructing the nonce value from parameters available at both the NE and the UE, the processor 1200 enables consistent input parameter usage without explicit nonce transmission, thereby reducing signaling overhead. Additionally, or alternatively, the processor 1200 may be configured to or operable to support the second message includes the nonce value, and where the nonce value is based on at least one of a counter, a sequence number, a random value, time information, or the authenticated encryption mode. By receiving the nonce value in the second message, the processor 1200 ensures that both entities use the same nonce value for subsequent security operations, enabling consistent cryptographic processing. Additionally, or alternatively, the processor 1200 may be configured to or operable to support to determine the nonce value based on at least one of a counter, a sequence number, a random value, time information, or the authenticated encryption mode, where the data indicates the nonce value. By indicating the nonce value in the data, the processor 1200 enables the UE to use the same nonce value for integrity verification and subsequent security operations, ensuring uniqueness for each invocation of the authenticated encryption algorithm. Additionally, or alternatively, the processor 1200 may be configured to or operable to support to receive, prior to transmitting the first message, a third message that indicates UE security capabilities including support for the authenticated encryption algorithm and one or more supported authenticated encryption modes, where the data is based on the UE security capabilities. By receiving UE security capabilities prior to transmitting the first message, the processor 1200 enables selection of an authenticated encryption algorithm and mode that both entities support, thereby enhancing interoperability and ensuring successful security establishment.

Additionally, or alternatively, the processor 1200 may be configured to or operable to support the authenticated encryption mode is associated with the integrity protection and the ciphering, and the processor 1200 may be configured to or operable to support to obtain, after the activation of the integrity protection and the ciphering, a first portion associated with a third message and a second portion associated with the third message, where the first portion includes sensitive information elements and the second portion includes non-sensitive information elements, generate, using the authenticated encryption algorithm, ciphertext based on a security key, a nonce value, the second portion as additional data for the integrity protection, the authenticated encryption mode, and the first portion as plaintext, generate, using the authenticated encryption algorithm, an authentication tag based on the security key, the nonce value, the additional data, the authenticated encryption mode, and the ciphertext, and transmit the third message including at least the ciphertext, the second portion, and the authentication tag. By selectively applying ciphering to sensitive information elements while integrity protecting non-sensitive information elements, the processor 1200 reduces processing overhead while maintaining security levels for different message portions. Additionally, or alternatively, the processor 1200 may be configured to or operable to support the authenticated encryption mode is associated with the integrity protection and the ciphering, and the processor 1200 may be configured to or operable to support to receive, after receiving the second message, a third message including at least a ciphertext, a second portion of the third message, and a first authentication tag, where the third message is associated with a first portion including sensitive information elements, and where the second portion includes non-sensitive information elements, generate, using the authenticated encryption algorithm, a second authentication tag based on a security key, a nonce value, the second portion as additional data, the authenticated encryption mode, and the ciphertext, verify an integrity of the third message based on the first authentication tag matching the second authentication tag, and obtain, using the authenticated encryption algorithm, plaintext associated with the ciphertext based on the security key, the nonce value, the additional data, the authenticated encryption mode, and the ciphertext. By verifying integrity and decrypting the ciphertext in a single authenticated encryption operation, the processor 1200 achieves improved throughput and reduced latency compared to performing separate integrity verification and decryption operations.

Additionally, or alternatively, the processor 1200 may be configured to or operable to support the authenticated encryption mode is associated with the integrity protection, and the processor 1200 may be configured to or operable to support to obtain, after the activation of the integrity protection, additional data associated with a third message, generate, using the authenticated encryption algorithm, an authentication tag based on a security key, a nonce value, and the additional data, where a ciphertext associated with the authenticated encryption algorithm includes a null value based on the authenticated encryption mode, and transmit the third message including at least the additional data and the authentication tag. By setting the ciphertext to a null value when integrity protection is implemented, the processor 1200 avoids increased ciphering operations, thereby reducing processing overhead for messages that do not implement confidentiality protection. Additionally, or alternatively, the processor 1200 may be configured to or operable to support the authenticated encryption mode is associated with the integrity protection, and the processor 1200 may be configured to or operable to support to receive, after receiving the second message, a third message including at least additional data, a ciphertext including a null value, and a first authentication tag, generate, using the authenticated encryption algorithm, a second authentication tag based on a security key, a nonce value, the additional data, and the null value, verify an integrity of the third message based on the first authentication tag matching the second authentication tag, and refrain from obtaining plaintext associated with the ciphertext based on the authenticated encryption mode. By refraining from decryption when the ciphertext includes a null value, the processor 1200 reduces processing overhead while still providing integrity verification for the received message.

Additionally, or alternatively, the processor 1200 may be configured to or operable to support the authenticated encryption mode is associated with the ciphering, and the processor 1200 may be configured to or operable to support to obtain, after the activation of the ciphering, plaintext associated with a third message, where the third message includes a null value corresponding to additional data, generate, using the authenticated encryption algorithm, a ciphertext associated with the plaintext based on a security key, the null value, a nonce value, and the authenticated encryption mode, and transmit the third message including at least the ciphertext, where an authentication tag associated with the authenticated encryption algorithm includes the null value based on the authenticated encryption mode. By setting the authentication tag to a null value when ciphering is implemented, the processor 1200 provides confidentiality protection without the overhead of authentication tag generation, which may apply when message authenticity is established through other mechanisms. Additionally, or alternatively, the processor 1200 may be configured to or operable to support the authenticated encryption mode is associated with the ciphering, and the processor 1200 may be configured to or operable to support to receive, after receiving the second message, a third message including at least a ciphertext and a null value corresponding to additional data, refrain from verifying an integrity of the third message based on the authenticated encryption mode, and obtain, using the authenticated encryption algorithm, plaintext associated with the ciphertext based on a security key, a nonce value, the authenticated encryption mode, the null value as the additional data, and the ciphertext. By refraining from integrity verification when the authenticated encryption mode indicates ciphering, the processor 1200 reduces processing latency while still providing confidentiality protection for the received message.

Additionally, or alternatively, the processor 1200 may be configured to or operable to support the authenticated encryption mode is associated with the integrity protection and the ciphering, and the processor 1200 may be configured to or operable to support to obtain, after the activation of the integrity protection and the ciphering, plaintext associated with a third message, where the third message includes a null value corresponding to additional data, generate, using the authenticated encryption algorithm, a ciphertext associated with the plaintext based on the plaintext, a security key, a nonce value, the authenticated encryption mode, and the null value, generate, using the authenticated encryption algorithm, an authentication tag based on the security key, the nonce value, the null value, the authenticated encryption mode, and the ciphertext, and transmit the third message including at least the ciphertext and the authentication tag. By performing combined ciphering and integrity protection in a single authenticated encryption operation, the processor 1200 achieves improved throughput and reduced latency compared to invoking separate ciphering and integrity protection algorithms. Additionally, or alternatively, the processor 1200 may be configured to or operable to support the authenticated encryption mode is associated with the integrity protection and the ciphering, and the processor 1200 may be configured to or operable to support to receive, after receiving the second message, a third message including ciphertext and a first authentication tag, where the third message includes a null value corresponding to additional data, generate, using the authenticated encryption algorithm, a second authentication tag based on a security key, a nonce value, the null value, the authenticated encryption mode, and the ciphertext, verify an integrity of the third message based on the first authentication tag matching the second authentication tag, and obtain, using the authenticated encryption algorithm, plaintext associated with the ciphertext based on the security key, the nonce value, the authenticated encryption mode, the null value, and the ciphertext. By performing combined integrity verification and decryption in a single authenticated encryption operation, the processor 1200 provides both confidentiality and integrity protection with reduced processing overhead compared to separate cryptographic operations.

Additionally, or alternatively, the processor 1200 may be configured to or operable to support the first message includes at least one of an AS security mode command, a NAS security mode command, or an RRC connection reconfiguration message, and where the second message includes at least one of an AS security mode complete message, a NAS security mode complete message, or an RRC connection reconfiguration complete message. By supporting multiple message types for security establishment, the processor 1200 enables authenticated encryption to be applied across different protocol layers. Additionally, or alternatively, the processor 1200 may be configured to or operable to support the data includes one or more of a count value, a bearer identifier, a direction bit, a nonce value, or security context information. By including these parameters in the data, the processor 1200 enables consistent input parameter definitions between the NE and the UE, which reduces the likelihood of deciphering and integrity verification failures that may otherwise occur due to inconsistent input parameter definitions.

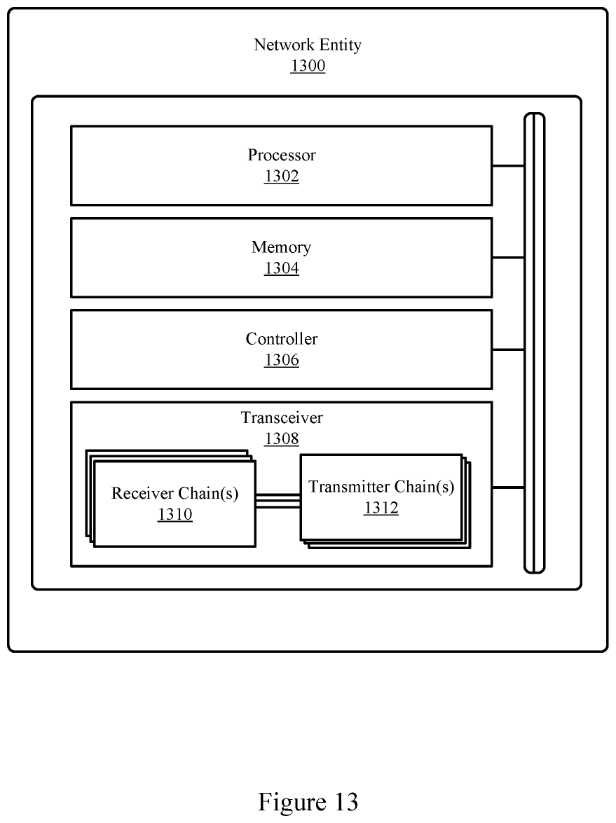

FIG. 13 illustrates an example of an NE 1300 in accordance with aspects of the present disclosure. The NE 1300 may include a processor 1302, a memory 1304, a controller 1306, and a transceiver 1308. The processor 1302, the memory 1304, the controller 1306, or the transceiver 1308, or various combinations thereof or various components thereof, may be examples of means for performing various aspects of the present disclosure as described herein. These components may be coupled (e.g., operatively, communicatively, functionally, electronically, electrically) via one or more interfaces.

The processor 1302, the memory 1304, the controller 1306, or the transceiver 1308, or various combinations or components thereof, may be implemented in hardware (e.g., circuitry). The hardware may include a processor, a DSP, an ASIC, or other programmable logic device, or any combination thereof, configured as or otherwise supporting a means for performing the functions described in the present disclosure.

The processor 1302 may include an intelligent hardware device (e.g., a general-purpose processor, a DSP, a CPU, an ASIC, an FPGA, or any combination thereof). In some implementations, the processor 1302 may be configured to operate the memory 1304. In some other implementations, the memory 1304 may be integrated into the processor 1302. The processor 1302 may be configured to execute computer-readable instructions stored in the memory 1304 to cause the NE 1300 to perform various functions of the present disclosure.

The memory 1304 may include volatile or non-volatile memory. The memory 1304 may store computer-readable, computer-executable code, including instructions that, when executed by the processor 1302, cause the NE 1300 to perform various functions described herein. The code may be stored in a non-transitory computer-readable medium, such as the memory 1304 or another type of memory. Computer-readable media include both non-transitory computer storage media and communication media, including any medium that facilitates transfer of a computer program from one place to another. A non-transitory storage medium may be any available medium that may be accessed by a general-purpose or special-purpose computer.

In some implementations, the processor 1302 and the memory 1304, coupled with the processor 1302, may be configured to cause the NE 1300 to perform one or more of the functions described herein (e.g., executing, by the processor 1302, instructions stored in the memory 1304). For example, the processor 1302 may support wireless communication at the NE 1300 in accordance with examples as disclosed herein. The NE 1300 may be configured to or operable to support a means for transmitting a first message, including data that indicates an authenticated encryption algorithm and an authenticated encryption mode associated with at least one of integrity protection or ciphering, and receiving a second message based on the authenticated encryption mode and an integrity of the first message, where the second message is associated with activation of at least one of the integrity protection or the ciphering. By transmitting the first message indicating the authenticated encryption algorithm and mode, and receiving the second message associated with activation of security protection, the NE 1300 enables efficient security establishment with configurable modes that reduce processing overhead and enhance interoperability between communicating entities.

Additionally, the NE 1300 may be configured to or operable to support any one or combination of to determine a security key based on one or more of an anchor key, an algorithm identifier associated with the authenticated encryption algorithm, the authenticated encryption mode, or a nonce value, where at least one of the integrity protection or the ciphering is based on the security key, and where the anchor key includes one of an AMF key, a radio anchor key, or a network key. By deriving the security key from the anchor key and other input parameters, the NE 1300 establishes consistent security parameters with the UE, which reduces the likelihood of deciphering and integrity verification failures. Additionally, or alternatively, the NE 1300 may be configured to or operable to support to determine the nonce value based on at least one of a count value, a direction bit, a bearer identifier, or the algorithm identifier. By constructing the nonce value from parameters available at both the NE and the UE, the NE 1300 enables consistent input parameter usage without explicit nonce transmission, thereby reducing signaling overhead. Additionally, or alternatively, the NE 1300 may be configured to or operable to support the second message includes the nonce value, and where the nonce value is based on at least one of a counter, a sequence number, a random value, time information, or the authenticated encryption mode. By receiving the nonce value in the second message, the NE 1300 ensures that both entities use the same nonce value for subsequent security operations, enabling consistent cryptographic processing. Additionally, or alternatively, the NE 1300 may be configured to or operable to support to determine the nonce value based on at least one of a counter, a sequence number, a random value, time information, or the authenticated encryption mode, where the data indicates the nonce value. By indicating the nonce value in the data, the NE 1300 enables the UE to use the same nonce value for integrity verification and subsequent security operations, ensuring uniqueness for each invocation of the authenticated encryption algorithm. Additionally, or alternatively, the NE 1300 may be configured to or operable to support to receive, prior to transmitting the first message, a third message that indicates UE security capabilities including support for the authenticated encryption algorithm and one or more supported authenticated encryption modes, where the data is based on the UE security capabilities. By receiving UE security capabilities prior to transmitting the first message, the NE 1300 enables selection of an authenticated encryption algorithm and mode that both entities support, thereby enhancing interoperability and ensuring successful security establishment.

Additionally, or alternatively, the NE 1300 may be configured to or operable to support the authenticated encryption mode is associated with the integrity protection and the ciphering, and the NE 1300 may be configured to or operable to support to obtain, after the activation of the integrity protection and the ciphering, a first portion associated with a third message and a second portion associated with the third message, where the first portion includes sensitive information elements and the second portion includes non-sensitive information elements, generate, using the authenticated encryption algorithm, ciphertext based on a security key, a nonce value, the second portion as additional data for the integrity protection, the authenticated encryption mode, and the first portion as plaintext, generate, using the authenticated encryption algorithm, an authentication tag based on the security key, the nonce value, the additional data, the authenticated encryption mode, and the ciphertext, and transmit the third message including at least the ciphertext, the second portion, and the authentication tag. By selectively applying ciphering to sensitive information elements while integrity protecting non-sensitive information elements, the NE 1300 reduces processing overhead while maintaining security levels for different message portions.

Additionally, or alternatively, the NE 1300 may be configured to or operable to support the authenticated encryption mode is associated with the integrity protection and the ciphering, and the NE 1300 may be configured to or operable to support to receive, after receiving the second message, a third message including at least a ciphertext, a second portion of the third message, and a first authentication tag, where the third message is associated with a first portion including sensitive information elements, and where the second portion includes non-sensitive information elements, generate, using the authenticated encryption algorithm, a second authentication tag based on a security key, a nonce value, the second portion as additional data, the authenticated encryption mode, and the ciphertext, verify an integrity of the third message based on the first authentication tag matching the second authentication tag, and obtain, using the authenticated encryption algorithm, plaintext associated with the ciphertext based on the security key, the nonce value, the additional data, the authenticated encryption mode, and the ciphertext. By verifying integrity and decrypting the ciphertext in a single authenticated encryption operation, the NE 1300 achieves improved throughput and reduced latency compared to performing separate integrity verification and decryption operations.

Additionally, or alternatively, the NE 1300 may be configured to or operable to support the authenticated encryption mode is associated with the integrity protection, and the NE 1300 may be configured to or operable to support to obtain, after the activation of the integrity protection, additional data associated with a third message, generate, using the authenticated encryption algorithm, an authentication tag based on a security key, a nonce value, and the additional data, where a ciphertext associated with the authenticated encryption algorithm includes a null value based on the authenticated encryption mode, and transmit the third message including at least the additional data and the authentication tag. By setting the ciphertext to a null value when integrity protection is implemented, the NE 1300 avoids increased ciphering operations, thereby reducing processing overhead for messages that do not implement confidentiality protection. Additionally, or alternatively, the NE 1300 may be configured to or operable to support the authenticated encryption mode is associated with the integrity protection, and the NE 1300 may be configured to or operable to support to receive, after receiving the second message, a third message including at least additional data, a ciphertext including a null value, and a first authentication tag, generate, using the authenticated encryption algorithm, a second authentication tag based on a security key, a nonce value, the additional data, and the null value, verify an integrity of the third message based on the first authentication tag matching the second authentication tag, and refrain from obtaining plaintext associated with the ciphertext based on the authenticated encryption mode. By refraining from decryption when the ciphertext includes a null value, the NE 1300 reduces processing overhead while still providing integrity verification for the received message.

Additionally, or alternatively, the NE 1300 may be configured to or operable to support the authenticated encryption mode is associated with the ciphering, and the NE 1300 may be configured to or operable to support to obtain, after the activation of the ciphering, plaintext associated with a third message, where the third message includes a null value corresponding to additional data, generate, using the authenticated encryption algorithm, a ciphertext associated with the plaintext based on a security key, the null value, a nonce value, and the authenticated encryption mode, and transmit the third message including at least the ciphertext, where an authentication tag associated with the authenticated encryption algorithm includes the null value based on the authenticated encryption mode. By setting the authentication tag to a null value when ciphering is implemented, the NE 1300 provides confidentiality protection without the overhead of authentication tag generation, which may apply when message authenticity is established through other mechanisms. Additionally, or alternatively, the NE 1300 may be configured to or operable to support the authenticated encryption mode is associated with the ciphering, and the NE 1300 may be configured to or operable to support to receive, after receiving the second message, a third message including at least a ciphertext and a null value corresponding to additional data, refrain from verifying an integrity of the third message based on the authenticated encryption mode, and obtain, using the authenticated encryption algorithm, plaintext associated with the ciphertext based on a security key, a nonce value, the authenticated encryption mode, the null value as the additional data, and the ciphertext. By refraining from integrity verification when the authenticated encryption mode indicates ciphering only, the NE 1300 reduces processing latency while still providing confidentiality protection for the received message. Additionally, or alternatively, the NE 1300 may be configured to or operable to support the authenticated encryption mode is associated with the integrity protection and the ciphering, and the NE 1300 may be configured to or operable to support to obtain, after the activation of the integrity protection and the ciphering, plaintext associated with a third message, where the third message includes a null value corresponding to additional data, generate, using the authenticated encryption algorithm, a ciphertext associated with the plaintext based on the plaintext, a security key, a nonce value, the authenticated encryption mode, and the null value, generate, using the authenticated encryption algorithm, an authentication tag based on the security key, the nonce value, the null value, the authenticated encryption mode, and the ciphertext, and transmit the third message including at least the ciphertext and the authentication tag. By performing combined ciphering and integrity protection in a single authenticated encryption operation, the NE 1300 achieves improved throughput and reduced latency compared to invoking separate ciphering and integrity protection algorithms.

Additionally, or alternatively, the NE 1300 may be configured to or operable to support the authenticated encryption mode is associated with the integrity protection and the ciphering, and the NE 1300 may be configured to or operable to support to receive, after receiving the second message, a third message including ciphertext and a first authentication tag, where the third message includes a null value corresponding to additional data, generate, using the authenticated encryption algorithm, a second authentication tag based on a security key, a nonce value, the null value, the authenticated encryption mode, and the ciphertext, verify an integrity of the third message based on the first authentication tag matching the second authentication tag, and obtain, using the authenticated encryption algorithm, plaintext associated with the ciphertext based on the security key, the nonce value, the authenticated encryption mode, the null value, and the ciphertext. By performing combined integrity verification and decryption in a single authenticated encryption operation, the NE 1300 provides both confidentiality and integrity protection with reduced processing overhead compared to separate cryptographic operations. Additionally, or alternatively, the NE 1300 may be configured to or operable to support the first message includes at least one of an AS security mode command, a NAS security mode command, or an RRC connection reconfiguration message, and where the second message includes at least one of an AS security mode complete message, a NAS security mode complete message, or an RRC connection reconfiguration complete message. By supporting multiple message types for security establishment, the NE 1300 enables authenticated encryption to be applied across different protocol layers. Additionally, or alternatively, the NE 1300 may be configured to or operable to support the data includes one or more of a count value, a bearer identifier, a direction bit, a nonce value, or security context information. By including these parameters in the data, the NE 1300 enables consistent input parameter definitions between the NE and the UE, which reduces the likelihood of deciphering and integrity verification failures that may otherwise occur due to inconsistent input parameter definitions.

Additionally, or alternatively, the NE 1300 may support at least one memory (e.g., the memory 1304) and at least one processor (e.g., the processor 1302) coupled with the at least one memory and configured to cause the NE to transmit a first message including data that indicates an authenticated encryption algorithm and an authenticated encryption mode associated with at least one of integrity protection or ciphering, and receive a second message based on the authenticated encryption mode and an integrity of the first message, where the second message is associated with activation of at least one of the integrity protection or the ciphering.

Additionally, the NE 1300 may be configured to support any one or a combination of to determine a security key based on one or more of an anchor key, an algorithm identifier associated with the authenticated encryption algorithm, the authenticated encryption mode, or a nonce value, where at least one of the integrity protection or the ciphering is based on the security key, and where the anchor key includes one of an AMF key, a radio anchor key, or a network key. Additionally, or alternatively, the NE 1300 may be configured to or be operable to support to determine the nonce value based on at least one of a count value, a direction bit, a bearer identifier, or the algorithm identifier. Additionally, or alternatively, the NE 1300 may be configured to or be operable to support the second message includes the nonce value, and where the nonce value is based on at least one of a counter, a sequence number, a random value, time information, or the authenticated encryption mode. Additionally, or alternatively, the NE 1300 may be configured to or be operable to support to determine the nonce value based on at least one of a counter, a sequence number, a random value, time information, or the authenticated encryption mode, where the data indicates the nonce value. Additionally, or alternatively, the NE 1300 may be configured to or be operable to support to receive, prior to transmitting the first message, a third message that indicates UE security capabilities, including support for the authenticated encryption algorithm and one or more supported authenticated encryption modes, where the data is based on the UE security capabilities. Additionally, or alternatively, the NE 1300 may be configured to or be operable to support the authenticated encryption mode is associated with the integrity protection and the ciphering, and the NE 1300 may be configured to or be operable to support to obtain, after the activation of the integrity protection and the ciphering, a first portion associated with a third message and a second portion associated with the third message, where the first portion includes sensitive information elements and the second portion includes non-sensitive information elements, generate, using the authenticated encryption algorithm, ciphertext based on a security key, a nonce value, the second portion as additional data for the integrity protection, the authenticated encryption mode, and the first portion as plaintext, generate, using the authenticated encryption algorithm, an authentication tag based on the security key, the nonce value, the additional data, the authenticated encryption mode, and the ciphertext, and transmit the third message including at least the ciphertext, the second portion, and the authentication tag.

Additionally, or alternatively, the NE 1300 may be configured to or operable to support the authenticated encryption mode is associated with the integrity protection and the ciphering, and the NE 1300 may be configured to or operable to support to receive, after receiving the second message, a third message including at least a ciphertext, a second portion of the third message, and a first authentication tag, where the third message is associated with a first portion including sensitive information elements, and where the second portion includes non-sensitive information elements, generate, using the authenticated encryption algorithm, a second authentication tag based on a security key, a nonce value, the second portion as additional data, the authenticated encryption mode, and the ciphertext, verify an integrity of the third message based on the first authentication tag matching the second authentication tag, and obtain, using the authenticated encryption algorithm, plaintext associated with the ciphertext based on the security key, the nonce value, the additional data, the authenticated encryption mode, and the ciphertext.

Additionally, or alternatively, the NE 1300 may be configured to or operable to support the authenticated encryption mode is associated with the integrity protection, and the NE 1300 may be configured to or operable to support to obtain, after the activation of the integrity protection, additional data associated with a third message, generate, using the authenticated encryption algorithm, an authentication tag based on a security key, a nonce value, and the additional data, where a ciphertext associated with the authenticated encryption algorithm includes a null value based on the authenticated encryption mode, and transmit the third message including at least the additional data and the authentication tag. Additionally, or alternatively, the NE 1300 may be configured to or operable to support the authenticated encryption mode is associated with the integrity protection, and the NE 1300 may be configured to or operable to support to receive, after receiving the second message, a third message including at least additional data, a ciphertext including a null value, and a first authentication tag, generate, using the authenticated encryption algorithm, a second authentication tag based on a security key, a nonce value, the additional data, and the null value, verify an integrity of the third message based on the first authentication tag matching the second authentication tag, and refrain from obtaining plaintext associated with the ciphertext based on the authenticated encryption mode.

Additionally, or alternatively, the NE 1300 may be configured to or operable to support the authenticated encryption mode is associated with the ciphering, and the NE 1300 may be configured to or operable to support to obtain, after the activation of the ciphering, plaintext associated with a third message, where the third message includes a null value corresponding to additional data, generate, using the authenticated encryption algorithm, a ciphertext associated with the plaintext based on a security key, the null value, a nonce value, and the authenticated encryption mode, and transmit the third message including at least the ciphertext, where an authentication tag associated with the authenticated encryption algorithm includes the null value based on the authenticated encryption mode. Additionally, or alternatively, the NE 1300 may be configured to or operable to support the authenticated encryption mode is associated with the ciphering, and the NE 1300 may be configured to or operable to support to receive, after receiving the second message, a third message including at least a ciphertext and a null value corresponding to additional data, refrain from verifying an integrity of the third message based on the authenticated encryption mode, and obtain, using the authenticated encryption algorithm, plaintext associated with the ciphertext based on a security key, a nonce value, the authenticated encryption mode, the null value as the additional data, and the ciphertext.

Additionally, or alternatively, the NE 1300 may be configured to or operable to support the authenticated encryption mode is associated with the integrity protection and the ciphering, and the NE 1300 may be configured to or operable to support to obtain, after the activation of the integrity protection and the ciphering, plaintext associated with a third message, where the third message includes a null value corresponding to additional data, generate, using the authenticated encryption algorithm, a ciphertext associated with the plaintext based on the plaintext, a security key, a nonce value, the authenticated encryption mode, and the null value, generate, using the authenticated encryption algorithm, an authentication tag based on the security key, the nonce value, the null value, the authenticated encryption mode, and the ciphertext, and transmit the third message including at least the ciphertext and the authentication tag. Additionally, or alternatively, the NE 1300 may be configured to or operable to support the authenticated encryption mode is associated with the integrity protection and the ciphering, and the NE 1300 may be configured to or operable to support to receive, after receiving the second message, a third message including ciphertext and a first authentication tag, where the third message includes a null value corresponding to additional data, generate, using the authenticated encryption algorithm, a second authentication tag based on a security key, a nonce value, the null value, the authenticated encryption mode, and the ciphertext, verify an integrity of the third message based on the first authentication tag matching the second authentication tag, and obtain, using the authenticated encryption algorithm, plaintext associated with the ciphertext based on the security key, the nonce value, the authenticated encryption mode, the null value, and the ciphertext. Additionally, or alternatively, the NE 1300 may be configured to or operable to support the first message includes at least one of an AS security mode command, a NAS security mode command, or an RRC connection reconfiguration message, and where the second message includes at least one of an AS security mode complete message, a NAS security mode complete message, or an RRC connection reconfiguration complete message. Additionally, or alternatively, the NE 1300 may be configured to or operable to support the data includes one or more of a count value, a bearer identifier, a direction bit, a nonce value, or security context information.

The controller 1306 may manage input and output signals for the NE 1300. The controller 1306 may also manage peripherals not integrated into the NE 1300. In some implementations, the controller 1306 may utilize an operating system such as iOS®, Android®, Windows®, or other operating systems. In some implementations, the controller 1306 may be implemented as part of the processor 1302.

In some implementations, the NE 1300 may include at least one transceiver 1308. In some other implementations, the NE 1300 may have more than one transceiver 1308. The transceiver 1308 may represent a wireless transceiver. The transceiver 1308 may include one or more receiver chains 1310, one or more transmitter chains 1312, or a combination thereof.

A receiver chain 1310 may be configured to receive signals (e.g., control information, data, packets) over a wireless medium. For example, the receiver chain 1310 may include one or more antennas to receive a signal over the air or wireless medium. The receiver chain 1310 may include at least one amplifier (e.g., an LNA) configured to amplify the received signal. The receiver chain 1310 may include at least one demodulator configured to demodulate the received signal and obtain the transmitted data by reversing the modulation technique applied during transmission of the signal. The receiver chain 1310 may include at least one decoder for decoding the demodulated signal to receive the transmitted data.

A transmitter chain 1312 may be configured to generate and transmit signals (e.g., control information, data, packets). The transmitter chain 1312 may include at least one modulator for modulating data onto a carrier signal, preparing the signal for transmission over a wireless medium. The at least one modulator may be configured to support one or more techniques such as AM, FM, or digital modulation schemes like PSK or QAM. The transmitter chain 1312 may also include at least one power amplifier configured to amplify the modulated signal to an appropriate power level suitable for transmission over the wireless medium. The transmitter chain 1312 may also include one or more antennas for transmitting the amplified signal into the air or wireless medium.

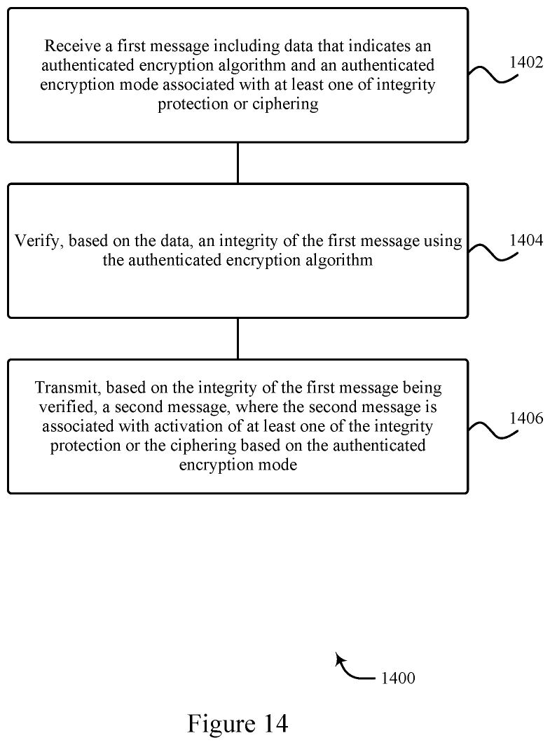

FIG. 14 illustrates a flowchart of a method 1400 in accordance with aspects of the present disclosure. The operations of the method may be implemented by a UE as described herein. In some implementations, the UE may execute a set of instructions to control the function elements of the UE to perform the described functions. It should be noted that the method described herein describes a possible implementation, and that the operations and the steps may be rearranged or otherwise modified, and that other implementations are possible.

At 1402, the method may include receiving a first message including data that indicates an authenticated encryption algorithm and an authenticated encryption mode associated with at least one of integrity protection or ciphering. The operations of 1402 may be performed in accordance with examples as described herein. In some implementations, aspects of the operations of 1402 may be performed by a UE as described with reference to FIG. 11.

At 1404, the method may include verifying, based on the data, an integrity of the first message using the authenticated encryption algorithm. The operations of 1404 may be performed in accordance with examples as described herein. In some implementations, aspects of the operations of 1404 may be performed by a UE as described with reference to FIG. 11.

At 1406, the method may include transmitting, based on the integrity of the first message being verified, a second message, where the second message is associated with activation of at least one of the integrity protection or the ciphering based on the authenticated encryption mode. The operations of 1406 may be performed in accordance with examples as described herein. In some implementations, aspects of the operations of 1406 may be performed by a UE as described with reference to FIG. 11.

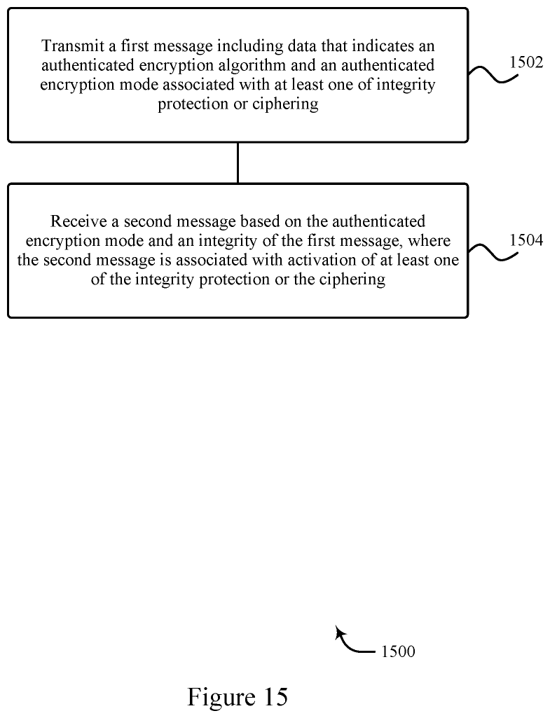

FIG. 15 illustrates a flowchart of a method 1500 in accordance with aspects of the present disclosure. The operations of the method may be implemented by an NE as described herein. In some implementations, the NE may execute a set of instructions to control the function elements of the NE to perform the described functions. It should be noted that the method described herein describes a possible implementation, and that the operations and the steps may be rearranged or otherwise modified, and that other implementations are possible.

At 1502, the method may include transmitting a first message including data that indicates an authenticated encryption algorithm and an authenticated encryption mode associated with at least one of integrity protection or ciphering. The operations of 1502 may be performed in accordance with examples as described herein. In some implementations, aspects of the operations of 1502 may be performed by an NE as described with reference to FIG. 13.

At 1504, the method may include receiving a second message based on the authenticated encryption mode and an integrity of the first message, where the second message is associated with activation of at least one of the integrity protection or the ciphering. The operations of 1504 may be performed in accordance with examples as described herein. In some implementations, aspects of the operations of 1504 may be performed by an NE as described with reference to FIG. 13.

The description herein is provided to enable a person having ordinary skill in the art to make or use the disclosure. Various modifications to the disclosure will be apparent to a person having ordinary skill in the art, and the generic principles defined herein may be applied to other variations without departing from the scope of the disclosure. Thus, the disclosure is not limited to the examples and designs described herein but is to be accorded the broadest scope consistent with the principles and novel features disclosed herein.

What is claimed is:

1. A user equipment (UE) for wireless communication, comprising:
at least one memory; and
at least one processor coupled with the at least one memory and operable to cause the UE to:
receive a first message comprising data that indicates an authenticated encryption algorithm and an authenticated encryption mode associated with at least one of integrity protection or ciphering;
verify, based at least in part on the data, an integrity of the first message using the authenticated encryption algorithm; and
transmit, based at least in part on the integrity of the first message being verified, a second message, wherein the second message is associated with activation of at least one of the integrity protection or the ciphering based at least in part on the authenticated encryption mode.

2. The UE of claim 1, wherein the at least one processor is further operable to cause the UE to determine a security key based at least in part on one or more of an anchor key, an algorithm identifier associated with the authenticated encryption algorithm, the authenticated encryption mode, or a nonce value, wherein at least one of the integrity protection or the ciphering is based at least in part on the security key, and wherein the anchor key comprises one of an access and mobility management function (AMF) key, a radio anchor key, or a network key.

3. The UE of claim 2, wherein the at least one processor is further operable to cause the UE to determine the nonce value based at least in part on at least one of a count value, a direction bit, a bearer identifier, or the algorithm identifier.

4. The UE of claim 2, wherein the data comprises the nonce value, and wherein the nonce value is based at least in part on at least one of a counter, a sequence number, a random value, time information, or the authenticated encryption mode.

5. The UE of claim 2, wherein the at least one processor is further operable to cause the UE to determine the nonce value based at least in part on at least one of a counter, a sequence number, a random value, time information, or the authenticated encryption mode, wherein the second message indicates the nonce value.

6. The UE of claim 2, wherein the first message comprises a first authentication tag, and wherein to verify the integrity of the first message, the at least one processor is further operable to cause the UE to generate, using the authenticated encryption algorithm, a second authentication tag based at least in part on the security key, the nonce value, and the data, wherein the integrity of the first message is verified based at least in part on the second authentication tag matching the first authentication tag.

7. The UE of claim 1, wherein the at least one processor is further operable to cause the UE to transmit, prior to receiving the first message, a third message that indicates UE security capabilities comprising support for the authenticated encryption algorithm and one or more supported authenticated encryption modes, wherein the data is based at least in part on the UE security capabilities.

8. The UE of claim 1, wherein the authenticated encryption mode is associated with the integrity protection and the ciphering, and wherein the at least one processor is further operable to cause the UE to:
obtain, after the activation of the integrity protection and the ciphering, a first portion associated with a third message and a second portion associated with the third message, wherein the first portion comprises sensitive information elements and the second portion comprises non-sensitive information elements;
generate, using the authenticated encryption algorithm, ciphertext based at least in part on a security key, a nonce value, the second portion as additional data for the integrity protection, the authenticated encryption mode, and the first portion as plaintext;
generate, using the authenticated encryption algorithm, an authentication tag based at least in part on the security key, the nonce value, the additional data, the authenticated encryption mode, and the ciphertext; and
transmit the third message comprising at least the ciphertext, the second portion, and the authentication tag.

9. The UE of claim 1, wherein the authenticated encryption mode is associated with the integrity protection and the ciphering, and wherein the at least one processor is further operable to cause the UE to:
receive, after transmitting the second message, a third message comprising at least a ciphertext, a second portion of the third message, and a first authentication tag, wherein the third message is associated with a first portion comprising sensitive information elements, and wherein the second portion comprises non-sensitive information elements;
generate, using the authenticated encryption algorithm, a second authentication tag based at least in part on a security key, a nonce value, the second portion as additional data, the authenticated encryption mode, and the ciphertext;
verify an integrity of the third message based at least in part on the first authentication tag matching the second authentication tag; and
obtain, using the authenticated encryption algorithm, plaintext associated with the ciphertext based at least in part on the security key, the nonce value, the additional data, the authenticated encryption mode, and the ciphertext.

10. The UE of claim 1, wherein the authenticated encryption mode is associated with the integrity protection, and wherein the at least one processor is further operable to cause the UE to:
obtain, after the activation of the integrity protection, additional data associated with a third message;
generate, using the authenticated encryption algorithm, an authentication tag based at least in part on a security key, a nonce value, and the additional data, wherein a ciphertext associated with the authenticated encryption algorithm comprises a null value based at least in part on the authenticated encryption mode; and
transmit the third message comprising at least the additional data and the authentication tag.

11. The UE of claim 1, wherein the authenticated encryption mode is associated with the integrity protection, and wherein the at least one processor is further operable to cause the UE to:
receive, after transmitting the second message, a third message comprising at least additional data, a ciphertext comprising a null value, and a first authentication tag;
generate, using the authenticated encryption algorithm, a second authentication tag based at least in part on a security key, a nonce value, the additional data, and the null value;
verify an integrity of the third message based at least in part on the first authentication tag matching the second authentication tag; and
refrain from obtaining plaintext associated with the ciphertext based at least in part on the authenticated encryption mode.

12. The UE of claim 1, wherein the authenticated encryption mode is associated with the ciphering, and wherein the at least one processor is further operable to cause the UE to:
obtain, after the activation of the ciphering, plaintext associated with a third message, wherein the third message comprises a null value corresponding to additional data;
generate, using the authenticated encryption algorithm, a ciphertext associated with the plaintext based at least in part on a security key, the null value, a nonce value, and the authenticated encryption mode; and
transmit the third message comprising at least the ciphertext, wherein an authentication tag associated with the authenticated encryption algorithm comprises the null value based at least in part on the authenticated encryption mode.

13. The UE of claim 1, wherein the authenticated encryption mode is associated with the ciphering, and wherein the at least one processor is further operable to cause the UE to:
receive, after transmitting the second message, a third message comprising at least a ciphertext and a null value corresponding to additional data;
refrain from verifying an integrity of the third message based at least in part on the authenticated encryption mode; and
obtain, using the authenticated encryption algorithm, plaintext associated with the ciphertext based at least in part on a security key, a nonce value, the authenticated encryption mode, the null value as the additional data, and the ciphertext.

14. The UE of claim 1, wherein the authenticated encryption mode is associated with the integrity protection and the ciphering, and wherein the at least one processor is further operable to cause the UE to:
obtain, after the activation of the integrity protection and the ciphering, plaintext associated with a third message, wherein the third message comprises a null value corresponding to additional data;
generate, using the authenticated encryption algorithm, a ciphertext associated with the plaintext based at least in part on the plaintext, a security key, a nonce value, the authenticated encryption mode, and the null value;
generate, using the authenticated encryption algorithm, an authentication tag based at least in part on the security key, the nonce value, the null value, the authenticated encryption mode, and the ciphertext; and
transmit the third message comprising at least the ciphertext and the authentication tag.

15. The UE of claim 1, wherein the authenticated encryption mode is associated with the integrity protection and the ciphering, and wherein the at least one processor is further operable to cause the UE to:
receive, after transmitting the second message, a third message comprising ciphertext and a first authentication tag, wherein the third message comprises a null value corresponding to additional data;
generate, using the authenticated encryption algorithm, a second authentication tag based at least in part on a security key, a nonce value, the null value, the authenticated encryption mode, and the ciphertext;
verify an integrity of the third message based at least in part on the first authentication tag matching the second authentication tag; and
obtain, using the authenticated encryption algorithm, plaintext associated with the ciphertext based at least in part on the security key, the nonce value, the authenticated encryption mode, the null value, and the ciphertext.

16. A method performed by a user equipment (UE), the method comprising:
receiving a first message comprising data that indicates an authenticated encryption algorithm and an authenticated encryption mode associated with at least one of integrity protection or ciphering;
verifying, based at least in part on the data, an integrity of the first message using the authenticated encryption algorithm; and
transmitting, based at least in part on the integrity of the first message being verified, a second message, wherein the second message is associated with activation of at least one of the integrity protection or the ciphering based at least in part on the authenticated encryption mode.

17. A network entity (NE) for wireless communication, comprising:
at least one memory; and
at least one processor coupled with the at least one memory and operable to cause the NE to:
transmit a first message comprising data that indicates an authenticated encryption algorithm and an authenticated encryption mode associated with at least one of integrity protection or ciphering; and
receive a second message based at least in part on the authenticated encryption mode and an integrity of the first message, wherein the second message is associated with activation of at least one of the integrity protection or the ciphering.

18. The NE of claim 17, wherein the at least one processor is further operable to cause the NE to determine a security key based at least in part on one or more of an anchor key, an algorithm identifier associated with the authenticated encryption algorithm, the authenticated encryption mode, or a nonce value, wherein at least one of the integrity protection or the ciphering is based at least in part on the security key, and wherein the anchor key comprises one of an access and mobility management function (AMF) key, a radio anchor key, or a network key.

19. The NE of claim 17, wherein the at least one processor is further operable to cause the NE to receive, prior to transmitting the first message, a third message that indicates UE security capabilities comprising support for the authenticated encryption algorithm and one or more supported authenticated encryption modes, wherein the data is based at least in part on the UE security capabilities.

20. A method performed by a network entity (NE), the method comprising:
transmitting a first message comprising data that indicates an authenticated encryption algorithm and an authenticated encryption mode associated with at least one of integrity protection or ciphering; and
receiving a second message based at least in part on the authenticated encryption mode and an integrity of the first message, wherein the second message is associated with activation of at least one of the integrity protection or the ciphering.
